(19) United States
(12) Patent Application Publication
(10) Pub. No.: US 2007/0125947 A1
(43) Pub. Date: Jun. 7, 2007

(54) Sample enclosure for a scanning electron microscope and methods of use thereof

(76) Inventors: David Sprinzak, Pasadena, CA (US); Ory Zik, Rehovot (IL); Yiftah Karni, Rehovot (IL); Amots Nechushtan, Aseret (IL); Opher Gileadi, Oxford (GB)

Correspondence Address: PEARL COHEN ZEDEK LATZER, LLP, 1500 BROADWAY 12TH FLOOR, NEW YORK, NY, 10036, US

(21) Appl. No.: 10/546,170

(22) PCT Filed: Dec. 10, 2003
(86) PCT No.: PCT/IL03/01054

§ 371 Date: Jan. 27, 2007

Related U.S. Application Data
(60) Provisional application No. 60/448,808, filed on Feb. 20, 2003.

(51) Int. Cl. G21K 7/00

(52) U.S. Cl. 250/310

(57) ABSTRACT

A SEM sample container having a sample enclosure (100, 102) including an electron beam permeable, fluid permeable membrane (132), and a peripheral enclosure sealed to the membrane, and a sample enclosure closure including a quick-connect attachment (152) for sealing engagement with the sample enclosure.

### REFERENCE TO CO-PENDING APPLICATIONS

Applicant hereby claims priority of U.S. Provisional Patent Application Ser. No. 60/448,808, filed on Feb. 20, 2003, entitled “A Specimen Enclosure for a Scanning Electron Microscope”, PCT Patent Application Serial No., PCT/IL03/00454 filed on Jun. 1, 2003, entitled “A Sample Enclosure for a Scanning Electron Microscope and Methods of Use Thereof” and PCT Patent Application Serial No. PCT/IL03/00457, filed on Jun. 1, 2003, entitled “Methods and SEM Inspection of Fluid Containing Samples”.

### FIELD OF THE INVENTION

The present invention relates to SEM inspection of fluid containing samples generally and more particularly to sample containers and inspection systems as well as methods for utilization thereof.

### BACKGROUND OF THE INVENTION

The following U.S. patent documents are believed to represent the current state of the art:

| | | | | | | |
|---|---|---|---|---|---|---|
| | 4,071,766; | 4,720,633; | 5,250,808; | 5,326,971; | 5,362,964; | 5,412,211; |
| 4,705,949; | 5,945,672; | 6,365,898; | 6,130,434; | 6,025,592; | 5,103,102; | 4,596,928; |
| 4,880,976; | 4,992,662; | 4,720,622; | 5,406,087; | 3,218,459; | 3,378,684; | 4,037,109; |
| 4,448,311; | 4,115,689; | 4,587,666; | 5,323,441; | 5,811,803; | 6,452,177; | 5,898,261; |

| | | |
|---|---|---|
| 4,618,938; | 6,072,178; | 6,114,695 and 4,929,041. |

### SUMMARY

The present invention seeks to provide apparatus, systems and methodologies for enabling SEM inspection of fluid containing samples.

There is thus provided in accordance with a preferred embodiment of the present invention a SEM compatible sample container including a sample enclosure including an electron beam permeable, fluid impermeable membrane, and a peripheral enclosure sealed to the membrane and defining with the membrane the sample enclosure, and a sample enclosure closure including quick-connect attachment functionality for sealing engagement with the sample enclosure. Preferably, the quick-connect attachment functionality includes a bayonet connection. Additionally, the peripheral enclosure is at least partially electrically conductive. Alternatively or additionally, the SEM compatible sample container also includes a pressure relief diaphragm associated with the sample enclosure.

In accordance with another preferred embodiment of the present invention the SEM compatible sample container also includes at least one reference orientation indicator associated with the membrane. Preferably, the SEM compatible sample container also includes at least one membrane support grid supporting the membrane and having reference orientation indication functionality. Additionally, the membrane is formed from a material selected from the group consisting of polyimide, polyamide, polyamide-imide, polyethylene, polypyrrole, PARLODION, COLLODION, KAPTON, FORMVAR, VINYLEC, BUTVAR, PIOLOFORM, PARYLENE, silicon dioxide, silicon monoxide and carbon. Alternatively or additionally, the sample enclosure is preassembled and ready to receive a liquid containing sample therein, following which the sample enclosure closure may be readily sealingly joined thereto by means of the quick-connect attachment functionality.

There is also provided in accordance with another preferred embodiment of the present invention a SEM compatible liquid sample container including a liquid sample enclosure including an electron beam permeable, fluid impermeable membrane, and a peripheral enclosure sealed to the membrane and defining with the membrane the liquid sample enclosure capable of containing a liquid at a depth which is not permeable by electrons having an energy level of less than 50 KeV.

There is also provided in accordance with yet another preferred embodiment of the present invention a SEM compatible sample container including a sample dish including an electron beam permeable, fluid impermeable, membrane, and a peripheral enclosure sealed to the membrane and defining with the membrane the sample dish, and an outer enclosure arranged about the sample dish and defining an aperture for electron communication through the membrane with the interior of the dish.

There is also provided in accordance with still another preferred embodiment of the present invention a SEM compatible sample container including an enclosure defining an aperture for electron communication, and a sample dish located at the interior of the enclosure and including an electron beam permeable, fluid impermeable, membrane, the aperture being arranged with respect to the membrane for electron communication with the interior of the enclosure through the membrane. Preferably, the sample dish is defined by the membrane together with the enclosure. Additionally, the sample dish is defined by the membrane together with a separate dish wall disposed within the enclosure. Alternatively or additionally, the separate dish wall is sealed to the membrane.

There is also provided in accordance with a further preferred embodiment of the present invention a SEM compatible sample container including a sample dish assembly defining an aperture for electron communication therethrough, the sample dish assembly including an electron beam permeable, fluid impermeable, membrane which at least partially defines a sample enclosure, a sample positioner arranged for linear non-rotational motion in engagement with a sample, thereby to position the sample adjacent to the membrane, and a closure including quick-connect attachment functionality for sealing engagement with the enclosure, the aperture being arranged with respect to the membrane for electron communication therethrough and through the membrane, with the sample adjacent thereto. Preferably, the sample positioner includes a flexible support element. Additionally, the flexible support element includes a cell support element

In accordance with another preferred embodiment of the present invention the flexible support element includes a cell growth element. Preferably, the flexible support element includes a fluid filter element. Additionally, the flexible support element includes a membrane.

In accordance with yet another preferred embodiment of the present invention the flexible support element also includes a resilient membrane support. Preferably, the flexible support element is at least partially permeable to liquids. Additionally, the sample positioner includes a spring.

There is also provided in accordance with a yet further preferred embodiment of the present invention a SEM compatible sample container including a sample dish assembly defining an aperture for electron communication therethrough, the sample dish assembly including an electron beam permeable, fluid impermeable, membrane which at least partially defines a sample enclosure, and a pressure relief diaphragm associated with the sample dish assembly.

There is also provided in accordance with a still further preferred embodiment of the present invention a SEM compatible sample container including a sample dish assembly defining an aperture for electron communication therethrough, the sample dish assembly including an electron beam permeable, fluid impermeable membrane which at least partially defines a sample enclosure, and at least one reference orientation indicator associated with the membrane.

There is also provided in accordance with another preferred embodiment of the present invention a SEM compatible premicroscopy multiple sample container system including a plurality of SEM compatible sample containers and a support for supporting the plurality of SEM compatible sample containers. Preferably, the support includes a light transparent portion underlying at least one of the membranes in the plurality of SEM compatible sample containers, whereby light microscopy may be carried out on samples in at least one of the plurality of SEM compatible sample containers while they are supported in the support. Additionally, the SEM compatible premicroscopy multiple sample container also includes a cover arranged to enclose the support and the plurality of SEM compatible sample containers supported thereon.

In accordance with another preferred embodiment of the present invention the support includes at least one liquid reservoir for holding liquid useful in maintaining humidity of the samples in the plurality of SEM compatible sample containers while they are supported in the support. Preferably, the SEM compatible multiple sample container is provided with a suction device and pipettes. Additionally, the suction device is configured such that upon operative engagement thereof with the support, physical engagement thereof with membranes of the plurality of SEM compatible sample containers is prevented.

In accordance with yet another preferred embodiment of the present invention the pipettes are provided with collar elements to prevent inadvertent engagement of the pipettes with the membrane. Preferably, the premicroscopy multiple sample container is dimensioned so as to be compatible with conventional cell biology equipment. Additionally, the support includes retaining functionality for removably retaining individual ones of the plurality of SEM compatible sample containers with respect thereto.

There is also provided in accordance with yet another preferred embodiment of the present invention a SEM system including a SEM, a sample dish assembly defining an aperture for electron communication therethrough, the sample dish assembly including an electron beam permeable, fluid impermeable, membrane which at least partially defines a sample enclosure, and an X-ray detector arranged to receive X-rays from a sample containing liquid located in the sample enclosure during SEM inspection. Preferably, the SEM system also includes a sample enclosure closure including quick-connect attachment functionality for sealing engagement with the sample enclosure. Additionally, the quick-connect attachment functionality includes a bayonet connection.

In accordance with another preferred embodiment of the present invention the sample enclosure is at least partially electrically conductive. Preferably, the SEM system also includes a pressure relief diaphragm associated with the sample enclosure. Additionally, the SEM system also includes at least one reference orientation indicator associated with the membrane.

In accordance with yet another preferred embodiment of the present invention the SEM system also includes at least one membrane support grid supporting the membrane and having reference orientation indication functionality. Preferably, the membrane is formed from a material selected from the group consisting of polyimide, polyamide, polyamide-imide, polyethylene, polypyrrole, PARLODION, COLLODION, KAPTON, FORMVAR, VINYLEC, BUTVAR, PIOLOFORM, PARYLENE, silicon dioxide, silicon monoxide and carbon. Additionally, the sample enclosure is preassembled and ready to receive a liquid containing sample therein, following which the sample enclosure closure may be readily sealingly joined thereto by means of the quick-connect attachment functionality.

There is also provided in accordance with still another preferred embodiment of the present invention a SEM system including a SEM, and a SEM compatible sample container including a sample enclosure including an electron beam permeable, fluid impermeable membrane, and a peripheral enclosure sealed to the membrane and defining with the membrane the sample enclosure, and a sample enclosure closure including quick-connect attachment functionality for sealing engagement with the sample enclosure. Preferably, the quick-connect attachment functionality includes a bayonet connection. Additionally, the peripheral enclosure is at least partially electrically conductive.

In accordance with another preferred embodiment of the present invention the SEM system also includes a pressure relief diaphragm associated with the sample enclosure. Preferably, the SEM system also includes at least one reference orientation indicator associated with the membrane. Additionally, the SEM system also includes at least one membrane support grid supporting the membrane and having reference orientation indication functionality.

In accordance with yet another preferred embodiment of the present invention the membrane is formed from a material selected from the group consisting of polyimide, polyamide, polyamide-imide, polyethylene, polypyrrole, PARLODION, COLLODION, KAPTON, FORMVAR, VINYLEC, BUTVAR, PIOLOFORM, PARYLENE, silicon dioxide, silicon monoxide and carbon. Preferably, the sample enclosure is preassembled and ready to receive a liquid containing sample therein, following which the sample enclosure closure may be readily sealingly joined thereto by means of the quick-connect attachment functionality.

There is also provided in accordance with a further preferred embodiment of the present invention a method for performing scanning electron microscopy including placing a sample in a sample enclosure including an electron beam permeable, fluid impermeable membrane, a peripheral enclosure sealed to the membrane and defining with the membrane the sample enclosure, and a sample enclosure closure including quick-connect attachment functionality for sealing engagement with the sample enclosure, sealing the sample enclosure with the sample enclosure closure, placing the sample enclosure in a beam of electrons, and analyzing results of interactions of the beam of electrons with the sample. Preferably, the method for performing scanning electron microscopy also includes removal of liquid from the sample enclosure prior to the sealing. Additionally, the method for performing scanning electron microscopy also includes addition of liquid to the sample enclosure prior to the sealing.

In accordance with another preferred embodiment of the present invention the method for performing scanning electron also includes incubation of the sample in the sample enclosure. Preferably, analysis of the results of interactions of the beam of electrons with the sample is performed by at least one of detection of X-rays, detection of light in the ultraviolet to infrared range, detection of backscattered electrons, and detection of secondary electrons.

There is also provided in accordance with a yet further preferred embodiment of the present invention a method for performing scanning electron microscopy including placing a sample in a sample enclosure including an electron beam permeable, fluid impermeable membrane, a peripheral enclosure sealed to the membrane and defining with the membrane the sample enclosure, and a sample enclosure closure including quick-connect attachment functionality for sealing engagement with the sample enclosure, positioning a sample positioner arranged to position the sample adjacent to the membrane, sealing the sample enclosure with the sample enclosure closure, placing the sample enclosure in a beam of electrons, and analyzing results of interactions of the beam of electrons with the sample. Preferably, the method for performing scanning electron microscopy also includes removal of liquid from the sample enclosure prior to the sealing. Additionally, the method for performing scanning electron also includes addition of liquid to the sample enclosure prior to the sealing.

In accordance with another preferred embodiment of the present invention the method for performing scanning electron microscopy also includes incubation of the sample in the sample enclosure. Preferably, analysis of the results of interactions of the beam of electrons with the sample is performed by at least one of detection of X-rays, detection of light in the ultraviolet to infrared range, detection of backscattered electrons, and detection of secondary electrons. Additionally, the sample positioner includes a flexible support element.

In accordance with yet another preferred embodiment of the present invention the flexible support element includes a cell support element. Preferably, the flexible support element includes a cell growth element. Additionally, the flexible support element includes a fluid filter element.

In accordance with still another preferred embodiment of the present invention the flexible support element includes a membrane. Preferably, the flexible support element also includes a resilient membrane support. Additionally, the flexible support element is at least partially permeable to liquids.

In accordance with a further preferred embodiment of the present invention the quick-connect attachment functionality includes a bayonet connection. Preferably, the sample enclosure is at least partially electrically conductive. Additionally, the sample positioner includes a spring.

In accordance with a still further preferred embodiment of the present invention the method for performing scanning electron also includes a pressure relief diaphragm associated with the sample dish assembly. Preferably, the method for performing scanning electron also includes at least one reference orientation indicator associated with the membrane. Additionally, the method for performing scanning electron also includes at least one membrane support grid supporting the membrane and having reference orientation indication functionality.

In accordance with another preferred embodiment of the present invention the membrane is formed from a material selected from the group consisting of polyimide, polyamide, polyamide-imide, polyethylene, polypyrrole, PARLODION, COLLODION, KAPTON, FORMVAR, VINYLEC, BUTVAR, PIOLOFORM, PARYLENE, silicon dioxide, silicon monoxide and carbon. Preferably, the sample enclosure is preassembled and ready to receive a sample therein, following which the closure may be readily sealingly joined thereto by means of the quick-connect attachment functionality.

There is also provided in accordance with a yet further preferred embodiment of the present invention a method of electron microscopy including providing a sample of an organic or macromolecular material which is susceptible to electron beam impingement induced damage, adding to the sample a protective material which at least partially prevents the electron beam impingement induced damage, and irradiating the sample and the protective material with an electron beam in an electron microscope. Preferably, the providing includes placing the sample in a sample enclosure including an electron beam permeable, fluid impermeable membrane, and a peripheral enclosure sealed to the membrane and defining with the membrane the sample enclosure.

There is also provided in accordance with a still further preferred embodiment of the present invention a method of electron microscopy including placing a sample in a sample enclosure including an electron beam permeable, fluid impermeable membrane, which is susceptible to electron beam induced damage, and a peripheral enclosure sealed to the membrane and defining with the membrane the sample enclosure, adding to the sample, a protective material which at least partially prevents the electron beam induced damage to the membrane, and irradiating the sample and the protective material with an electron beam in an electron microscope. Preferably, the membrane is susceptible to the electron beam induced damage resulting from electron beam impingement thereon. Additionally, the membrane is susceptible to the electron beam induced damage resulting from electron beam impingement on the sample.

There is also provided in accordance with another preferred embodiment of the present invention an open top microscopy sample container including a light transmissive, fluid impermeable sample support of thickness less than ten microns, and an open top peripheral enclosure sealed to the sample support and defining with the sample support the open top sample contain

### BRIEF DESCRIPTION OF THE DRAWINGS

The present invention will be understood and appreciated more fully from the following detailed description, taken in conjunction with the drawings in which:

FIGS. 1A & 1B are oppositely facing simplified exploded view pictorial illustrations of a disassembled SEM compatible sample container constructed and operative in accordance with a preferred embodiment of the present invention;

FIGS. 2A & 2B are oppositely facing simplified partially pictorial, partially sectional illustrations of a subassembly of the container of FIGS. 1A & 1B;

FIGS. 3A & 3B are oppositely facing simplified exploded view pictorial illustrations of the SEM compatible sample container of FIGS. 1A-2B in a partially assembled state;

FIGS. 4A & 4B are oppositely facing simplified pictorial illustrations of the SEM compatible sample container of FIGS. 1A-3B in a fully assembled state;

FIGS. 5A & 5B are oppositely facing simplified partially pictorial, partially sectional illustrations taken along lines VA-VA and VB-VB, respectively, in FIGS. 3A & 3B;

FIGS. 6A, 6B & 6C are three sectional illustrations showing the operative orientation of the SEM compatible sample container of FIGS. 1A -5B at three stages of operation;

FIGS. 7A, 7B, 7C, 7D and 7E are simplified sectional illustrations of cell growth, liquid removal, liquid addition, sealing and insertion into a SEM respectively using the SEM compatible sample container of FIGS. 1A-6C;

FIGS. 8A, 8B and 8C are simplified sectional illustrations of liquid containing samples, sealing and insertion into a SEM respectively using the SEM compatible sample container of FIGS. 1A-6C;

FIG. 9 is a simplified pictorial and sectional illustration of a SEM inspection of a sample using the SEM compatible sample container of FIGS. 1A-6C;

FIG. 10 is a greatly enlarged simplified schematic illustration of the SEM inspection of a sample in the context of FIG. 9;

FIGS. 11A & 11B are oppositely facing simplified exploded view pictorial illustrations of a disassembled SEM compatible sample container constructed and operative in accordance with another preferred embodiment of the present invention;

FIGS. 12A & 12B are oppositely facing simplified partially pictorial, partially sectional illustrations of a subassembly of the container of FIGS. 11A & 11B;

FIGS. 13A & 13B are oppositely facing simplified exploded view pictorial illustrations of the SEM compatible sample container of FIGS. 11A-12B in a partially assembled state;

FIGS. 14A & 14B are oppositely facing simplified pictorial illustrations of the SEM compatible sample container of FIGS. 11A-13B in a fully assembled state;

FIGS. 15A & 15B are oppositely facing simplified partially pictorial, partially sectional illustrations taken along lines XVA-XVA and XVB-XVB, respectively, in FIGS. 13A & 13B;

FIGS. 16A, 16B & 16C are three sectional illustrations showing the operative orientation of the SEM compatible sample container of FIGS. 11A-15B at three stages of operation;

FIGS. 17A, 17B, 17C, 17D and 17E are simplified sectional illustrations of cell growth, liquid removal, liquid addition, sealing and insertion into a SEM respectively using the SEM compatible sample container of FIGS. 11A-16C;

FIGS. 18A, 18B and 18C are simplified sectional illustrations of liquid containing samples, sealing and insertion into a SEM respectively using the SEM compatible sample container of FIGS. 11A-16C;

FIG. 19 is a simplified pictorial and sectional illustration of a SEM inspection of a sample using the SEM compatible sample container of FIGS. 11A-16C;

FIG. 20 is a greatly enlarged simplified schematic illustration of the SEM inspection of a sample in the context of FIG. 19;

FIGS. 21A and 21B are simplified exploded view illustrations of a pre-microscopy multi-sample holder in use with SEM compatible sample containers of the type shown in FIGS. 1A-20;

FIGS. 22A, 22B and 22C are simplified illustrations of the pre-microscopy multi-sample holder of FIGS. 21A and 21B respectively associated with a suction device and pipettes;

FIG. 23 is a simplified illustration of a SEM based sample inspection system constructed and operative in accordance with a preferred embodiment of the present invention;

FIGS. 24A & 24B are oppositely facing simplified exploded view pictorial illustrations of a disassembled SEM compatible sample container constructed and operative in accordance with another preferred embodiment of the present invention;

FIGS. 25A & 25B are oppositely facing simplified partially pictorial, partially sectional illustrations of a subassembly of the container of FIGS. 24A & 24B;

FIGS. 26A & 26B are oppositely facing simplified exploded view pictorial illustrations of the SEM compatible sample container of FIGS. 24A-25B in a partially assembled state;

FIGS. 27A & 27B are oppositely facing simplified pictorial illustrations of the SEM compatible sample container of FIGS. 24A-26B in a fully assembled state;

FIGS. 28A & 28B are oppositely facing simplified partially pictorial, partially sectional illustrations taken along lines XXVIIIA-XXVIIIA and XXVIIIB-XXVIIIB, respectively, in FIGS. 26A & 26B;

FIGS. 29A, 29B & 29C are three sectional illustrations showing the operative orientation of the SEM compatible sample container of FIGS. 24A-28B at three stages of operation;

FIG. 30 is a simplified sectional and pictorial illustration of tissue containing samples and insertion into a SEM using the SEM compatible sample container of FIGS. 24A-29C;

FIGS. 31A, 31B, 31C, 31D and 31E are simplified sectional illustrations showing the operative orientation of a SEM compatible sample container at various stages of operation and insertion into a SEM using the SEM compatible sample container constructed and operative in accordance with another preferred embodiment of the present invention;

FIG. 32 is a simplified pictorial and sectional illustration of a SEM inspection of a sample using the SEM compatible sample container of FIGS. 24A-30;

FIG. 33 is a greatly enlarged simplified schematic illustration of the SEM inspection of a sample in the context of FIG. 32;

FIGS. 34A & 34B are oppositely facing simplified exploded view pictorial illustrations of a disassembled SEM compatible sample container constructed and operative in accordance with another preferred embodiment of the present invention;

FIGS. 35A & 35B are oppositely facing simplified partially pictorial, partially sectional illustrations of a subassembly of the container of FIGS. 34A & 34B;

FIGS. 36A & 36B are oppositely facing simplified exploded view pictorial illustrations of the SEM compatible sample container of FIGS. 34A-35B in a partially assembled state;

FIGS. 37A & 37B are oppositely facing simplified pictorial illustrations of the SEM compatible sample container of FIGS. 34A-36B in a fully assembled state;

FIGS. 38A & 38B are oppositely facing simplified partially pictorial, partially sectional illustrations taken along lines XVIIIA-XXXVIIIA and XXXVIIIB-XXXVIIIB, respectively, in FIGS. 36A & 36B;

FIGS. 39A, 39B & 39C are three sectional illustrations showing the operative orientation of the SEM compatible sample container of FIGS. 34A-38B at three stages of operation;

FIG. 40 is a simplified sectional and pictorial illustrations of tissue containing samples and insertion into a SEM using the SEM compatible sample container of FIGS. 35A-39C;

FIGS. 41A, 41B, 41C, 41D and 41E are simplified sectional illustrations showing the operative orientation of a SEM compatible sample container at various stages of operation and insertion into a SEM using the SEM compatible sample container constructed and operative in accordance with another preferred embodiment of the present invention;

FIG. 42 is a simplified pictorial and sectional illustration of a SEM inspection of a sample using the SEM compatible sample container of FIGS. 34A-39C;

FIG. 43 is a greatly enlarged simplified schematic illustration of the SEM inspection of a sample in the context of FIG. 42;

FIG. 44 is a simplified illustration of a SEM based sample inspection system constructed and operative in accordance with a preferred embodiment of the present invention;

FIG. 45 is a simplified partially pictorial and partially sectional illustration of a sample in an Inverted Light Microscope constructed and operative in accordance with another preferred embodiment of the present invention; and

FIG. 46, is a simplified pictorial and sectional illustration of SEM inspection of a sample using the SEM compatible sample container of FIGS. 11A-20.

### DETAILED DESCRIPTION OF PREFERRED EMBODIMENTS

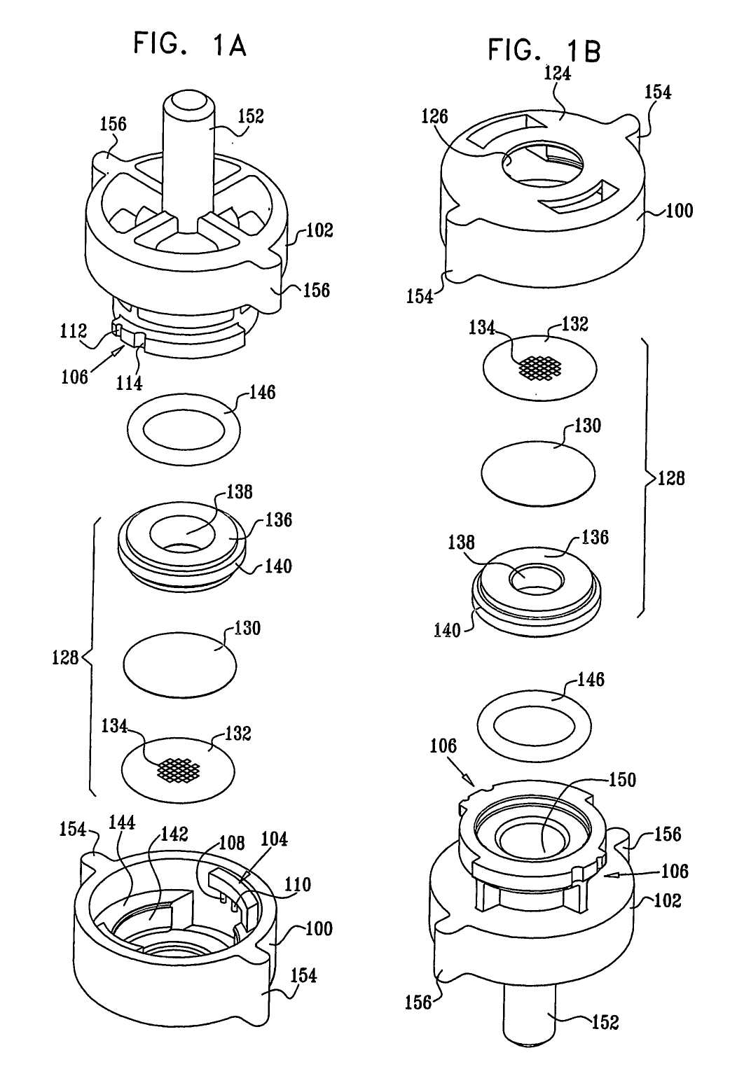

Reference is now made to FIGS. 1A-5B, which are oppositely facing simplified exploded view pictorial illustrations of a disassembled scanning electron microscope (SEM) compatible sample container constructed and operative in accordance with a preferred embodiment of the present invention. As seen in FIGS. 1A & 1B, the SEM compatible sample container comprises first and second mutually engaged enclosure elements, respectively designated by reference numerals 100 and 102, arranged for enhanced ease and speed of closure by connecting a protruded portion 104 formed in first enclosure element 100 to a bayonet-type socket 106 formed in second enclosure element 102.

Protruded portion 104 preferably comprises a first protrusion 108 and a second protrusion 110, which communicate with a first recess 112 and a second recess 114 formed in bayonet-type socket 106. Initial engagement of protrusion 108 with recess 112 provides for a loose engagement of enclosure elements 100 and 102 so as to prevent inadvertent damage of the SEM compatible sample container, such as during shipping and handling. Subsequent engagement of protrusion 108 with recess 114 provides for a tight engagement of enclosure elements 100 and 102. Enclosure elements 100 and 102 are preferably molded of plastic and coated with a conductive metal coating.

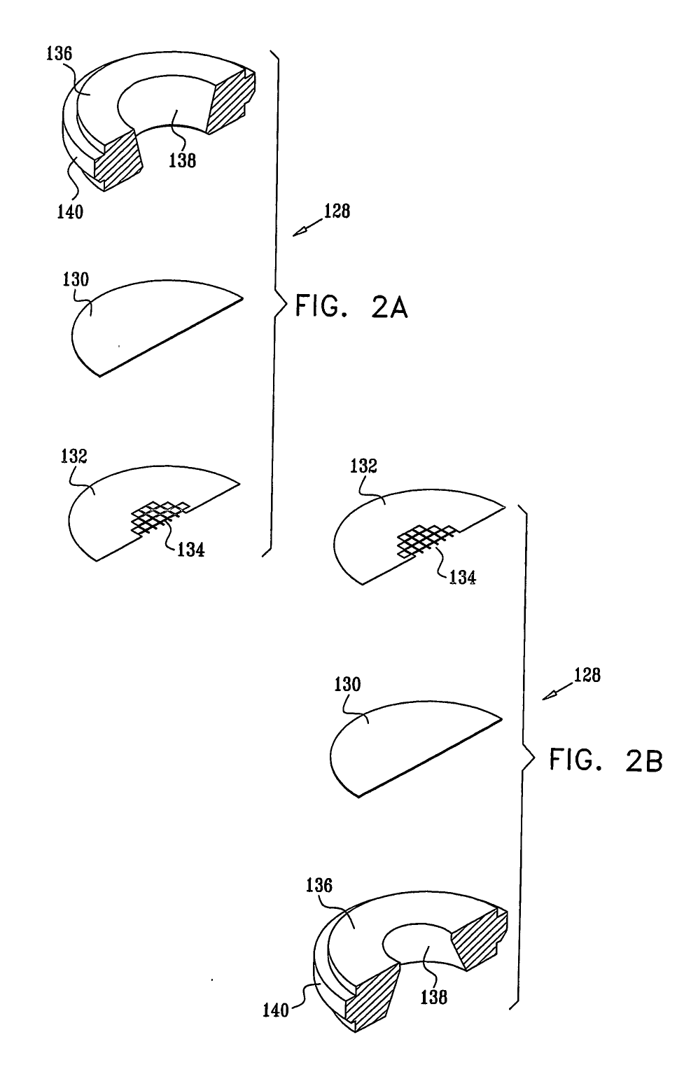

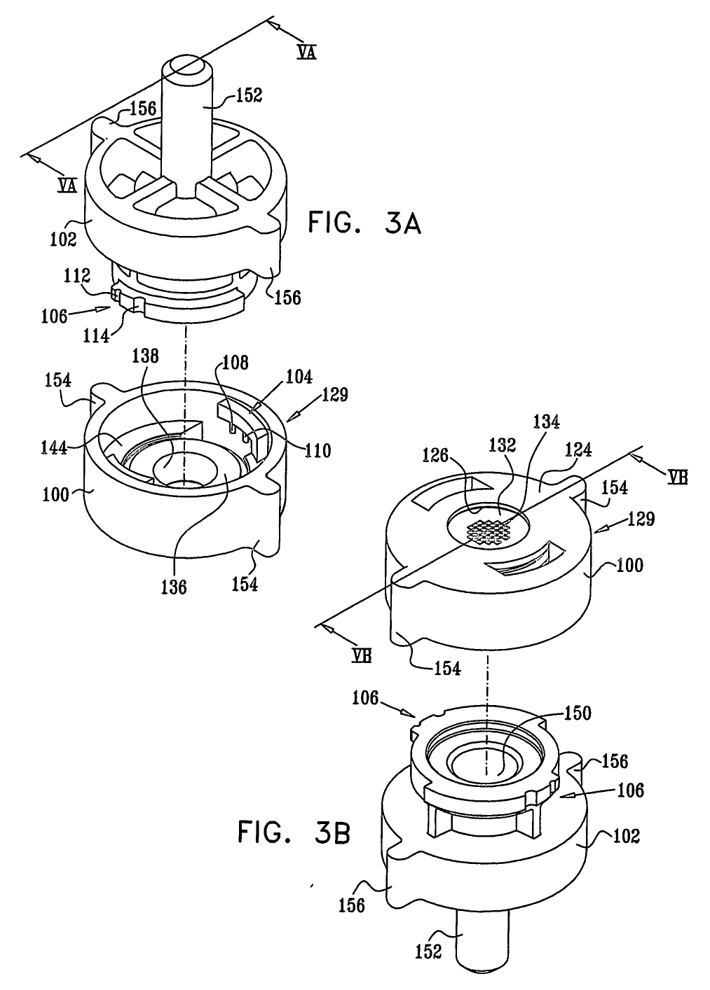

First enclosure element 100 preferably defines a liquid sample enclosure and has a base surface 124 having a generally central aperture 126. An electron beam permeable, fluid impermeable, membrane subassembly 128, shown in detail in FIGS. 2A and 2B, is seated inside enclosure element 100 against and over aperture 126, as shown in FIGS. 3A & 3B and 5A & 5B. A sample dish comprising subassembly 128 suitably positioned in enclosure element 100 is designated by reference numeral 129, as shown in FIGS. 3A-5B.

Turning additionally to FIGS. 2A and 2B, it is seen that an electron beam permeable, fluid impermeable, membrane 130, preferably a polyimide membrane, such as Catalog No. LWN00033, commercially available from Moxtek Inc. of Orem, Utah, U.S.A., is adhered, as by an adhesive, to a grid support element 132, which defines at its center a mechanically supporting grid 134. Grid 134; which is not shown to scale, is preferably configured to define an asymmetrical array of apertures to provide reference orientation indication functionality so as to assist users in identifying the location of a sample region in respect to the SEM compatible sample container and is preferably formed by photochemical etching of stainless still sheets, commercially available from Suron Ltd. of Kibutz Maagan Michael, Israel. The adhesive is preferably Catalog No. 1193MVLV, commercially available from Dyamx corporation of 51 Greenwoods Road, Torrington, Conn. 06790, USA.

A liquid sample enclosure defining ring 136 is adhered to electron beam permeable, fluid impermeable, membrane 130, preferably by an adhesive, such as Catalog No. 1193MVLV, commercially available from Dyamx corporation of 51 Greenwoods Road, Torrington, Conn. 06790, USA. Ring 136 is preferably formed of PMMA (polymethyl methacrylate), such as Catalog No. 692106001000, commercially available from Irpen of Barcelona, Spain, and preferably defines a liquid sample enclosure with a volume of approximately 20 microliters and a height of approximately 2 mm. Preferably ring 136 is configured to define a liquid sample enclosure 138 having inclined walls and is formed on an external surface thereof with a circumferential rim 140 operative to engage recesses 142 formed in protruded portions 144 of first enclosure element 100 so as to securely seat ring 136 in first enclosure element 100.

Alternatively, membrane 130 may be formed from polyamide, polyamide-imide, polyethylene, polypyrrole, PARLODION, COLLODION, KAPTON, FORMVAR, VINYLEC, BUTVAR, PIOLOFORM, PARYLENE, silicon dioxide, silicon monoxide or carbon, or any combination thereof or any other suitable material.

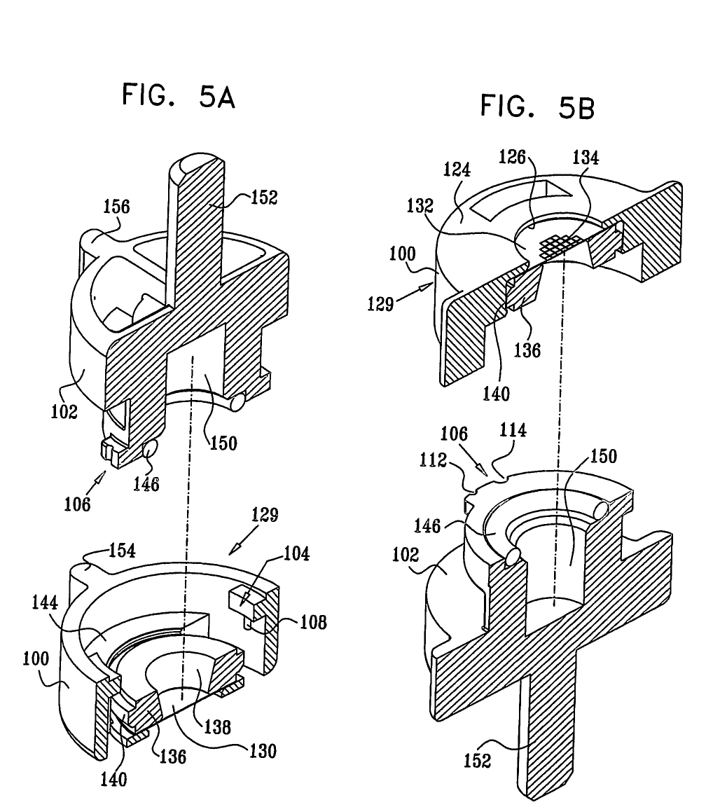

As seen in FIGS. 1A, 1B, 5A and 5B, an O-ring 146 is preferably disposed between ring 136 and an interior surface 150 of second enclosure element 102. O-ring 146 is operative, when enclosure elements 100 and 102 are in tight engagement, to obviate the need for the engagement of elements 100 and 102 to be a sealed engagement.

Second enclosure element 102 preferably is formed with a generally central stub 152, which is arranged to be seated in a suitable recess (not shown) in a specimen stage of a scanning electron microscope. It is a particular feature of the present invention that the container, shown in FIGS. 1A-10, is sized and operative with conventional stub recesses in conventional SEMs and does not require any modification thereof whatsoever. It is appreciated that various configurations and sizes of stubs may be provided so as to fit various SEMs.

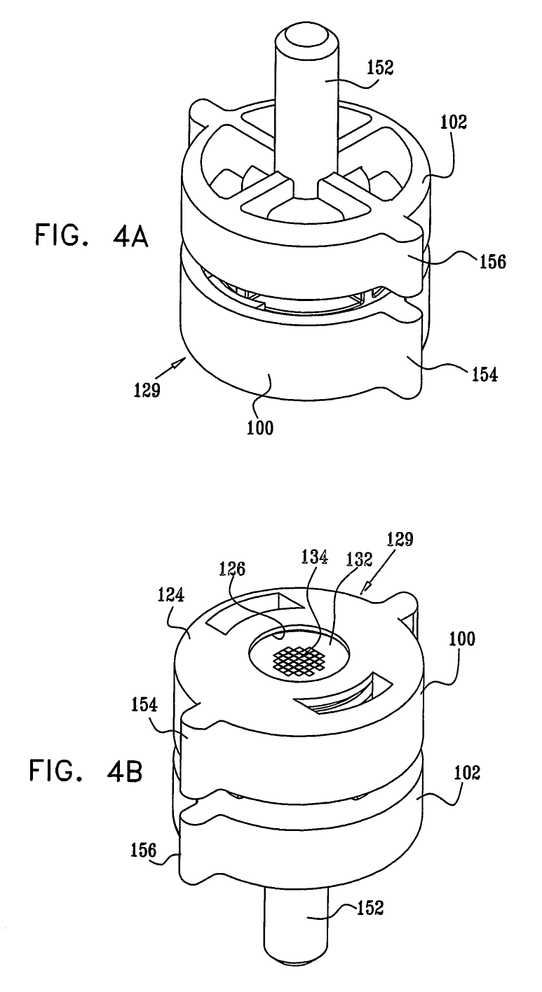

Enclosure elements 100 and 102 are preferably also provided with respective radially extending positioning and retaining protrusions 154 and 156, respectively, to enable the container to be readily seated in a suitable multi-container holder and also to assist users in opening and closing the enclosure elements 100 and 102. Preferably, the mutual azimuthal positioning of the protrusions 154 and 156 on respective enclosure elements 100 and 102 is such that mutual azimuthal alignment therebetween indicates a tight engagement therebetween, as shown in FIGS. 4A and 4B.

It is appreciated that in another embodiment of the present invention the sample dish may include enclosures 100 and 102.

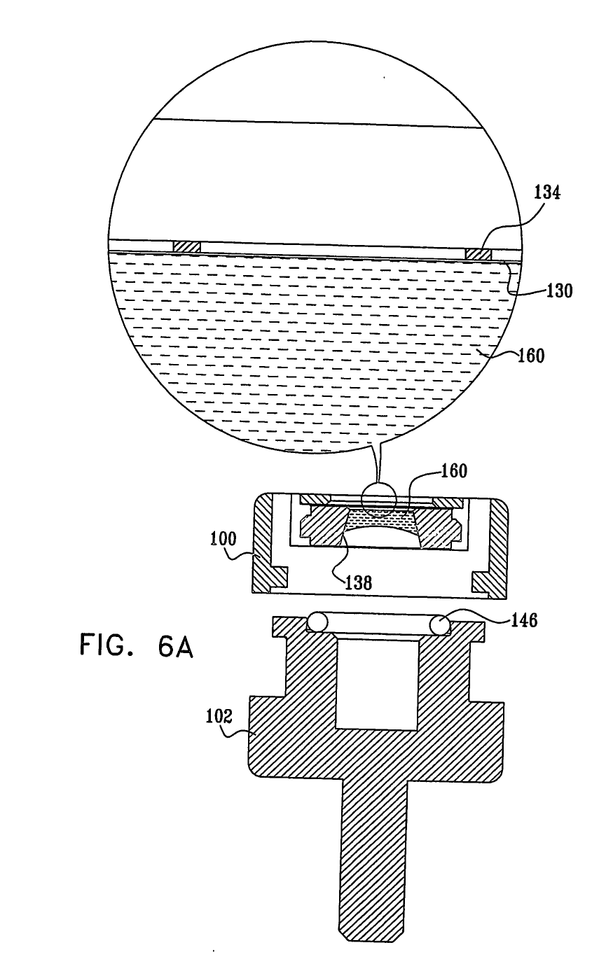

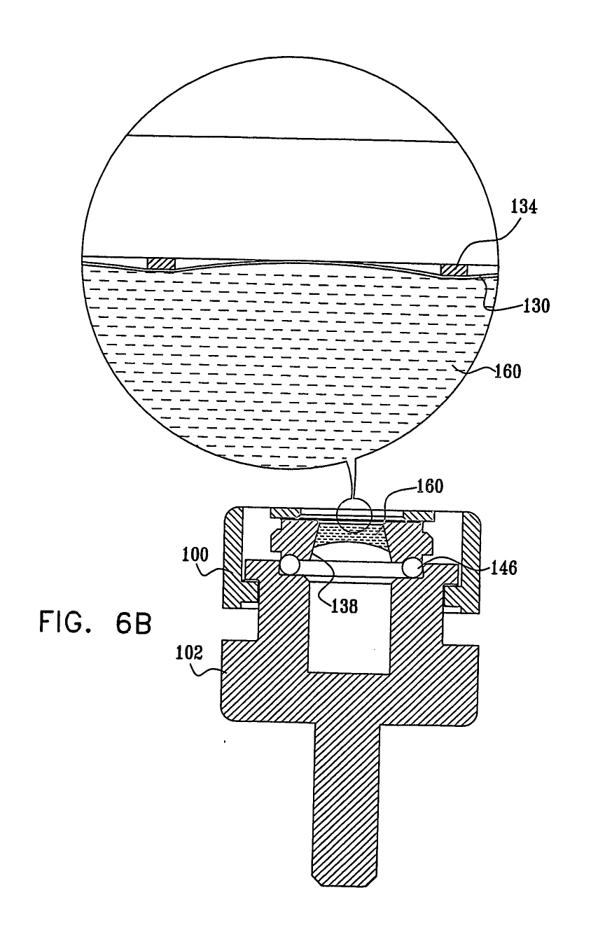

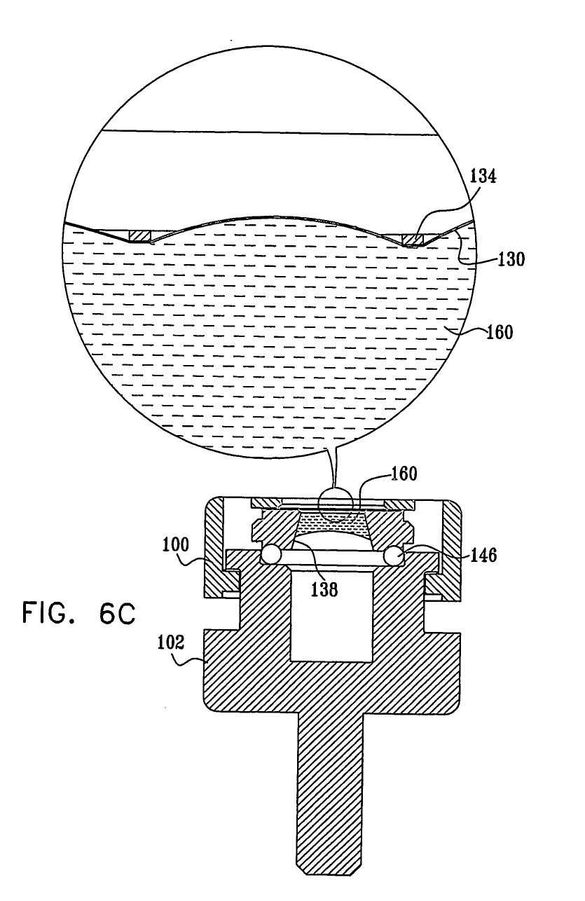

Reference is now made to FIGS. 6A, 6B & 6C, which are three sectional illustrations showing the operative orientation of the SEM compatible sample container of FIGS. 1A-5B at three stages of operation. FIG. 6A shows the container of FIGS. 1A-5B containing a liquid sample 160 and arranged in the orientation shown in FIG. 1B, prior to closure of enclosure elements 100 and 102. It is noted that the liquid sample does not flow out of the liquid sample enclosure 138 due to surface tension. The electron beam permeable, fluid impermeable, membrane 130 is seen in FIG. 6A to be generally planar.

FIG. 6B shows the container of FIG. 6A immediately following full engagement between enclosure elements 100 and 102, producing sealing of the liquid sample enclosure 138 from the ambient. It is seen that the electron beam permeable, fluid impermeable, membrane 130 bows outwardly due to pressure buildup in the liquid sample enclosure 138 as the result of sealing thereof in this manner. Supporting grid 134 is seen to be generally planar.

FIG. 6C illustrates the container of FIG. 6B, when placed in an evacuated environment of a SEM, typically at a vacuum of 10⁻²- 10⁻⁶ millibars. It is seen that in this environment, the electron beam permeable, fluid impermeable, membrane 130 and support grid 134 bow outwardly to a greater extent than in the ambient environment of FIG. 6B and further that the electron beam permeable, fluid impermeable, membrane 130 tends to be forced into and through the interstices of grid 134 to a greater extent than occurs in the ambient environment of FIG. 6B.

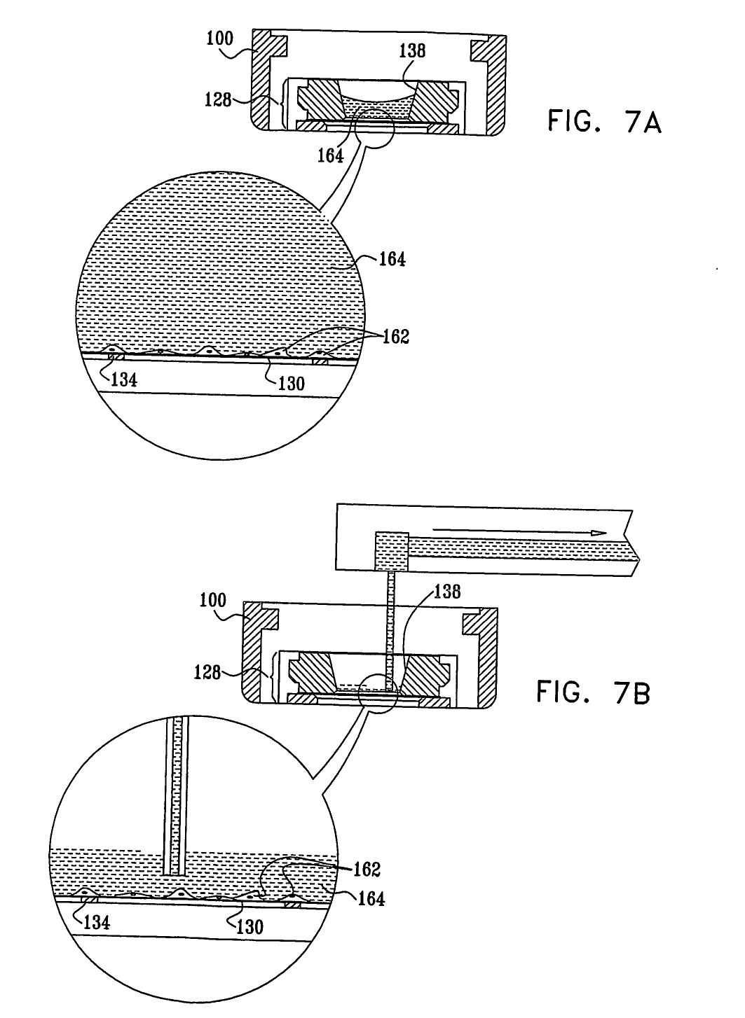

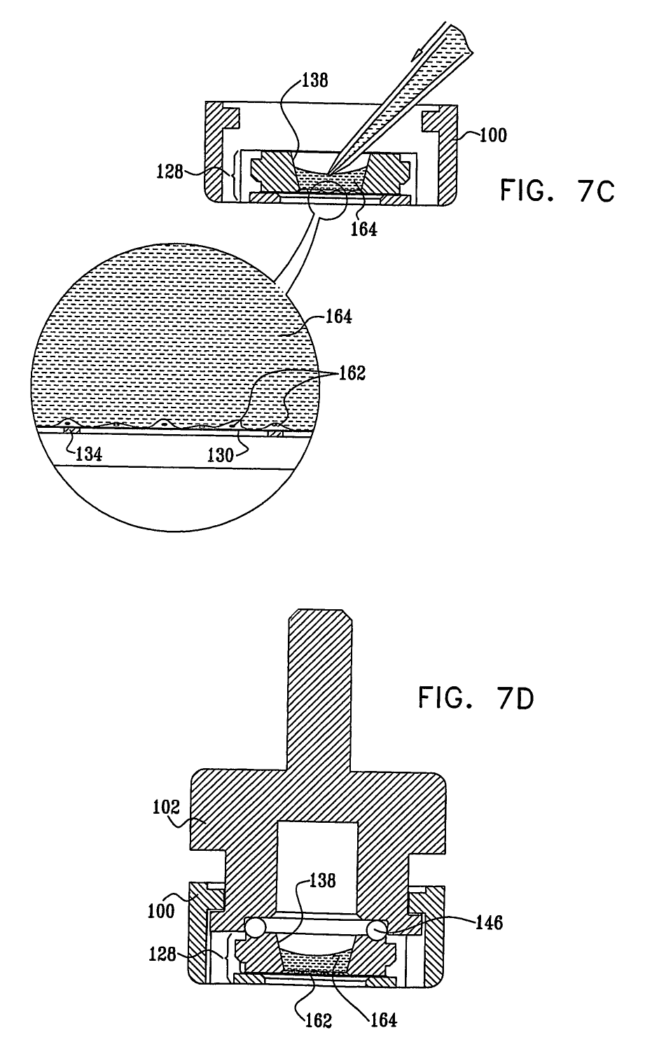

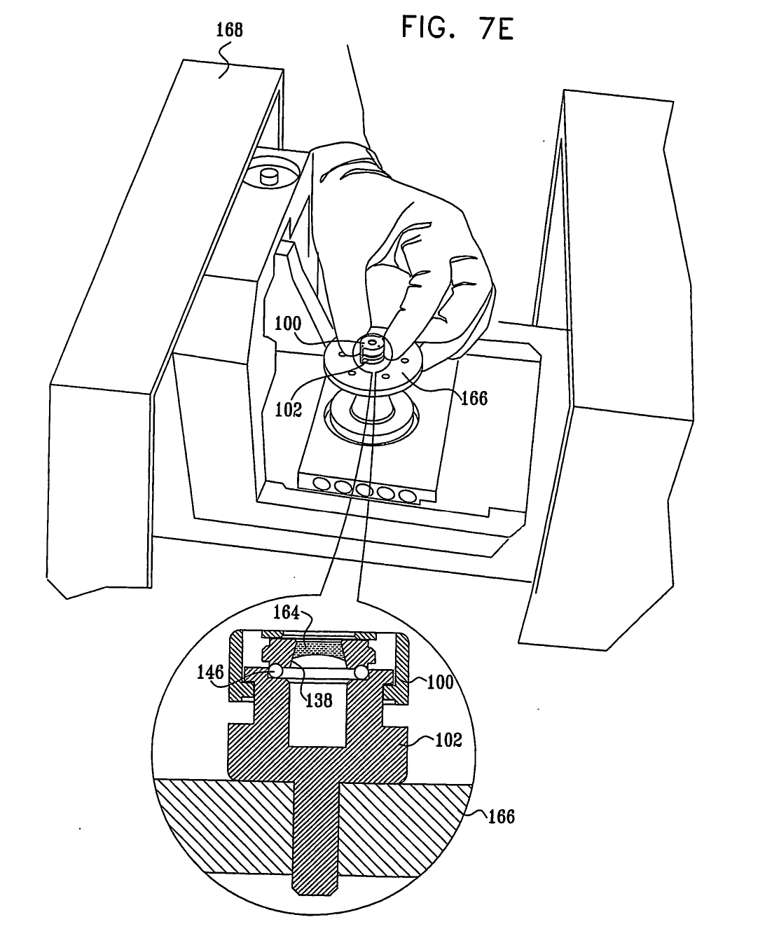

Reference is now made to FIGS. 7A, 7B, 7C, 7D and 7E, which are simplified sectional illustrations of cell growth, liquid removal, liquid addition, sealing and insertion into a SEM respectively using the SEM compatible sample container of FIGS. 1A-6C. Turning to FIG. 7A, which illustrates a typical cell culture situation, it is seen that the enclosure element 100 having disposed therewithin subassembly 128 is in the orientation shown in FIG. 1A and cells 162 in a liquid medium 164 are located within liquid sample enclosure 138, the cells 162 lying against the electron beam permeable, fluid impermeable, membrane 130.

FIG. 7B shows removal of liquid from liquid sample enclosure 138, typically by aspiration, and FIG. 7C shows addition of liquid to liquid sample enclosure 138. It is appreciated that multiple occurrences of liquid removal and addition may take place with respect to a sample within liquid sample enclosure 138. Preferably, the apparatus employed for liquid removal and addition is designed or equipped such as to prevent inadvertent rupture of the electron beam permeable, fluid impermeable, membrane 130.

FIG. 7D illustrates closing of the container containing the cells 162, seen in FIG. 7C, in a liquid medium 164. FIG. 7E shows the closed container, in the orientation of FIG. 1B, being inserted onto a stage 166 of a SEM 168. It is appreciated that there exist SEMs wherein the orientation of the container is opposite to that shown in FIG. 7E.

FIGS. 7A-7D exemplify a situation wherein at least a portion of a liquid containing sample remains in contact with the electron beam permeable, fluid impermeable, membrane 130 notwithstanding the addition or removal of liquid from liquid sample enclosure 138. This situation may include situations wherein part of the sample is adsorbed or otherwise adhered to the electron beam permeable, fluid impermeable, membrane 130. Examples of liquid containing samples may include cell cultures, blood, bacteria and acellular material.

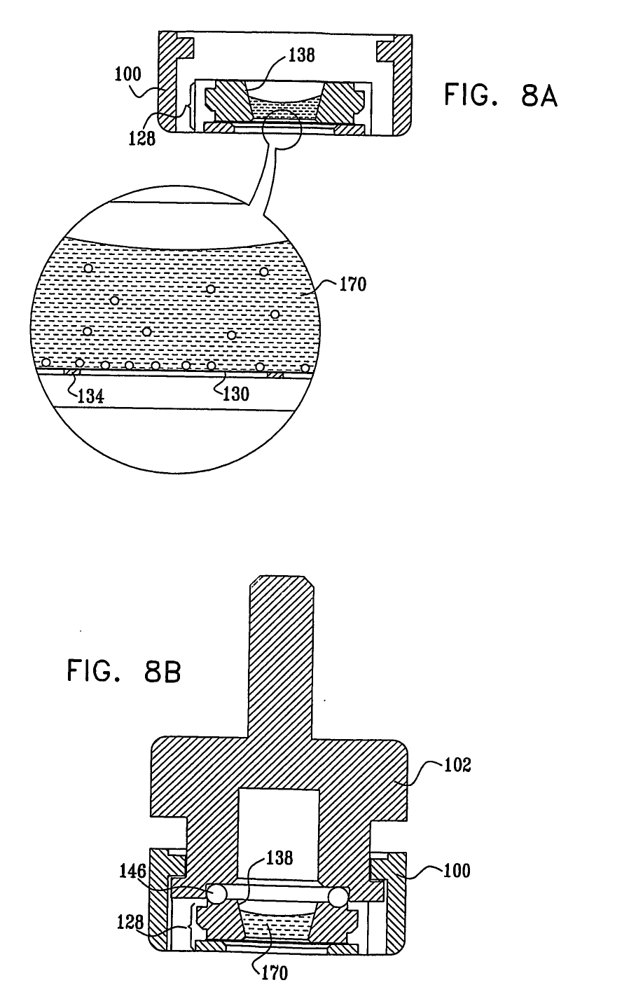

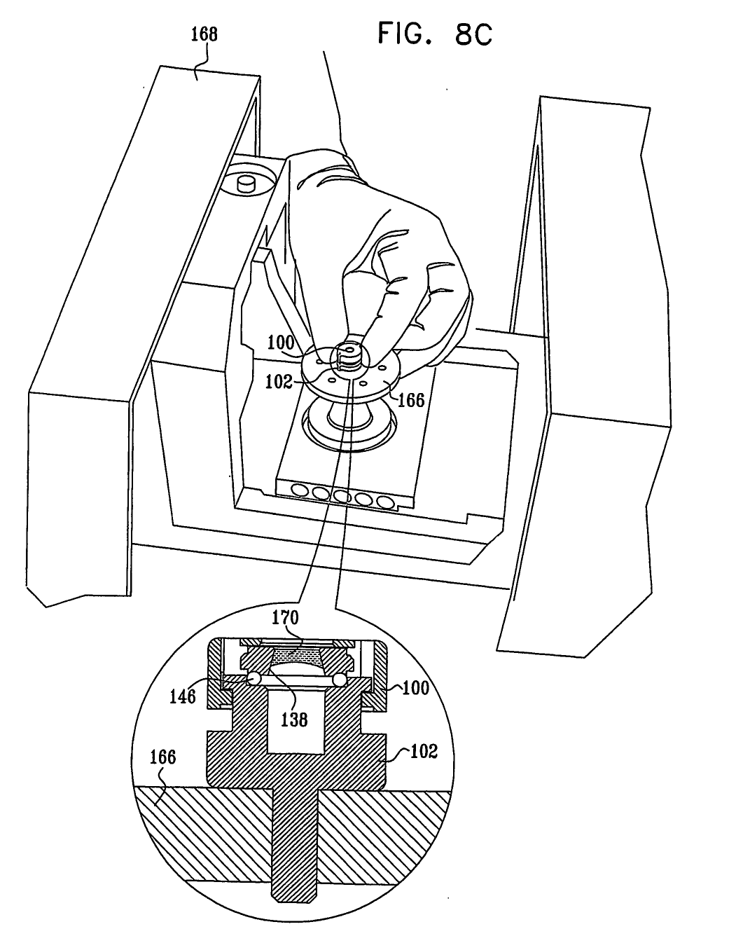

Reference is now made to FIGS. 8A, 8B and 8C, which are simplified sectional illustrations of liquid containing samples in contact with the electron beam permeable, fluid impermeable, membrane 130, sealing and insertion into a SEM respectively using the SEM compatible sample container of FIGS. 1A-6C. FIGS. 8A-8C exemplify a situation wherein at least a portion of a liquid containing sample 170 is in contact with the electron beam permeable, fluid impermeable, membrane 130 but is not adhered thereto. Examples of liquid containing samples may include various emulsions and suspensions such as milk, cosmetic creams, paints, inks, and pharmaceuticals in liquid form. It is seen that the enclosure element 100 in FIGS. 8A and 8B, having disposed therewithin subassembly 128, is in the orientation shown in FIG. 1A.

FIG. 8B illustrates closing of the container containing the sample 170. FIG. 8C shows the closed container, in the orientation of FIG. 1B, being inserted onto stage 166 of SEM 168. It is appreciated that there exist SEMs wherein the orientation of the container is opposite to that shown in FIG. 8C.

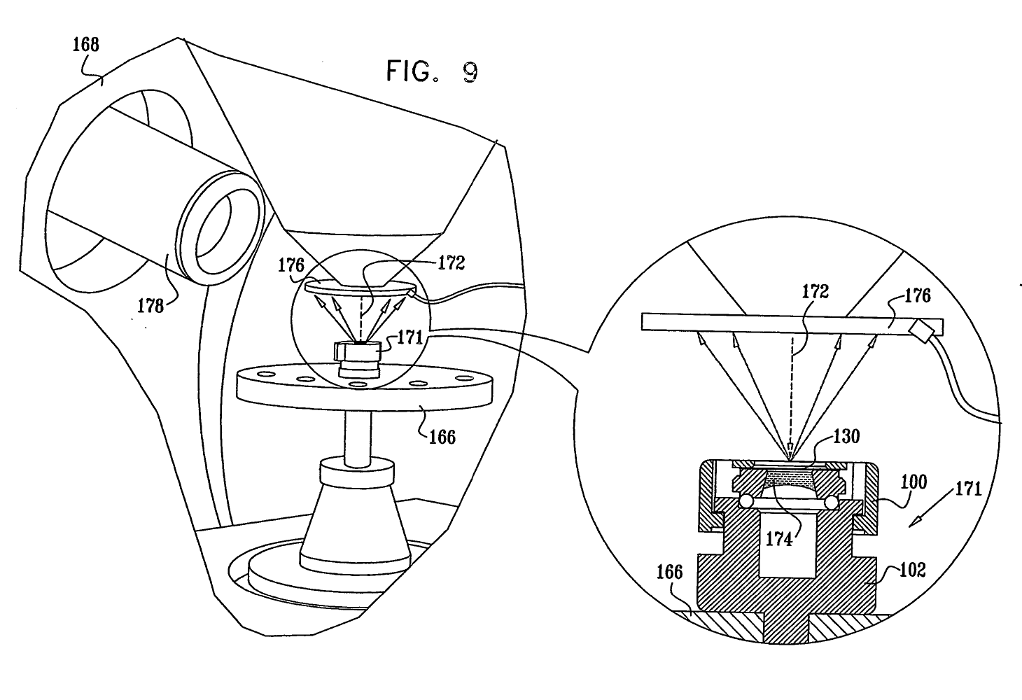

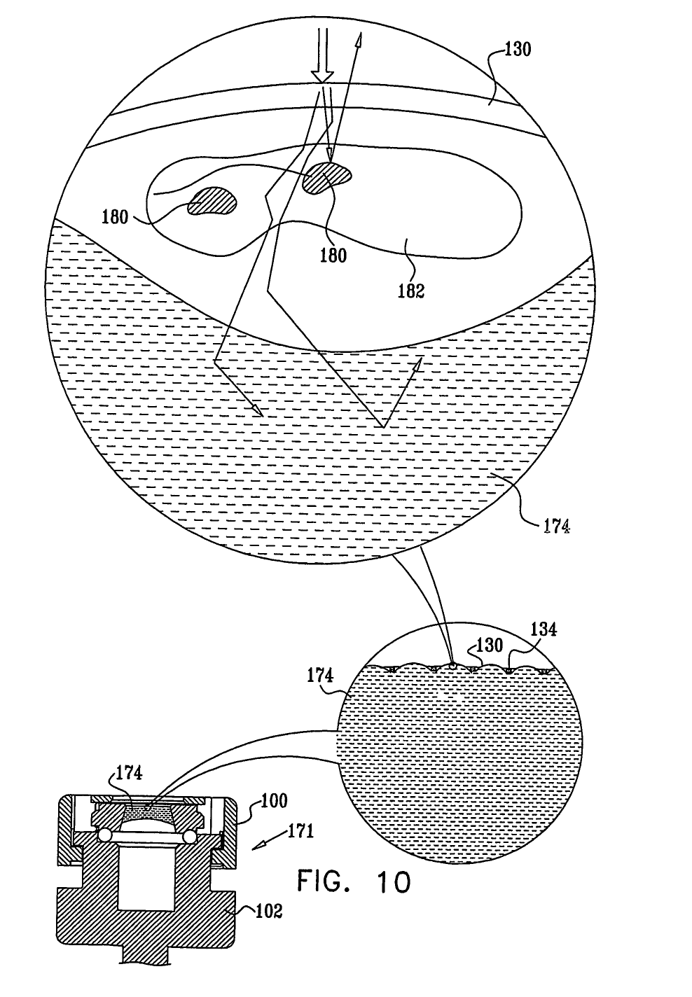

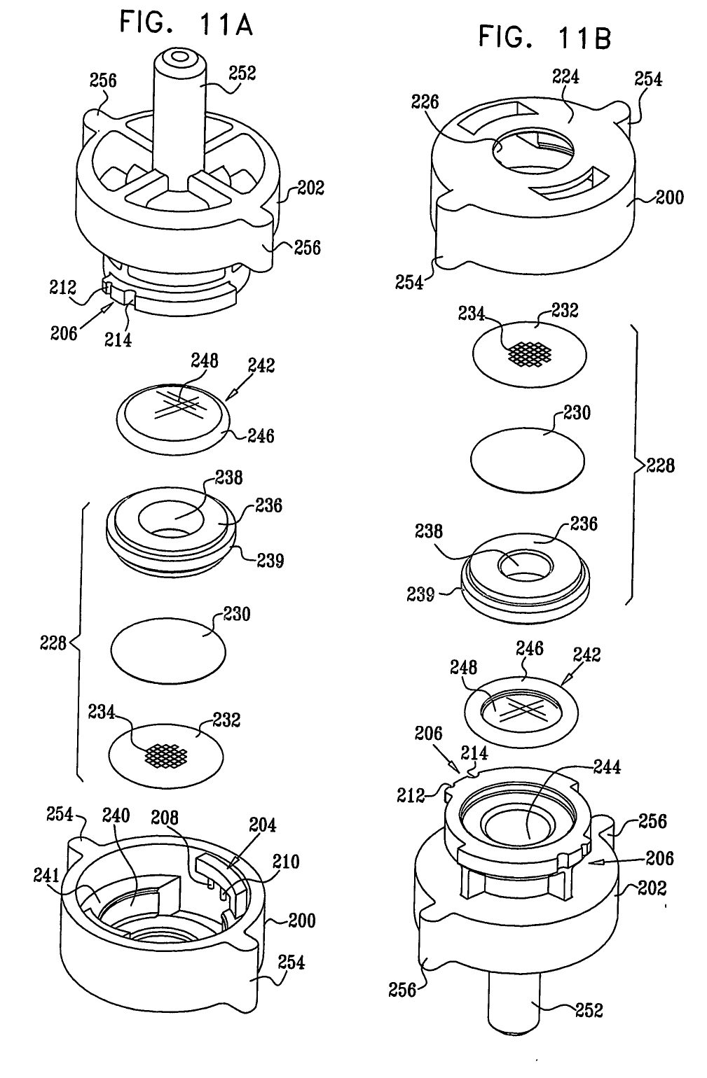

Reference is now made to FIG. 9, which is a simplified pictorial and sectional illustration of SEM inspection of a sample using the SEM compatible sample container of FIGS. 1A-6C. As seen in FIG. 9, the container, here designated by reference numeral 171, is shown positioned on stage 166 of SEM 168 such that an electron beam 172, generated by the SEM, passes through electron beam permeable, fluid impermeable, membrane 130 and impinges on a liquid containing sample 174 within container 171. Backscattered electrons from sample 174 pass through electron beam permeable, fluid impermeable, membrane 130 and are detected by a detector 176, forming part of the SEM 168. One or more additional detectors, such as a secondary electron detector 178, may also be provided. An X-ray detector (not shown) may be provided for detecting X-ray radiation emitted by the sample 174 due to electron beam excitation thereof and a cathodoluminescent detector (not shown) may also be provided for detecting radiation emitted by the sample 174 due to electron beam excitation thereof.

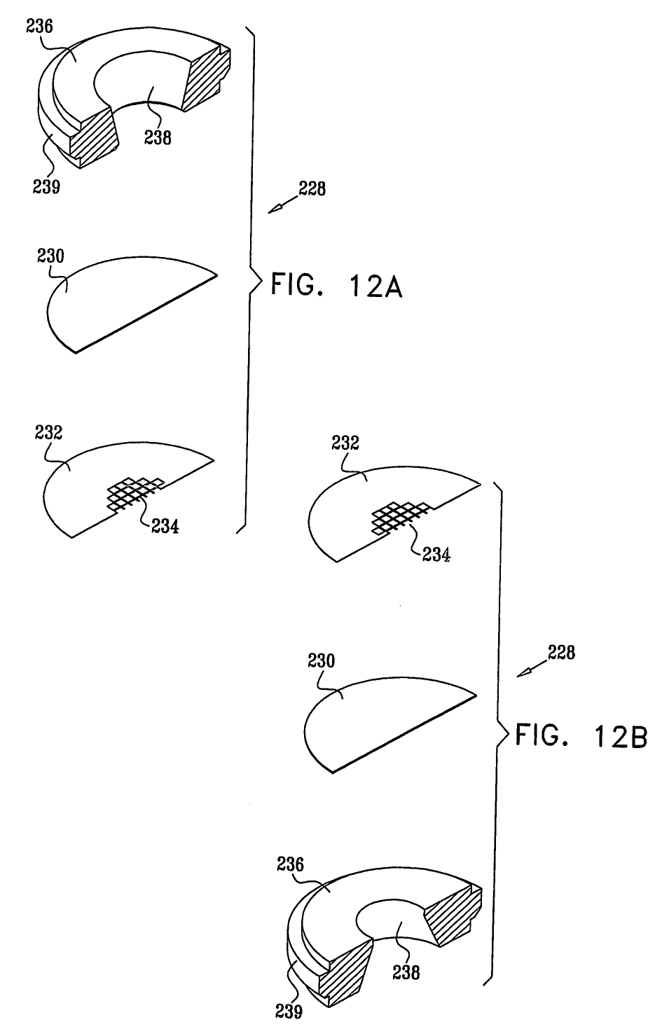

Reference is now made additionally to FIG. 10, which schematically illustrates some details of the electron beam interaction with the sample 174 in container 171 in accordance with a preferred embodiment of the present invention. It is noted that the present invention enables high contrast imaging of features which are distinguished from each other by their average atomic number, as illustrated in FIG. 10. In FIG. 10 it is seen that nucleoli 180, having a relatively high average atomic number, backscatter electrons more than the surrounding nucleoplasm 182.

It is also noted that in accordance with a preferred embodiment of the present invention, imaging of the interior of the sample to a depth of up to approximately 2 microns is achievable for electrons having an energy level of less than 50 KeV, as seen in FIG. 10, wherein nucleoli 180 disposed below electron beam permeable, fluid impermeable, membrane 130 are imaged.

Reference is now made to FIGS. 11A-15B, which are oppositely facing simplified exploded view pictorial illustrations of a disassembled scanning electron microscope (SEM) compatible sample container constructed and operative in accordance with another preferred embodiment of the present invention. As seen in FIGS. 11A & 11B, the SEM compatible sample container comprises first and second mutually engaged enclosure elements, respectively designated by reference numerals 200 and 202, arranged for enhanced ease and speed of closure by connecting a protruded portion 204 formed in first enclosure element 200 to a bayonet-type socket 206 formed in second enclosure element 202.

Protruded portion 204 preferably comprises a first protrusion 208 and a second protrusion 210, which communicate with a first recess 212 and a second recess 214 formed in bayonet-type socket 206. Initial engagement of protrusion 208 with recess 212 provides for a loose engagement of enclosure elements 200 and 202 so as to prevent inadvertent damage of the SEM compatible sample container, such as during shipping and handling. Subsequent engagement of protrusion 208 with recess 214 provides for a tight engagement of enclosure elements 200 and 202. Enclosure elements 200 and 202 are preferably molded of plastic and coated with a conductive metal coating.

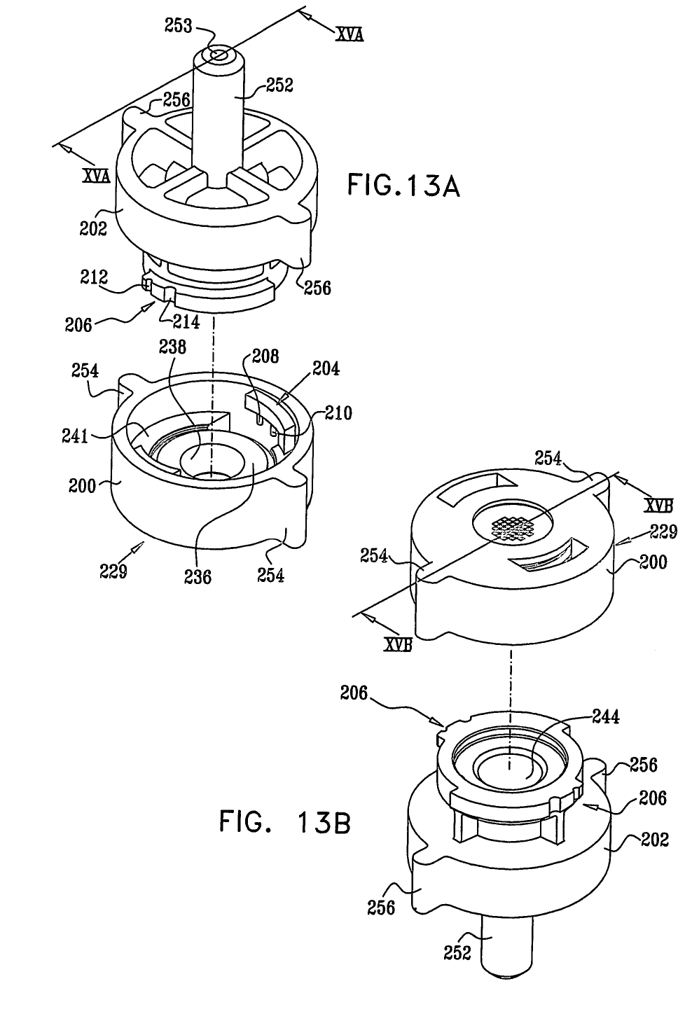

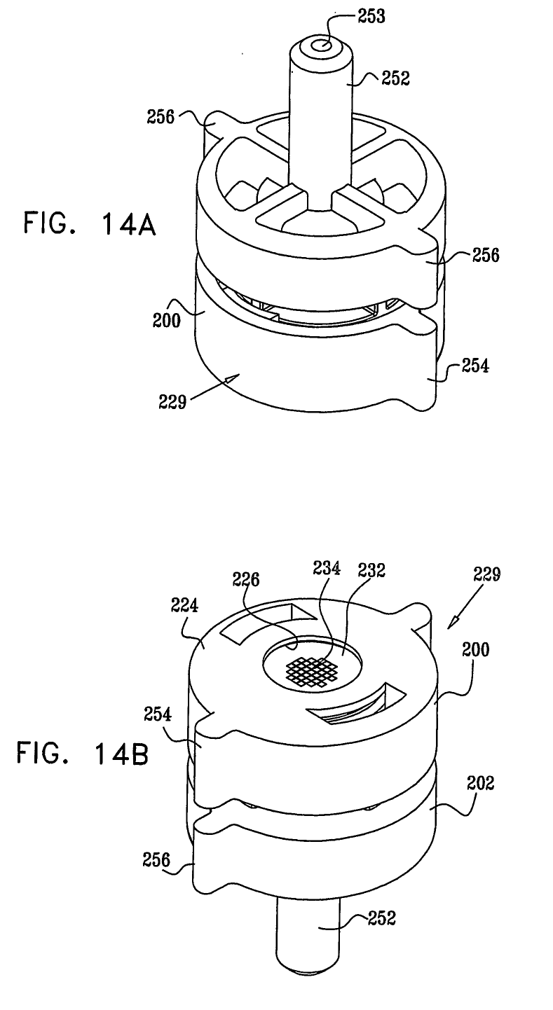

First enclosure element 200 preferably defines a liquid sample enclosure and has a base surface 224 having a generally central aperture 226. An electron beam permeable, fluid impermeable, membrane subassembly 228, shown in detail in FIGS. 12A and 12B, is seated inside enclosure element 200 against and over aperture 226, as shown in FIGS. 13A & 13B and 15A & 15B. A sample dish comprising subassembly 228 suitably positioned in enclosure element 200 is designated by reference numeral 229, as shown in FIGS. 13A-15B.

Turning additionally to FIGS. 12A and 12B, it is seen that an electron beam permeable, fluid impermeable, membrane 230, preferably a polyimide membrane, such as Catalog No. LWN00033, commercially available from Moxtek Inc. of Orem, Utah, U.S.A., is adhered, as by an adhesive, to a grid support element 232, which defines at its center a mechanically supporting grid 234. Grid 234, which is not shown to scale, is preferably configured to define an asymmetrical array of apertures to provide reference orientation indication functionality so as to assist users in identifying the location of a sample region in respect to the SEM compatible sample container and is preferably formed by photochemical etching of stainless still sheets, commercially available from Suron Ltd. of Kibutz Maagan Michael, Israel.

A liquid sample enclosure defining ring 236 is adhered to electron beam permeable, fluid impermeable, membrane 230, preferably by an adhesive, such as Catalog No 1193MVLV, commercially available from Dyamx corporation of 51 Greenwoods Road, Torrington, Conn. 06790, USA. Ring 236 is preferably formed of PMMA (polymethyl methacrylate), such as Catalog No. 692106001000, commercially available from Irpen of Barcelona, Spain, and preferably defines a liquid sample enclosure with a volume of approximately 20 microliters and a height of approximately 2 mm. Preferably ring 236 is configured to define a liquid sample enclosure 238 having inclined walls and is preferably formed on an external surface thereof with a circumferential rim 239 operative to engage recesses 240 formed in protruded portions 241 of first enclosure element 200 so as to securely seat ring 236 in first enclosure element 200.

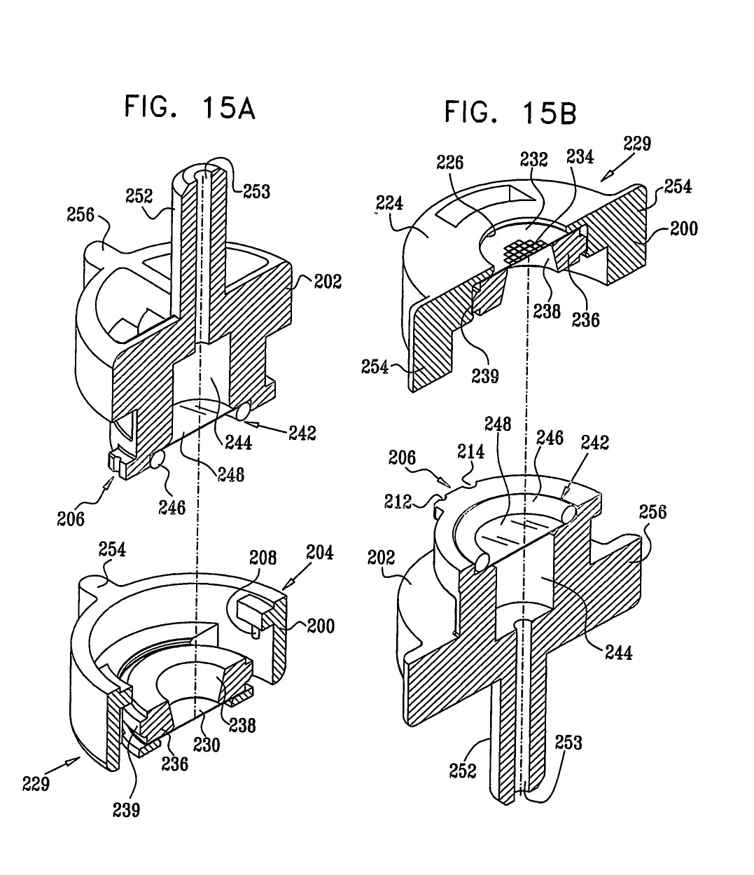

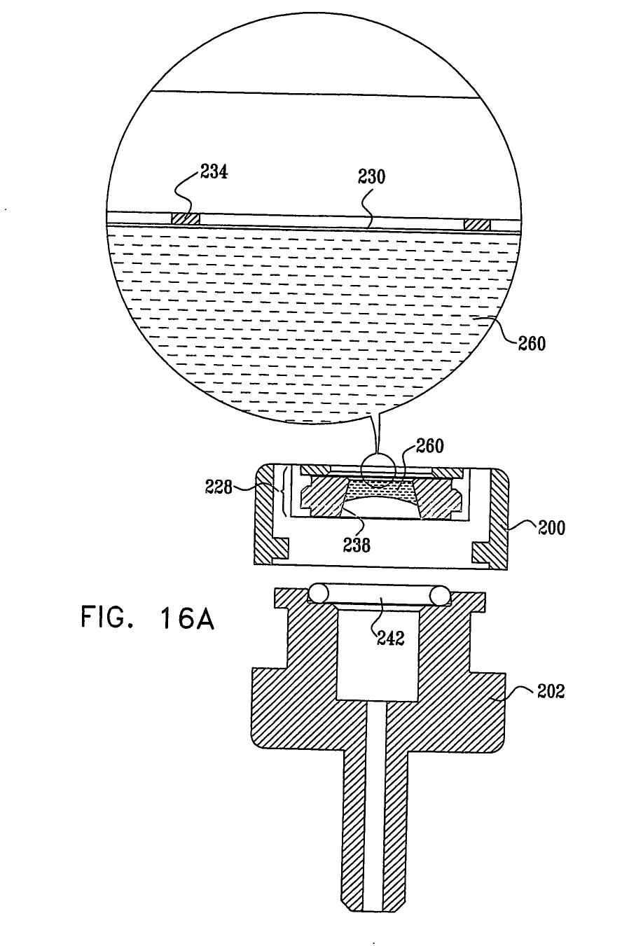

As seen in FIGS. 11A, 11B, 15A and 15B, a diaphragm 242 is preferably disposed between ring 236 and an interior surface 244 of second enclosure element 202. Diaphragm 242 is preferably integrally formed of an O-ring portion 246 to which is sealed an expandable sheet portion 248. The diaphragm 242 is preferably molded of silicon rubber having a Shore hardness of about 50 and the sheet portion 248 preferably has a thickness of 0.2-0.3 mm. Diaphragm 242 is operative, when enclosure elements 200 and 202 are in tight engagement, to obviate the need for the engagement of elements 200 and 202 to be a sealed engagement and to provide dynamic and static pressure relief.

Second enclosure element 202 preferably is formed with a generally central stub 252, having a throughgoing bore 253, which stub is arranged to be seated in a suitable recess (not shown) in a specimen stage of a scanning electron microscope. Bore 253 enables diaphragm 242 to provide pressure relief by defining a fluid communication channel between one side of the diaphragm 242 and the environment in which the (SEM) compatible sample container is located. It is a particular feature of the present invention that the container, shown in FIGS. 11A-20, is sized and operative with conventional stub recesses in conventional SEMs and does not require any modification thereof whatsoever. It is appreciated that various configurations and sizes of stubs may be provided so as to fit various SEMs.

Enclosure elements 200 and 202 are preferably also provided with respective radially extending positioning and retaining protrusions 254 and 256, to enable the container to be readily seated in a suitable multi-container holder and also to assist users in opening and closing the enclosure elements 200 and 202. Preferably, the mutual azimuthal positioning of the protrusions 254 and 256 on respective enclosure elements 200 and 202 is such that mutual azimuthal alignment therebetween indicates a tight engagement therebetween, as shown in FIGS. 14A and 14B.

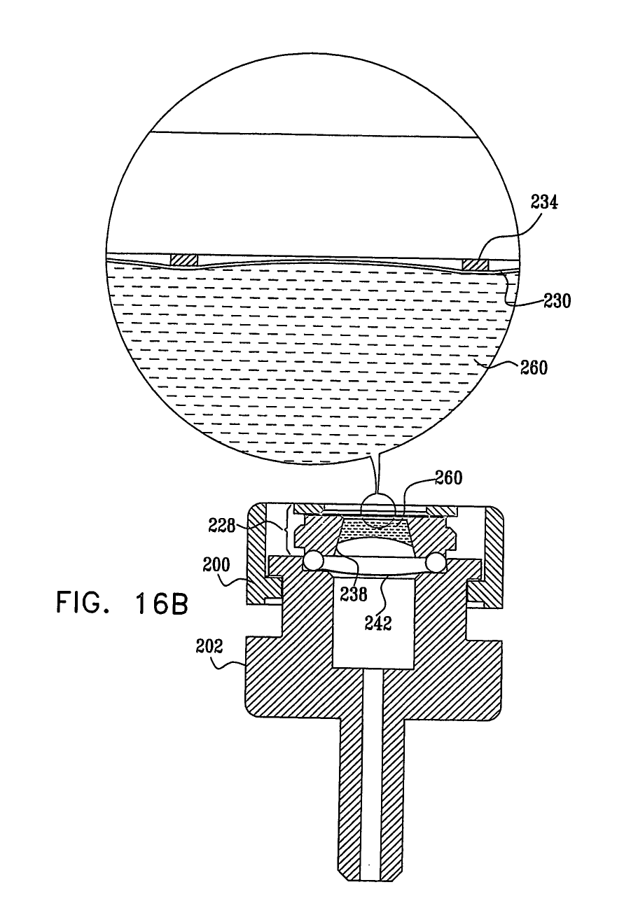

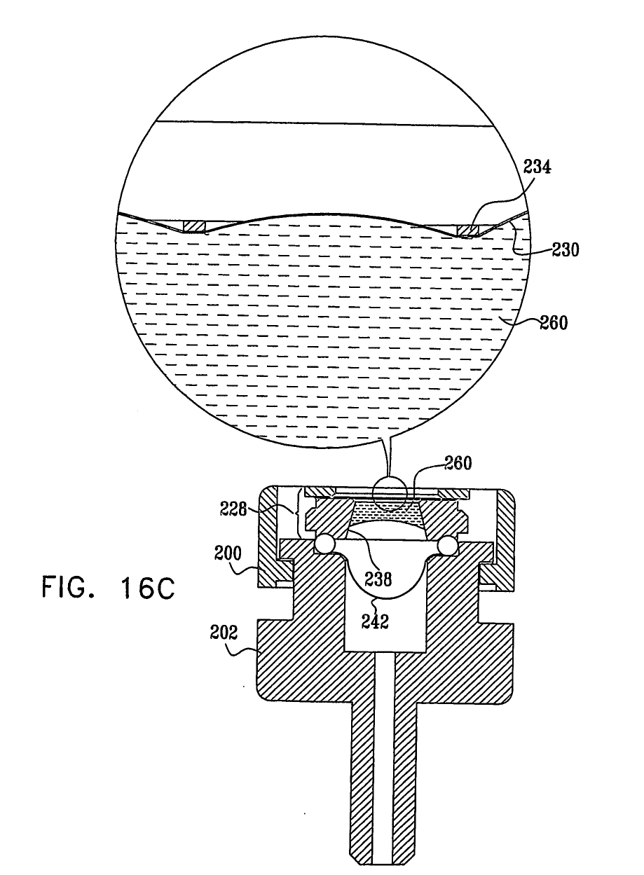

Reference is now made to FIGS. 16A, 16B & 16C, which are three sectional illustrations showing the operative orientation of the SEM compatible sample container of FIGS. 11A-15B at three stages of operation. FIG. 16A shows the container of FIGS. 11A-15B containing a liquid sample 260 and arranged in the orientation shown in FIG. 11B, prior to closure of enclosure elements 200 and 202. It is noted that the liquid sample does not flow out of the liquid sample enclosure 238 due to surface tension. The electron beam permeable, fluid impermeable, membrane 230 is seen in FIG. 16A to be generally planar.

FIG. 16B shows the container of FIG. 16A immediately following full engagement between enclosure elements 200 and 202, producing sealing of the liquid sample enclosure 238 from the ambient. It is seen that the diaphragm 242 bows outwardly due to pressure buildup in the liquid sample enclosure 238 as the result of sealing thereof in this manner. In this embodiment, electron beam permeable, fluid impermeable, membrane 230 bows outwardly due to pressure buildup in the liquid sample enclosure 238 as the result of sealing thereof in this manner, however to a significantly lesser extent, due to the action of diaphragm 242. This can be seen by comparing FIG. 16B with FIG. 6B. Supporting grid 234 is seen to be generally planar.

FIG. 16C illustrates the container of FIG. 16B, when placed in an evacuated environment of a SEM, typically at a vacuum of 10⁻²-10⁻⁶ millibars. It is seen that in this environment, the diaphragm 242 bows outwardly to a greater extent than in the ambient environment of FIG. 16B and that electron beam permeable, fluid impermeable, membrane 230 and support grid 234 also bow outwardly to a greater extent than in the ambient environment of FIG. 16B, but to a significantly lesser extent than in the embodiment of FIG. 6C, due to the action of diaphragm 242. This can be seen by comparing FIG. 16C with FIG. 6C.

It is also noted that the electron beam permeable, fluid impermeable, membrane 230 tends to be forced into and through the interstices of grid 234 to a greater extent than occurs in the ambient environment of FIG. 16B but to a significantly lesser extent than in the embodiment of FIG. 6C, due to the action of diaphragm 242. This can also be seen by comparing FIG. 16C with FIG. 6C.

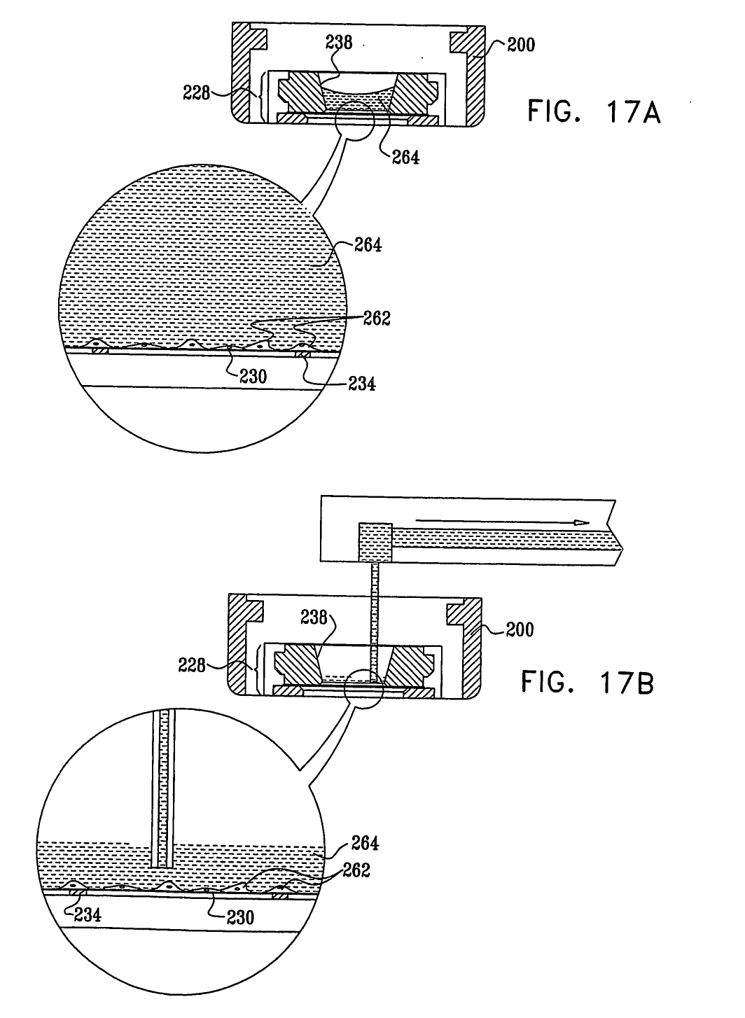

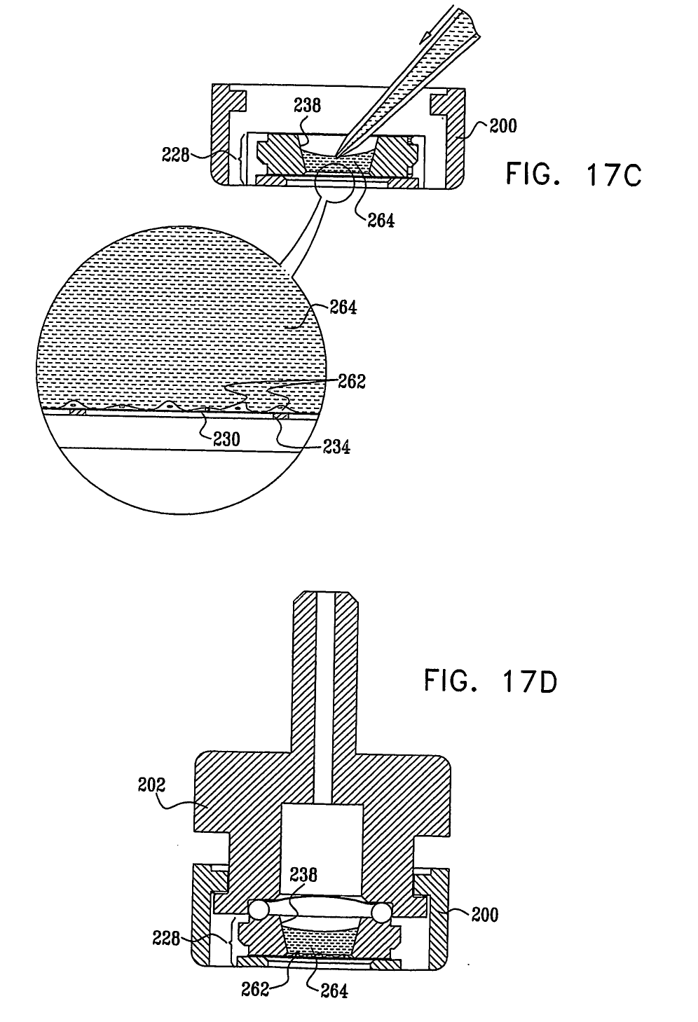

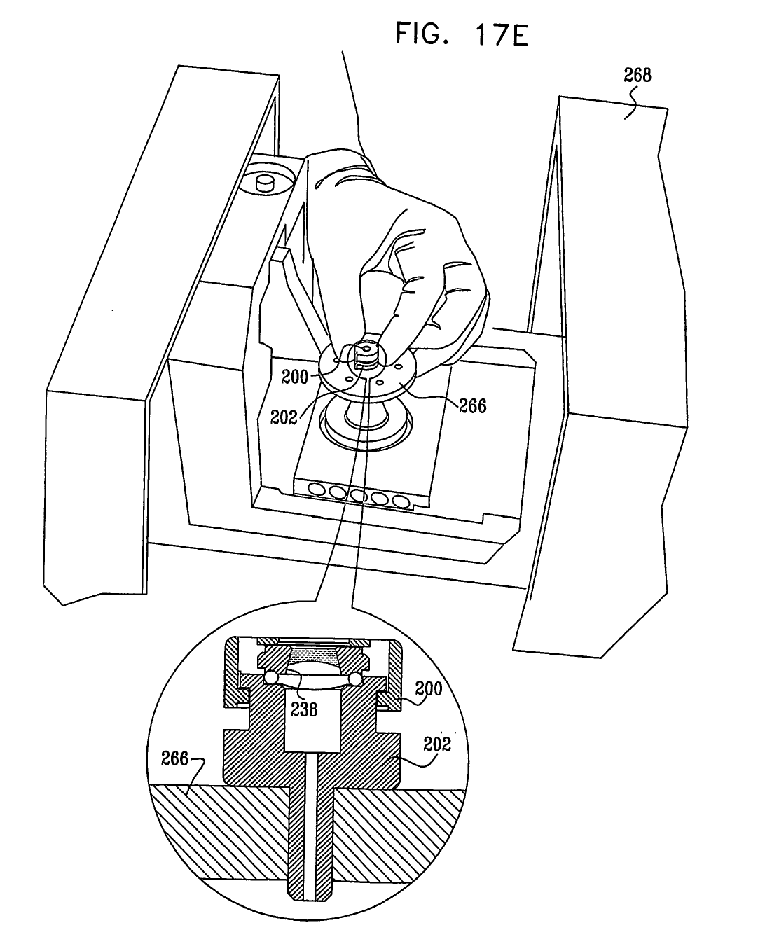

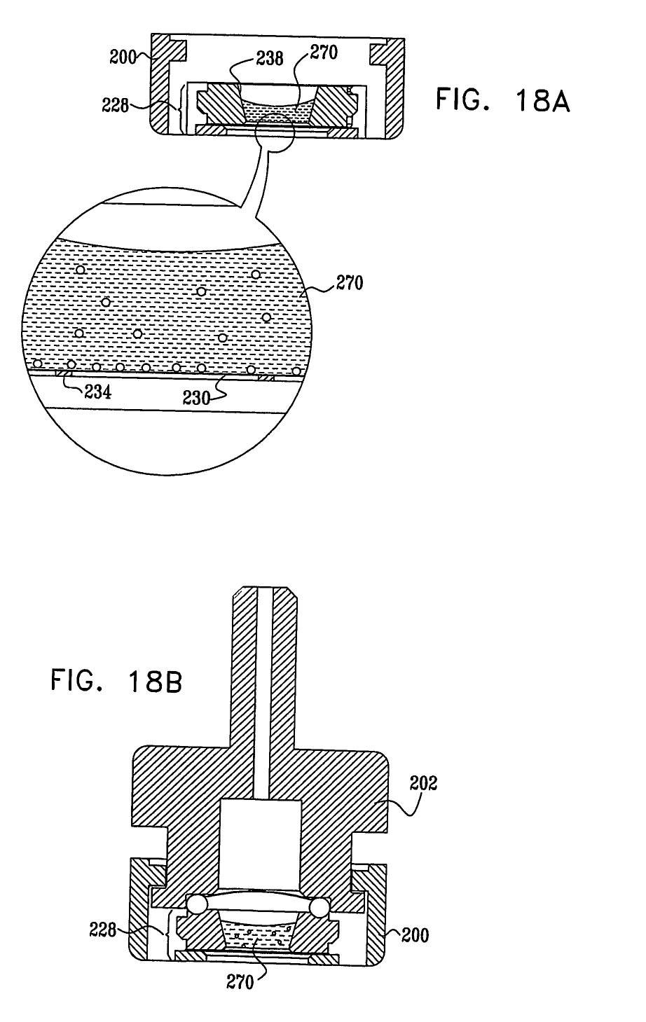

Reference is now made to FIGS. 17A, 17B, 17C, 17D and 17E, which are simplified sectional illustrations of cell growth, liquid removal, liquid addition, sealing and insertion into a SEM respectively using the SEM compatible sample container of FIGS. 11A-16C. Turning to FIG. 17A, which is identical to FIG. 7A and illustrates a typical cell culture situation, it is seen that the enclosure element 200 having disposed therewithin subassembly 228 is in the orientation shown in FIG. 11A and cells 262 in a liquid medium 264 are located within liquid sample enclosure 238, the cells 262 lying against the electron beam permeable, fluid impermeable, membrane 230.

FIG. 17B, which is identical to FIG. 7B, shows removal of liquid from liquid sample enclosure 238, typically by aspiration, and FIG. 17C, which is identical to FIG. 7C, shows addition of liquid to liquid sample enclosure 238. It is appreciated that multiple occurrences of liquid removal and addition may take place with respect to a sample within liquid sample enclosure 238. Preferably, the apparatus employed for liquid removal and addition is designed or equipped such as to prevent inadvertent rupture of the electron beam permeable, fluid impermeable, membrane 230.

FIG. 17D illustrates closing of the container containing the cells 262, seen in FIG. 17C, in a liquid medium 264. FIG. 17E shows the closed container, in the orientation of FIG. 11B, being inserted onto a stage 266 of a SEM 268. It is appreciated that there exist SEMs wherein the orientation of the container is opposite to that shown in FIG. 17E.

FIGS. 17A-17D exemplify a situation wherein at least a portion of a liquid containing sample remains in contact with the electron beam permeable, fluid impermeable, membrane 230 notwithstanding the addition or removal of liquid from liquid sample enclosure 238. This situation may include situations wherein part of the sample is adsorbed or otherwise adhered to the electron beam permeable, fluid impermeable, membrane 230. Examples of liquid containing samples may include cell cultures, blood, bacteria and a cellular material.

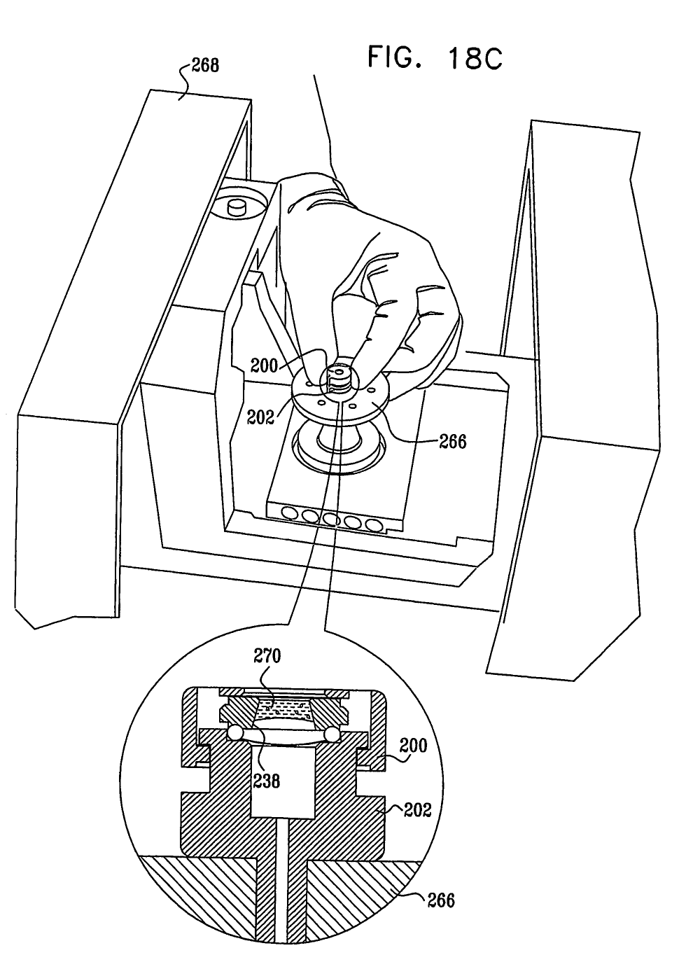

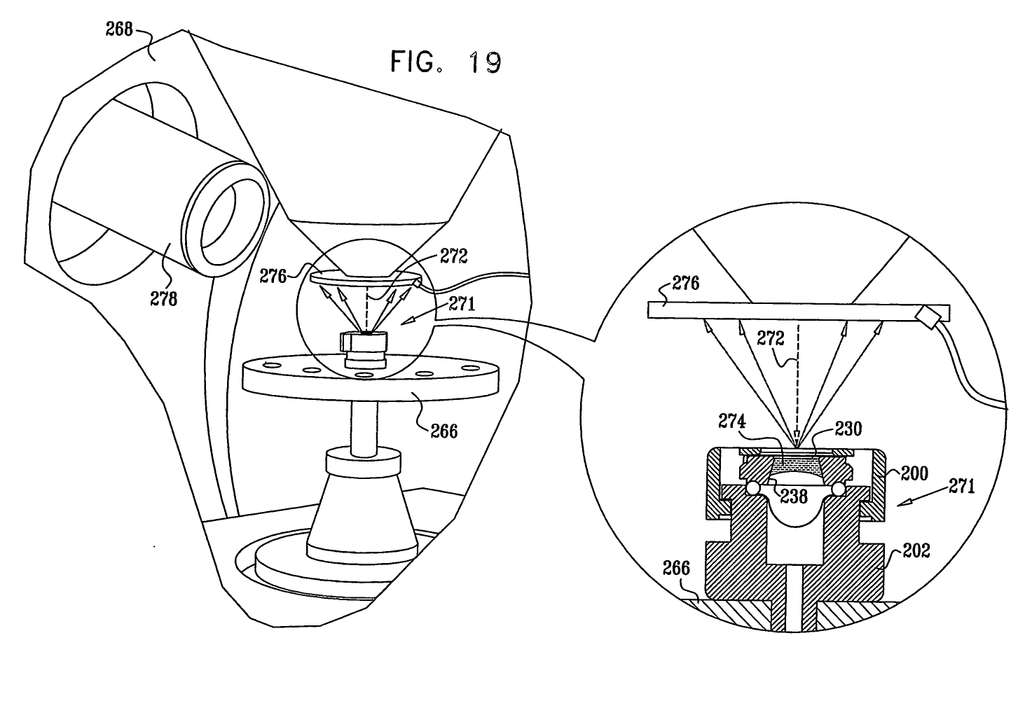

Reference is now made to FIGS. 18A, 18B and 18C which are simplified sectional illustrations of liquid containing samples in contact with the electron beam permeable, fluid impermeable, membrane 230, sealing and insertion into a SEM, respectively, using the SEM compatible sample container of FIGS. 11A-16C. FIGS. 18A-18C exemplify a situation wherein at least a portion of a liquid containing sample 270 is in contact with the electron beam permeable, fluid impermeable, membrane 230 but is not adhered thereto. Examples of liquid containing samples may include various emulsions and suspensions such as milk, cosmetic creams, paints, inks, and pharmaceuticals in liquid form. It is seen that the enclosure element 200, having disposed therewithin subassembly 228 in FIGS. 18A-18B, is in the orientation shown in FIG. 11A. FIG. 18A is identical to FIG. 8A.

FIG. 18B illustrates closing of the container containing the sample 270. FIG. 18C shows the closed container, in the orientation of FIG. 11B, being inserted onto stage 266 of SEM 268. It is appreciated that there exist SEMs wherein the orientation of the container is opposite to that shown in FIG. 18C.

Reference is now made to FIG. 19, which is a simplified pictorial and sectional illustration of SEM inspection of a sample using the SEM compatible sample container of FIGS. 11A-16C. As seen in FIG. 19, the container, here designated by reference numeral 271, is shown positioned on stage 266 of SEM 268 such that an electron beam 272, generated by the SEM, passes through electron beam permeable, fluid impermeable, membrane 230 and impinges on a liquid containing sample 274 within container 271. Backscattered electrons from sample 274 pass through electron beam permeable, fluid impermeable, membrane 230 and are detected by a detector 276, forming part of the SEM 268. One or more additional detectors, such as a secondary electron detector 278, may also be provided. An X-ray detector (not shown) may also be provided for detecting X-ray radiation emitted by the sample 274 due to electron beam excitation thereof and a cathodoluminescent detector (not shown) may also be provided for detecting radiation emitted by the sample 274 due to electron beam excitation thereof.

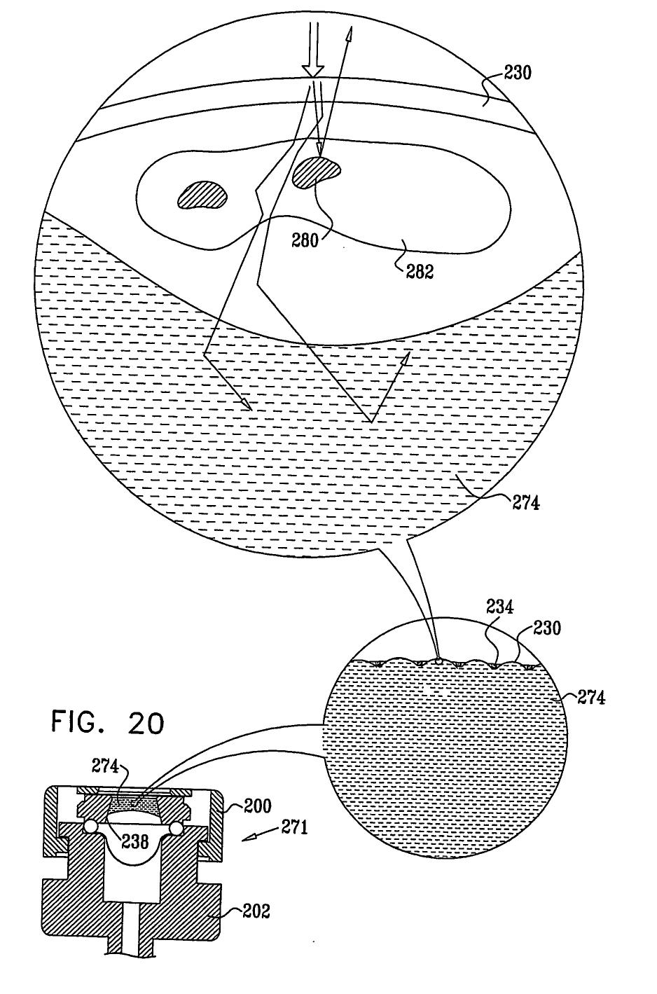

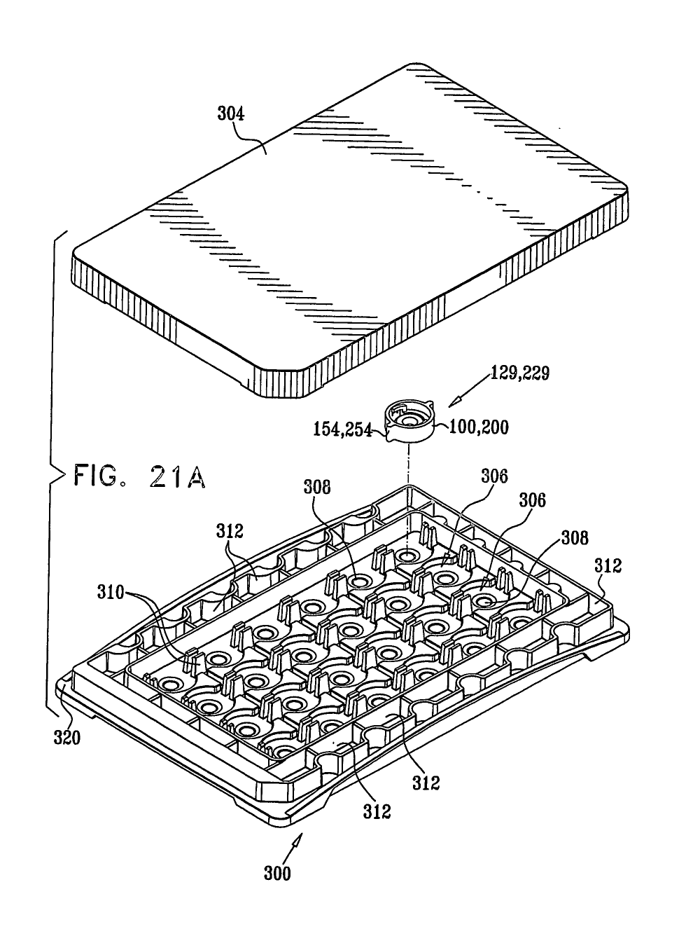

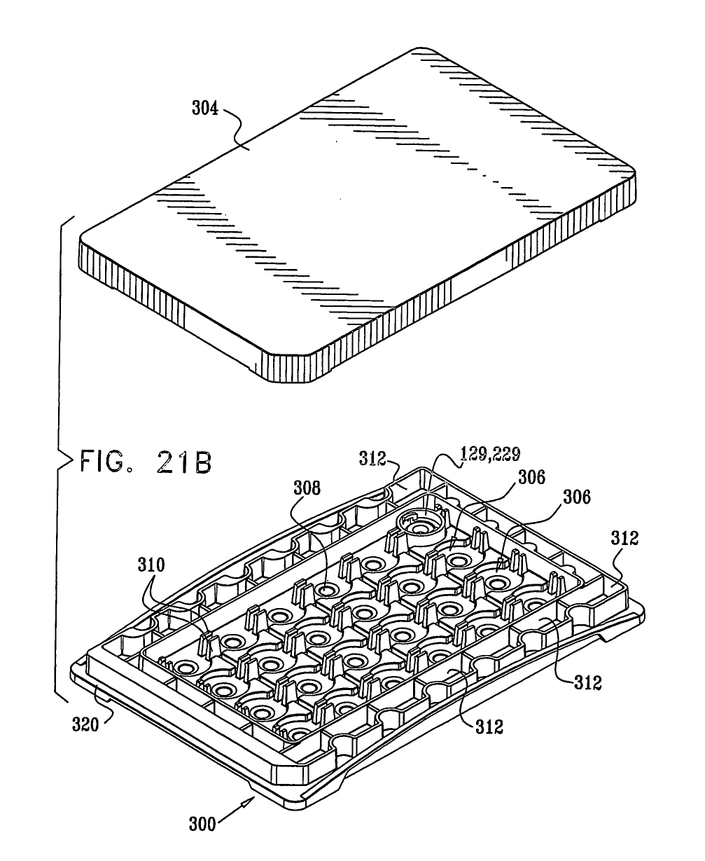

Reference is now made additionally to FIG. 20, which schematically illustrates some details of the electron beam interaction with the sample 274 in container 270 in accordance with a preferred embodiment of the present invention. It is noted that the present invention enables high contrast imaging of features which are distinguished from each other by their average atomic number, as illustrated in FIG. 20. In FIG. 20 it is seen that nucleoli 280 having a relatively high average atomic number, backscatter electrons more than the surrounding nucleoplasm 282.

It is also noted that in accordance with a preferred embodiment of the present invention, imaging of the interior of the sample to a depth of up to approximately 2 microns is achievable for electrons having an energy level of less than 50 KeV, as seen in FIG. 20, wherein nucleoli 280 disposed below electron beam permeable, fluid impermeable, membrane 230 are imaged.

Reference is now made to FIGS. 21A and 21B, which are simplified exploded view illustrations of a pre-microscopy multi-sample holder in use with SEM compatible sample containers of the type shown in FIGS. 1A-20. As seen in FIGS. 21A and 21B, the pre-microscopy multi-sample holder preferably comprises a base 300, and a cover 304. Cover 304 is preferably provided to maintain sterility within the interior of the pre-microscopy multi-sample holder.

The base 300 is preferably injection molded of a plastic material and defines an array of container support locations 306. Each container support location 306 is preferably defined by a recess 308 having a light transparent bottom wall through which light microscopy may take place. Adjacent to each recess 308 there is preferably formed a pair of mutually aligned pairs of upstanding mutually spaced protrusions 310 arranged to receive protrusions, designated by reference numeral 154 in FIGS. 1A-5B and 254 in FIGS. 11A-15B, on enclosure elements, designated by reference numeral 100 in FIGS. 1A-5B and 200 in FIGS. 11A-15B, thereby fixing the azimuthal alignment thereof.

Base 300 preferably also defines a plurality of liquid reservoirs 312 which are adapted to hold liquid used to maintain a desired level of humidity in the interior of the pre-microscopy multi-sample holder. Base 300 is preferably formed with a floor 320.

Cover 304 is provided to maintain sterility of the interior of the pre-microscopy multi-sample holder. Cover 304 is preferably transparent to light. The pre-microscopy multi-sample holder of FIGS. 21A and 21B is preferably dimensioned so as to be compatible with conventional cell biology equipment, such as light microscopes, centrifuges and automated positioning devices. Preferred dimensions are 85 mm×127 mm.

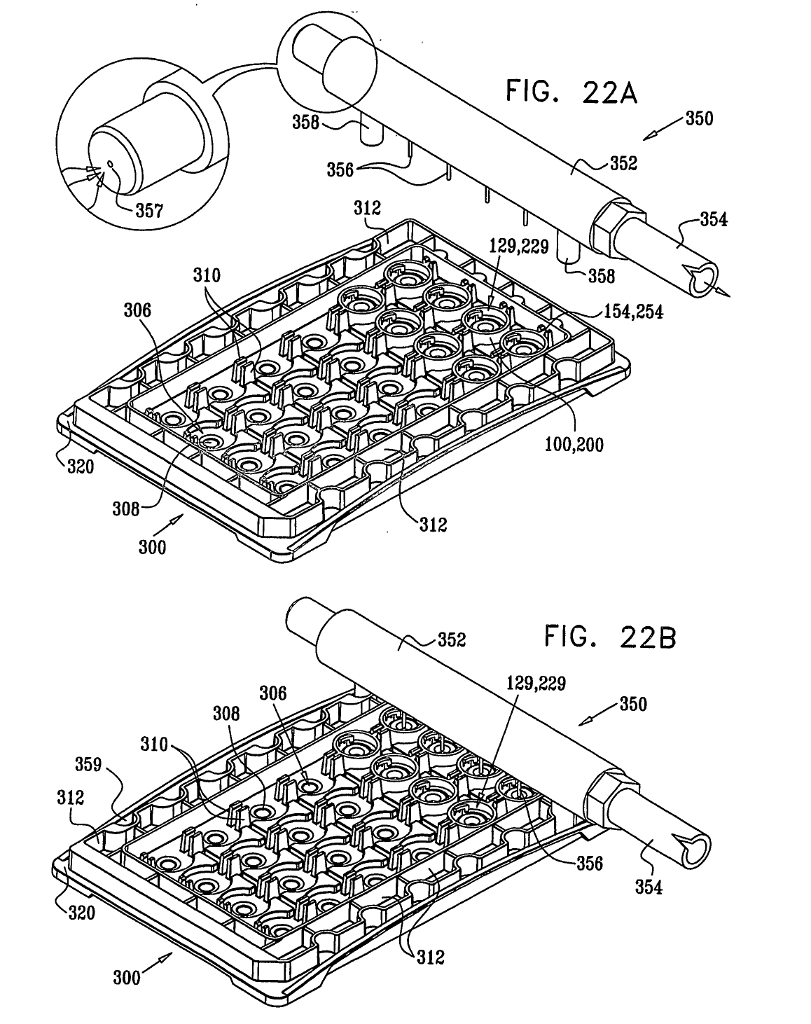

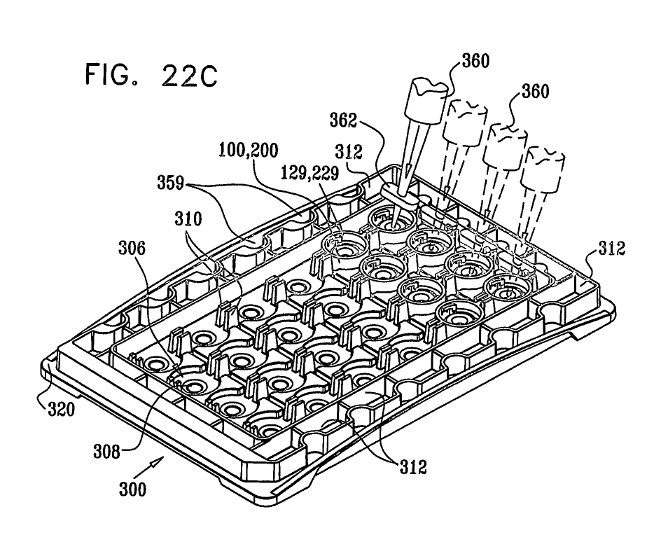

Reference is now made to FIGS. 22A, 22B and 22C, which are simplified illustrations of the pre-microscopy multi-sample holder of FIGS. 21A and 21B respectively associated with a suction device and pipettes. Turning to FIG. 22A, it is seen that the suction device, here designated by reference numeral 350, comprises a manifold 352 coupled via a conduit 354 to a source of suction. The manifold 352 preferably communicates with a linear array of uniformly spaced needles 356. Preferably, the manifold 352 is formed with an orifice 357 on one end thereof to provide for enhanced suction and independent suction operation of individual needles 356.

A pair of spacers 358 is attached to the manifold 352 or is integrally formed therewith. Spacers 358 are arranged in line with the linear array of needles 356. These spacers 358 preferably engage floor 320 of base 300 at recesses 359 on opposite sides of base 300. The spacers 358 ensure that the needles 356 do not engage electron beam permeable, fluid impermeable, membrane, designated by reference numeral 130 in FIGS. 1A-10 and 230 in FIGS. 11A-20. Spacers 358 engage recesses 359 such that needles 356 are aligned along the sides of sample dishes, designated by reference numeral 129 in FIGS. 3A-5B and 229 in FIGS. 13A-15B, so as to prevent the needles 356 from dislodging a sample in the sample dish.

As seen in FIG. 22A, the container support locations 306 are arranged in straight rows on the pre-microscopy multi-sample holder. Thus, as seen in FIG. 22B, in every row, four of the needles 356 engage the sample dishes.

FIG. 22C illustrates addition of liquid to the individual sample dishes by means of conventional pipettes 360 Collar elements 362 may be provided for use in association with pipettes 360 to prevent inadvertent engagement of the pipettes with the electron beam permeable, fluid impermeable, membrane, designated by reference numeral 130 in FIGS. 1A-10 and 230 in FIGS. 11A-20.

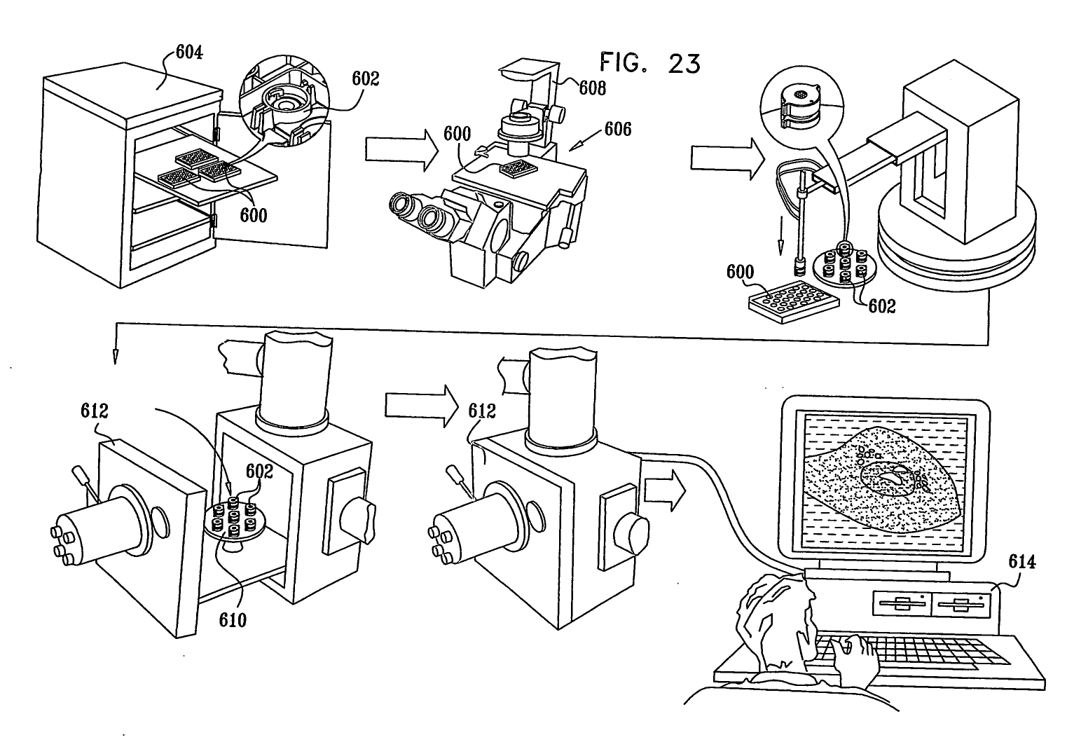

Reference is now made to FIG. 23, which is a simplified illustration of a SEM based sample inspection system constructed and operative in accordance with a preferred embodiment of the present invention. As seen in FIG. 23, a plurality of pre-microscopy multi-sample holders 600, each containing a multiplicity of SEM compatible sample containers 602 of the type shown in FIGS. 1A-20, is shown in an incubator 604. Preferably, light microscopy inspection of the samples in containers 602 is carried out while the containers 602 are mounted in holder 600, as indicated by reference numeral 606, in order to identify samples of interest. Preferably an inverted light microscope 608 is employed for this purpose.

Preferably automated positioning systems, such as robotic arms, as shown, are used for conveying the pre-microscopy multi-sample holders 600 and the containers 602 throughout the system, it being appreciated that manual intervention may be employed at one or more stages as appropriate.

Thereafter, individual containers 602 are removed from holders 600 and placed on a removable electron microscope specimen stage 610, which is subsequently introduced into a scanning electron microscope 612. The resulting image may be inspected visually by an operator and/or analyzed by conventional image analysis functionality, typically embodied in a computer 614.

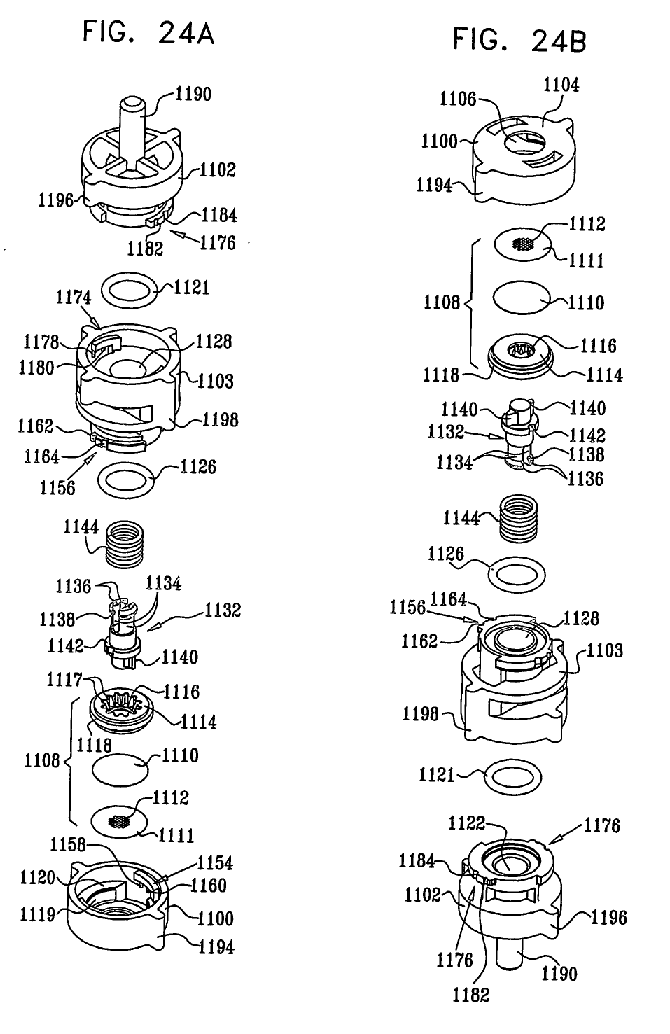

Reference is now made to FIGS. 24A-28B, which are oppositely facing simplified exploded view pictorial illustrations of a disassembled scanning electron microscope (SEM) compatible sample container constructed and operative in accordance with another preferred embodiment of the present invention. As seen in FIGS. 24A & 24B, the SEM compatible sample container comprises first and second enclosure elements, respectively designated by reference numerals 1100 and 1102 and a connecting element 1103 arranged for enhanced ease and speed of closure. Enclosure elements 1100 and 1102 and connecting element 1103 are preferably molded of plastic and coated with a conductive metal coating.

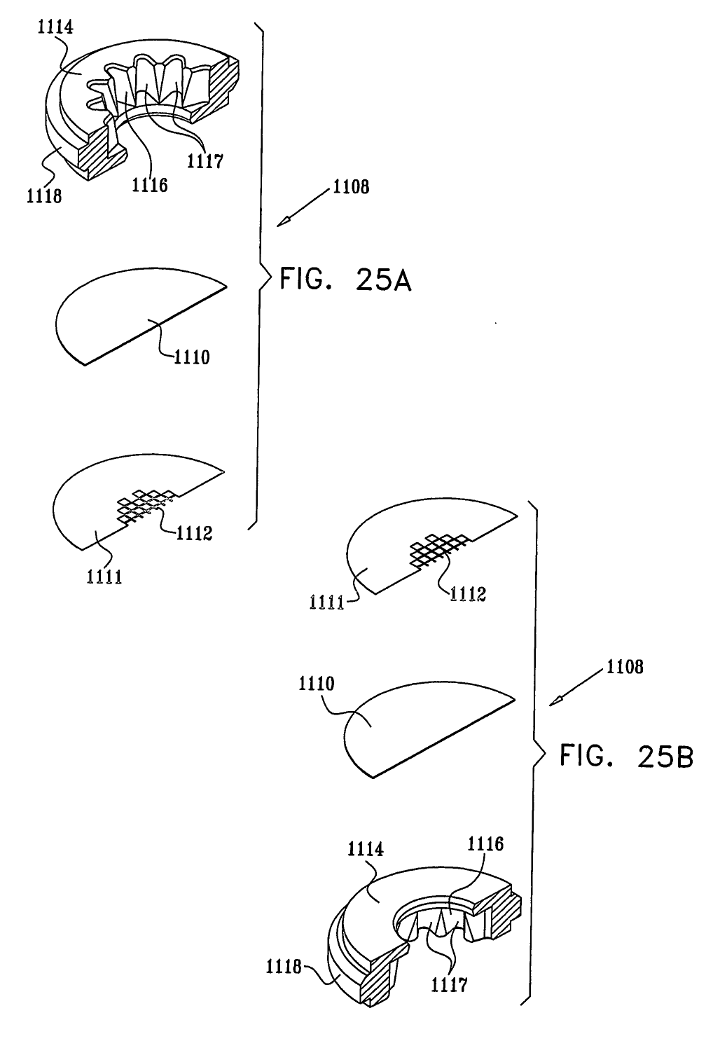

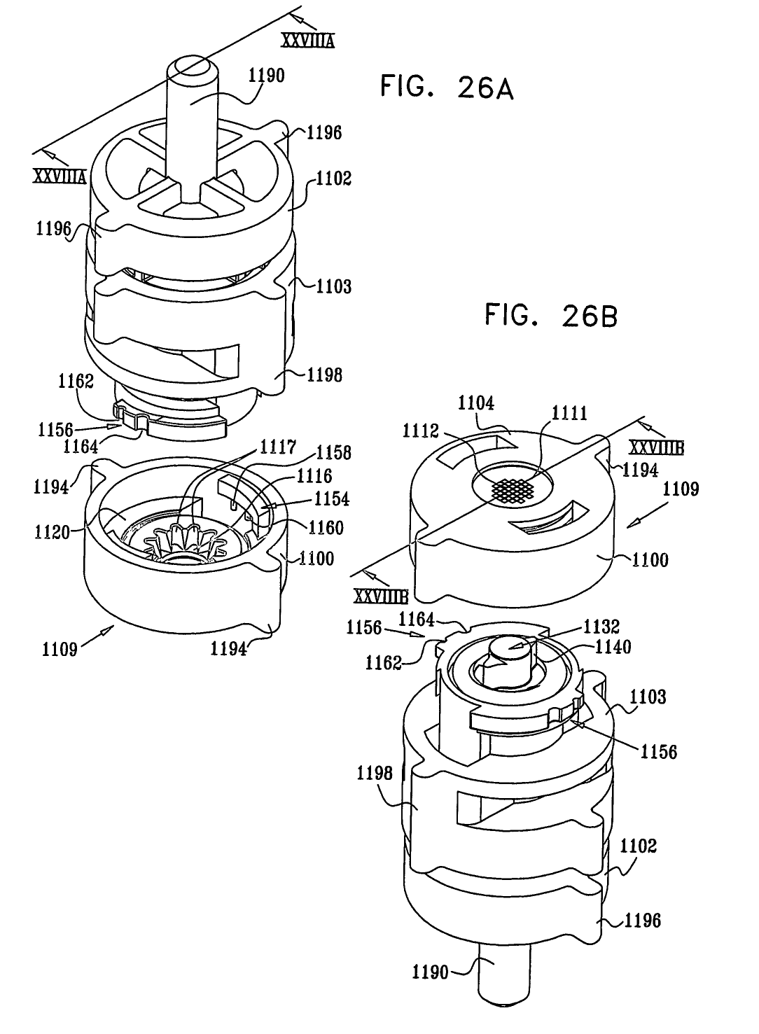

First enclosure element 1100 preferably defines a sample enclosure and has a base surface 1104 having a generally central aperture 1106. An electron beam permeable, fluid impermeable, membrane subassembly 1108, shown in detail in FIGS. 25A and 25B, is seated inside enclosure element 1100 against and over aperture 1106, as shown in FIGS. 26A & 26B and 28A & 28B. A sample dish comprising subassembly 1108 suitably positioned in enclosure element 1100 is designated by reference numeral 1109, as shown in FIGS. 26A-28B.

Turning additionally to FIGS. 25A and 25B, it is seen that an electron beam permeable, fluid impermeable, membrane 1110, preferably a polyimide membrane, such as Catalog No. LWN00033, commercially available from Moxtek Inc. of Orem, Utah, U.S.A., is adhered, as by an adhesive, to a grid support element 1111, which defines at its center a mechanically supporting grid 1112. Grid 1112, which is not shown to scale, is preferably configured to define an asymmetrical array of apertures to provide reference orientation indication functionality so as to assist users in identifying the location of a sample region in respect to the SEM compatible sample container and is preferably formed by photochemical etching of stainless still sheets, commercially available from Suron Ltd. of Kibutz Maagan Michael, Israel.

A sample enclosure defining ring 1114 is adhered to electron beam permeable, fluid impermeable, membrane 1110, preferably by an adhesive, such as Catalog No. 1193MVLV, commercially available from Dyamx corporation of 51 Greenwoods Road, Torrington, Conn. 06790, USA. Ring 1114 is preferably formed of PMMA (polymethyl methacrylate), such as Catalog No. 692106001000, commercially available from Irpen of Barcelona, Spain, and preferably defines a sample enclosure with a volume of approximately 20 microliters and a height of approximately 2 mm. Preferably ring 1114 is configured to define a sample enclosure 1116 having interior inclined walls configured to define a plurality of radially distributed grooves 1117. Ring 1114 is also preferably formed on an external surface thereof with a circumferential rim 1118 operative to engage recesses 1119 formed in protruded portions 1120 of first enclosure element 1100 so as to securely seat ring 1114 in first enclosure element 1100.

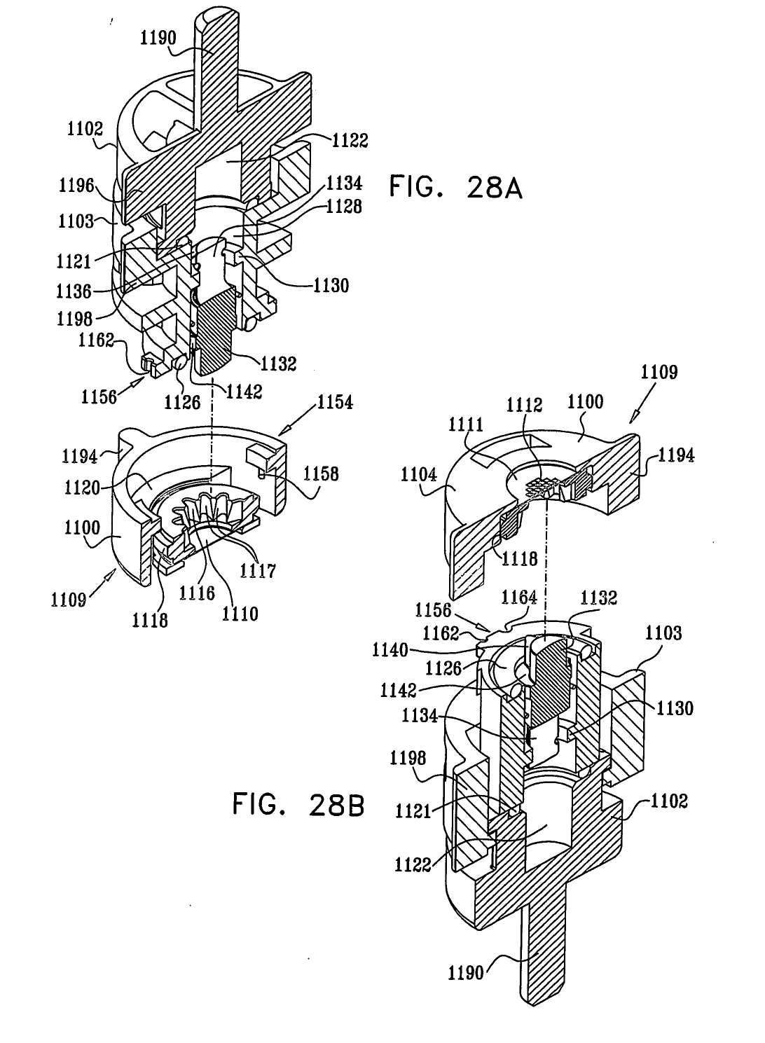

As seen in FIGS. 24A, 24B, 28A and 28B, a first O-ring 1121 is preferably disposed between an interior surface 1122 of second enclosure element 1102 and the connecting element 1103. A second O-ring 1126 is preferably disposed between connecting element 1103 and ring 1114 of subassembly 1108. O-rings 1121 and 1126 are operative, when enclosure elements 1100 and 1102 and connecting element 1103 are in tight engagement, to obviate the need for the engagement of elements 1100 and 1102 and connecting element 1103 to be a sealed engagement.

Connecting element 1103 preferably has a recess 1128. Connecting element 1103 is also formed with a circumferential protrusion 1130, seen in FIGS. 28A & 28B, protruding into recess 1128.

A positioner 1132 is preferably comprised of two upright flexible projections 1134, each with a ridge 1136 formed on an end portion 1138 of the projections 1134. Positioner 1132 is preferably molded of plastic. Projections 1134 press against each other when inserted into recess 1128 of connecting element 1103 and then snap back to an upright position once ridges 1136 are seated on the protrusion 1130 of connecting element 1103, as shown in FIGS. 28A & 28B.

Positioner 1132 is preferably also provided with respective radially extending positioning and retaining protrusions 1140 extending from a rim 1142. Positioning and retaining protrusions 1140 are seated in grooves 1117 of ring 1114 so as to prevent rotation of positioner 1132 within ring 1114.

A coil spring 1144 is disposed on positioner 1132 between rim 1142 and ridges 1136 of projections 1134. Spring 1144 is preferably formed of hardened stainless steel.

The positioner 1132 and spring 1144 are operative to move a non-liquid sample up and against electron beam permeable, fluid impermeable, membrane 1110 when enclosure elements 1100 and 1102 and connecting element 1103 are in tight engagement.

First enclosure element 1100 engages connecting element 1103 by connecting a protruded portion 1154 formed in first enclosure element 1100 to a bayonet-type socket 1156 formed in connecting element 1103.

Protruded portion 1154 preferably comprises a first protrusion 1158 and a second protrusion 1160, which communicate with a first recess 1162 and a second recess 1164 formed in bayonet-type socket 1156. Initial engagement of protrusion 1158 with recess 1162 provides for a loose engagement of first enclosure element 1100 and connecting element 1103 so as to prevent inadvertent damage of the SEM compatible sample container, such as during shipping and handling. Subsequent engagement of protrusion 1158 with recess 1164 provides for a tight engagement of first enclosure element 1100 and connecting element 1103.

Second enclosure element 1102 engages connecting element 1103 by connecting a protruded portion 1174 formed in connecting element 1103 to a bayonet-type socket 1176 formed in second enclosure element 1102.

Protruded portion 1174 preferably comprises a first protrusion 1178 and a second protrusion 1180, which communicate with a first recess 1182 and a second recess 1184 formed in bayonet-type socket 1176. Initial engagement of protrusion 1178 with recess 1182 provides for a loose engagement of second enclosure element 1102 and connecting element 1103 so as to prevent inadvertent damage of the SEM compatible sample container, such as during shipping and handling. Subsequent engagement of protrusion 1178 with recess 1184 provides for a tight engagement of second enclosure element 1102 and connecting element 1103.

Second enclosure element 1102 is preferably formed with a generally central stub 1190, which is arranged to be seated in a suitable recess (not shown) in a specimen stage of a scanning electron microscope. It is a particular feature of the present invention that the container, shown in FIGS. 24A-33, is sized and operative with conventional stub recesses in conventional SEMs and does not require any modification thereof whatsoever. It is appreciated that various configurations and sizes of stubs may be provided so as to fit various SEMs.

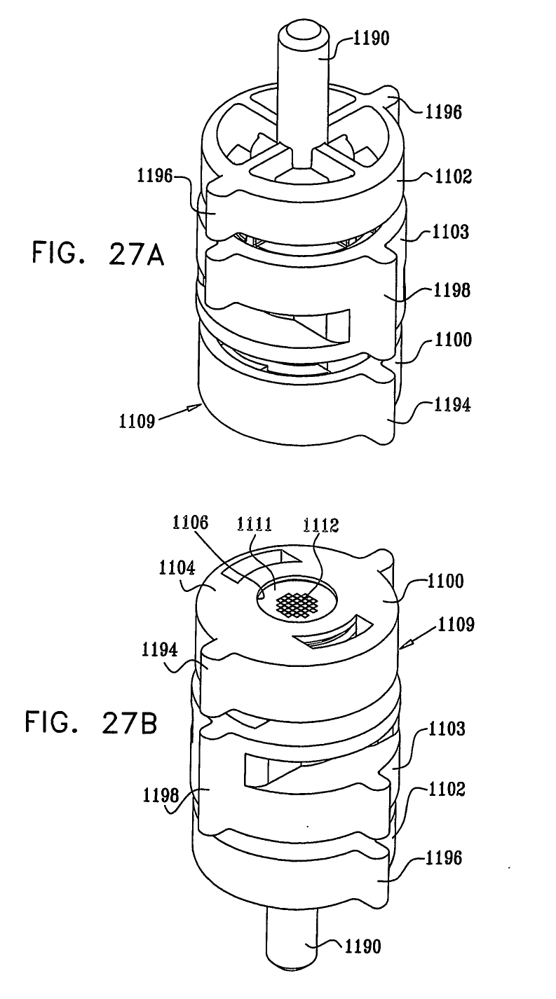

Enclosure elements 1100 and 1102 and connecting element 1103 are preferably also provided with respective radially extending positioning and retaining protrusions 1194, 1196 and 1198, to enable the container to be readily seated in a suitable multi-container holder and also to assist users in opening and closing the enclosure elements 1100 and 1102 and connecting element 1103. Preferably, the mutual azimuthal positioning of the protrusions 1194, 1196 and 1198 on respective enclosure elements 1100 and 1102 and connecting element 1103 is such that mutual azimuthal alignment therebetween indicates a tight engagement therebetween, as shown in FIGS. 27A and 27B.

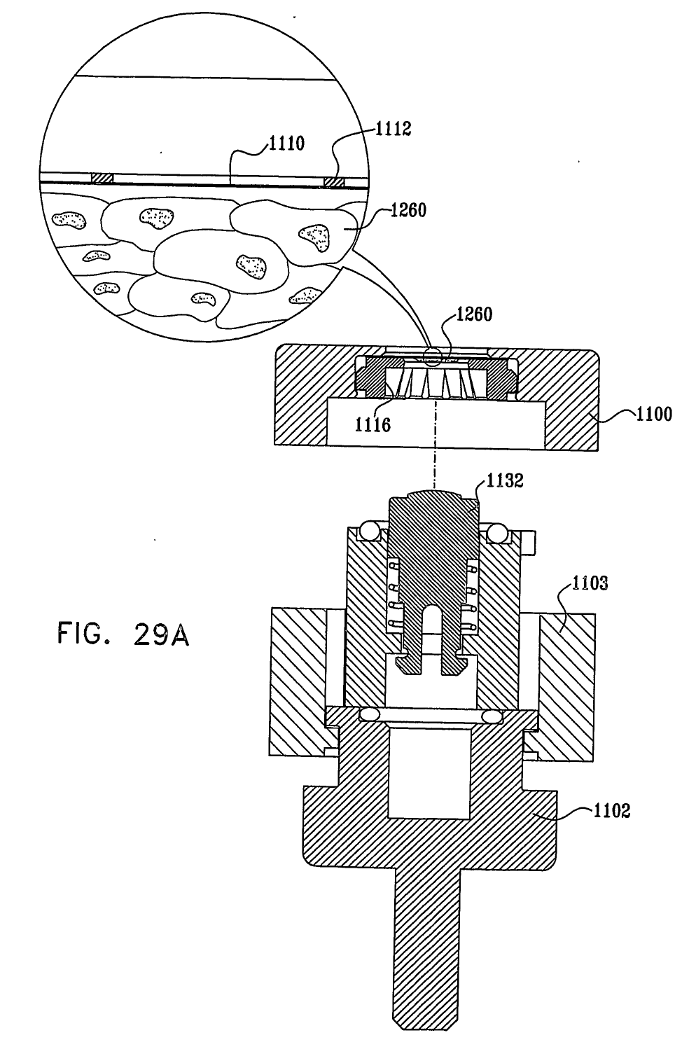

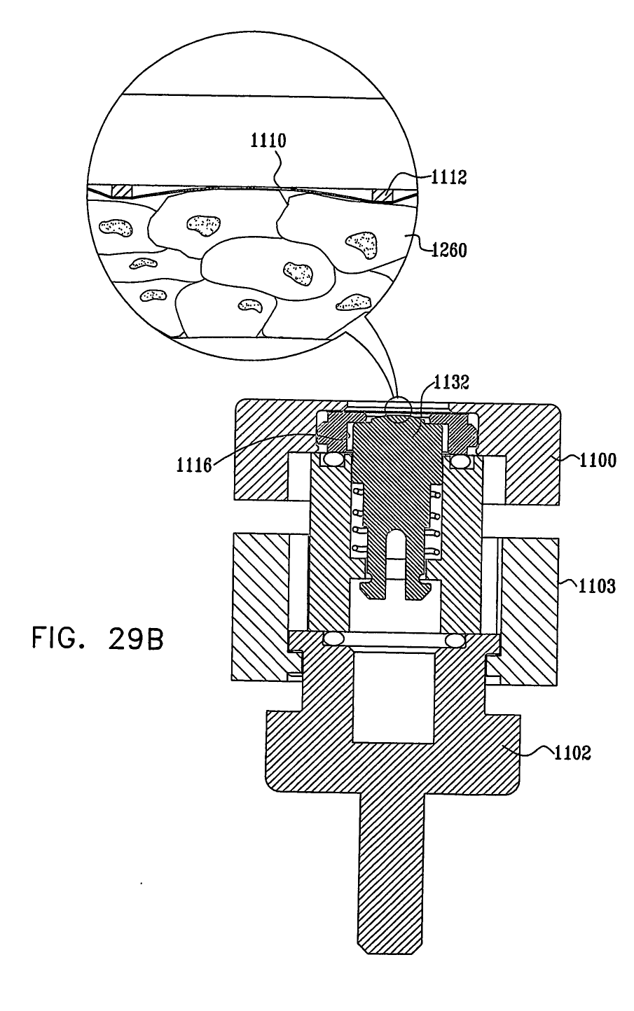

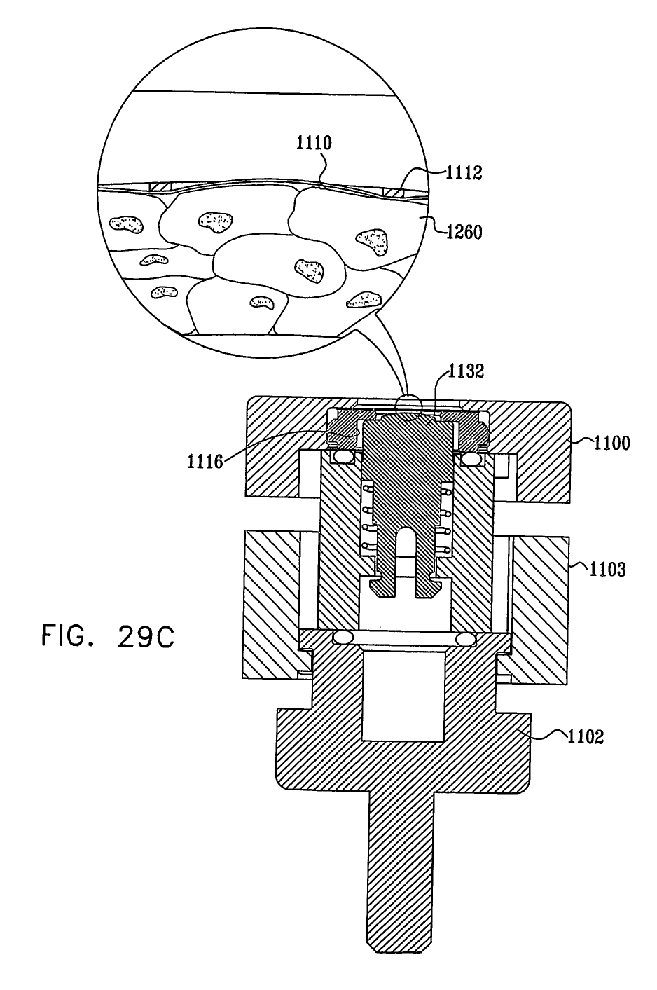

Reference is now made to FIGS. 29A, 29B & 29C, which are three sectional illustrations showing the operative orientation of the SEM compatible sample container of FIGS. 24A-28B at three stages of operation. FIG. 29A shows the container of FIGS. 24A-28B containing a tissue sample 1260 and arranged in the orientation shown in FIG. 24B, prior to closure of enclosure elements 1100 and 1102 and connecting element 1103. The electron beam permeable, fluid impermeable, membrane 1110 is seen in FIG. 29A to be generally planar.

FIG. 29B shows the container of FIG. 29A immediately following full engagement between enclosure elements 1100 and 1102 and connecting element 1103 producing sealing of the tissue sample enclosure 1116 from the ambient. It is noted that the tissue sample 1260 is in close contact with the electron beam permeable, fluid impermeable, membrane 1110 due to the force exerted by the positioner 1132. It is seen that the electron beam permeable, fluid impermeable, membrane 1110 bows outwardly due to pressure buildup in the tissue sample enclosure 1116 as the result of sealing thereof in this manner. Supporting grid 1112 is seen to be generally planar.

FIG. 29C illustrates the container of FIG. 29B, when placed in an evacuated environment of a SEM, typically at a vacuum of 10⁻²-10⁻⁶ millibars. It is seen that in this environment, the electron beam permeable, fluid impermeable, membrane 1110 and support grid 1112 bow outwardly to a greater extent than in the ambient environment of FIG. 29B and further that the electron beam permeable, fluid impermeable, membrane 1110 tends to be forced into and through the interstices of grid 1112 to a greater extent than occurs in the ambient environment of FIG. 29B.

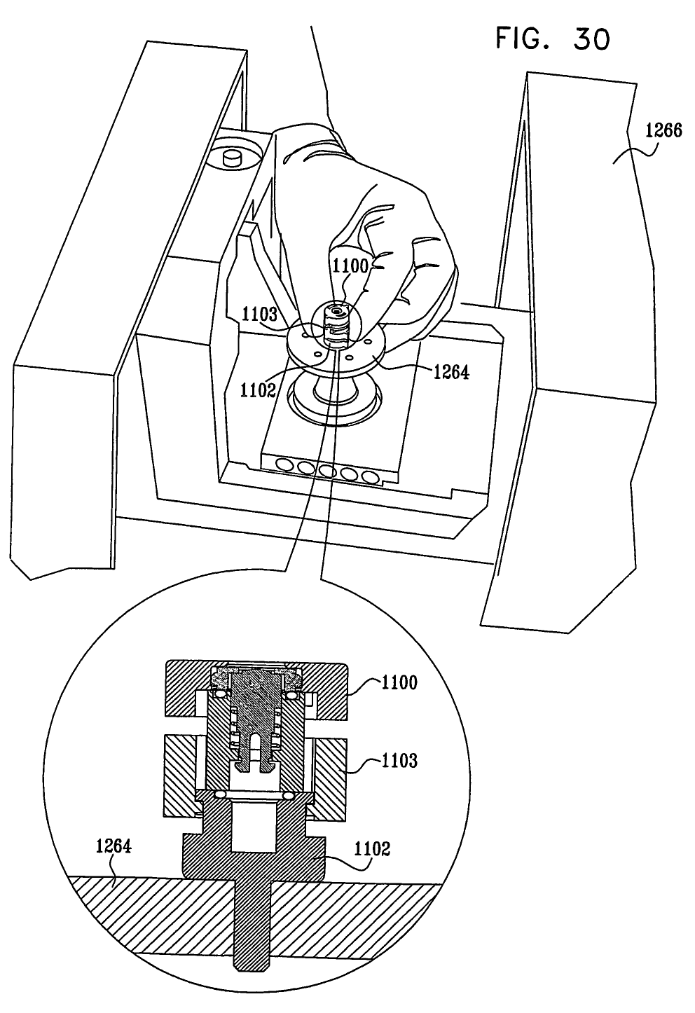

Reference is now made to FIG. 30, which is a simplified sectional and pictorial illustration of tissue containing sample and insertion into a SEM using the SEM compatible sample container of FIGS. 24A-29C. FIG. 30 shows the closed container, in the orientation of FIG. 24B, being inserted onto a stage 1264 of a SEM 1266. It is appreciated that there exist SEMs wherein the orientation of the container is opposite to that shown in FIG. 30.

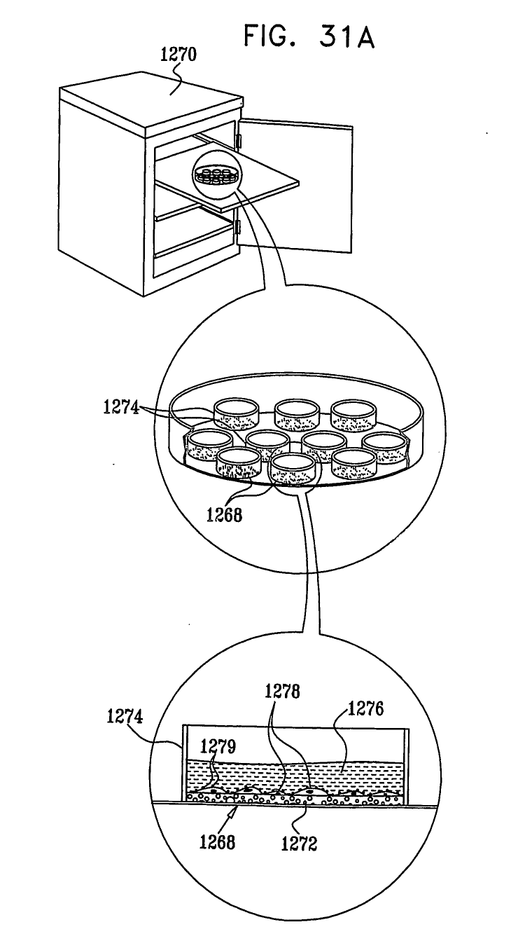

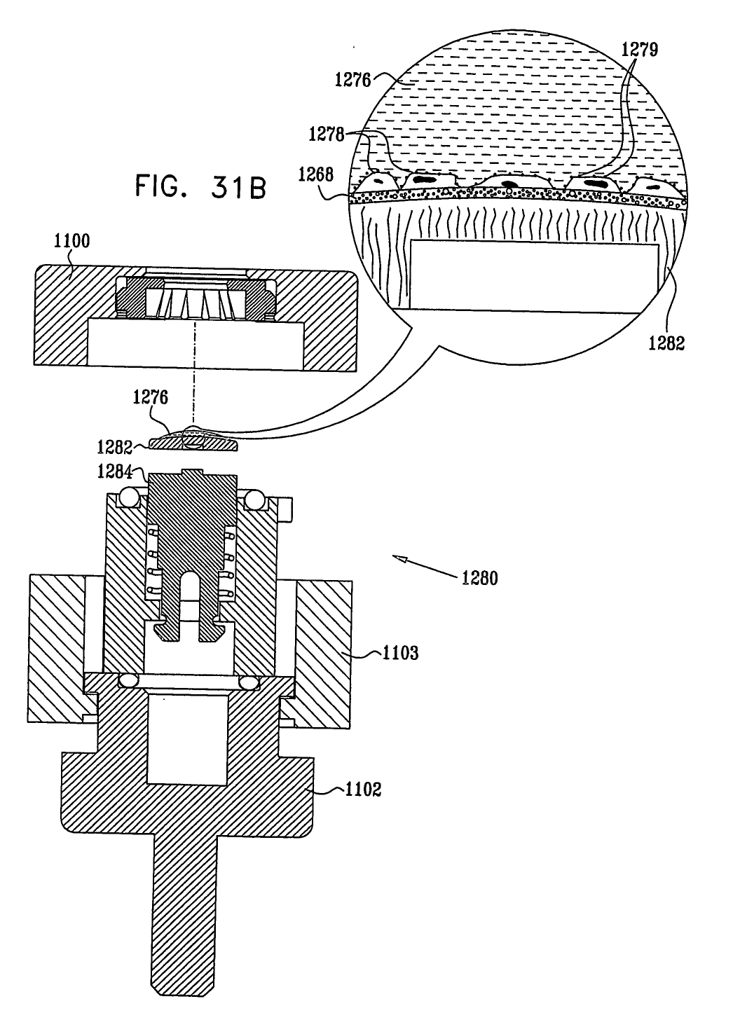

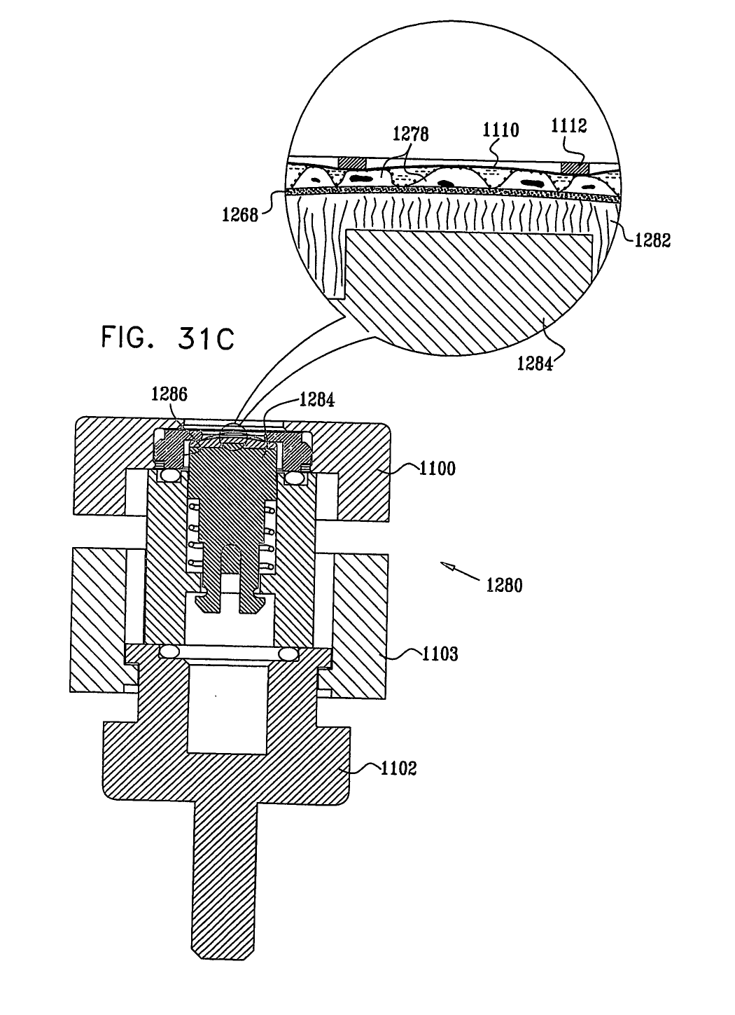

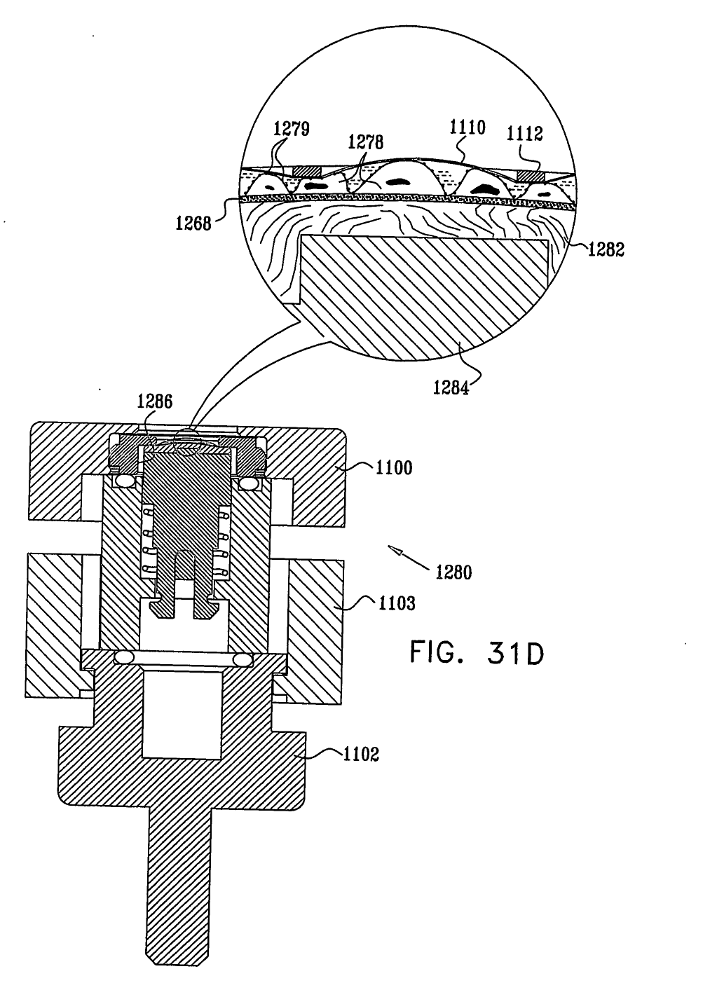

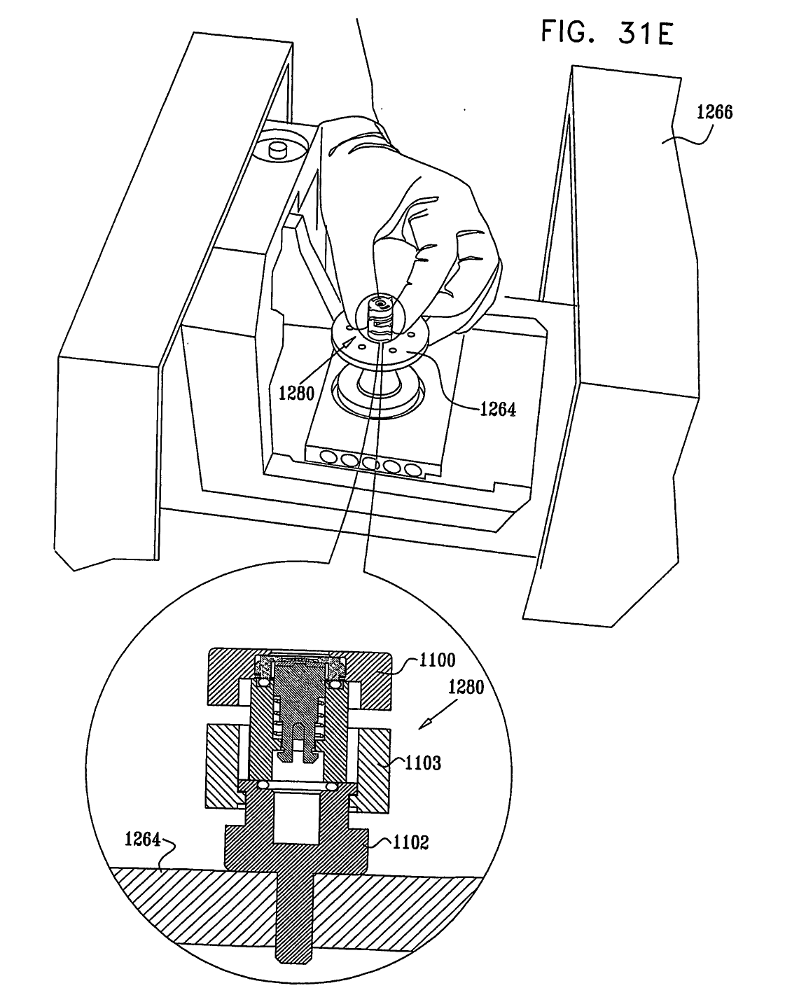

Reference is now made to FIGS. 31A, 31B, 31C, 31D and 31E, which are sectional illustrations showing the operative orientation of a variation of the SEM compatible sample container of FIGS. 24A-29B at various stages of operation and insertion into a SEM using the SEM compatible sample container.

FIG. 31A shows a plurality of flexible support elements, which are operative to support particles or cells, such as cell support elements, cell growth elements, fluid filter elements and cell stages 1268 typically placed in an incubator 1270. Cell stages 1268 are operative to allow growth of cells thereon or, alternatively, allow adherence of grown cells thereon. Each cell stage 1268 is preferably defined by a porous membrane 1272, which is surrounded by a ring 1274 and supports a sample 1276 including cells 1278. Porous membrane 1272 is preferably formed of polyester, such as a Transwell plate, Catalog number 3470, commercially available from Corning, Acton, Mass., USA. Cells 1278 are preferably supported by the porous membrane 1272 on a basal side of cells 1278 in a liquid medium. The porous membrane 1272 is operative to maintain a desired level of humidity in the sample during the stages of operation, such as during incubation in incubator 1270, as shown in FIG. 31A.

It is appreciated that cells 1278 or particles may be deposited on the flexible support elements by adsorption or by filtering a fluid containing the cells or the particles trough the porous membrane 1272.

As seen in FIG. 31A, molecules 1279, such as molecules of cells 1278 or extraneously added molecules are preferably provided on an apical side of the cells 1278. Preferably, molecules 1279 are linked to electron-dense structures such as gold colloids, which can be visualized in an electron microscope.

FIG. 31B shows a SEM compatible sample container 1280, identical to the container of FIGS. 24A-28B other than as specified hereinbelow, containing the cell stage 1268, which supports cells 1278 and is mounted on a platform 1282, preferably formed of a non-rigid material. The container 1280 is arranged in the orientation shown in FIG. 24B, prior to closure of enclosure elements 1100 and 1102 and connecting element 1103. Cell platform 1282 is mounted onto a suitably configured positioner 1284, which corresponds to positioner 1132 in the embodiment of FIGS. 24A-30. Typically, the cells 1278 are grown onto cell stage 1268 in incubator 1270 while cell stage 1268 is not mounted onto platform 1282. The mounting of the cell stage 1268 onto platform 1282 and, in turn, the mounting of the platform 1282 with the cell stage 1268 onto positioner 1284 typically occurs just before SEM inspection takes place.

FIG. 31C shows the container 1280 of FIG. 31B immediately following full engagement between enclosure elements 1100 and 1102 and connecting element 1103 producing sealing of the cell sample enclosure, here designated by reference numeral 1286, from the ambient. It is noted that the sample containing cells 1278 is in close contact with the electron beam permeable, fluid impermeable, membrane 1110 due to the force exerted by the positioner 1284. It is seen that the electron beam permeable, fluid impermeable, membrane 1110 and the cell stage 1268 bow outwardly due to pressure buildup in the cell sample enclosure 1286 as the result of sealing thereof in this manner. The supporting grid 1112 is seen to be generally planar.

FIG. 31D illustrates the container of FIG. 31C, when placed in an evacuated environment of a SEM, typically at a vacuum of 10⁻²-10⁻⁶ millibars. It is seen that in this environment, the electron beam permeable, fluid impermeable, membrane 1110 and the cell stage 1268 bow outwardly to a greater extent than in the ambient environment of FIG. 31C and further that the electron beam permeable, fluid impermeable, membrane 1110 tends to be forced into and through the interstices of grid 1112 to a greater extent than occurs in the ambient environment of FIG. 31C. The grid 1112 is also seen to slightly bow outwardly in this environment.

FIG. 31E shows the closed container 1280, in the orientation of FIG. 24B, being inserted onto stage 1264 of SEM 1266. It is appreciated that there exist SEMs wherein the orientation of the container is opposite to that shown in FIG. 31E.

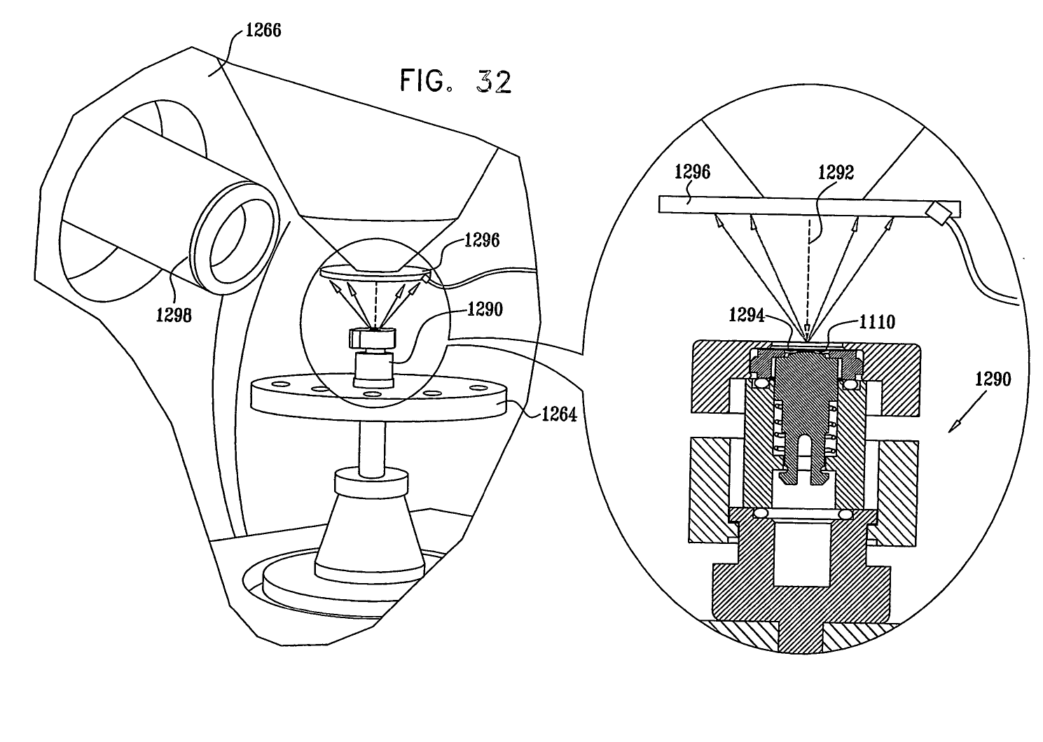

Reference is now made to FIG. 32, which is a simplified pictorial and sectional illustration of SEM inspection of a sample using the SEM compatible sample container of FIGS. 24A-30. As seen in FIG. 32, the container, here designated by reference numeral 1290, is shown positioned on stage 1264 of SEM 1266 such that an electron beam 1292, generated by the SEM, passes through electron beam permeable, fluid impermeable, membrane 1110 (FIGS. 24A-31D) and impinges on a tissue containing sample 1294 within container 1290. Backscattered electrons from sample 1294 pass through electron beam permeable, fluid impermeable, membrane 1110 and are detected by a detector 1296, forming part of the SEM. One or more additional detectors, such as a secondary electron detector 1298, may also be provided. An X-ray detector (not shown) may also be provided for detecting X-ray radiation emitted by the sample 1294 due to electron beam excitation thereof and a cathodoluminescent detector (not shown) may also be provided for detecting radiation emitted by the sample 1294 due to electron beam excitation thereof.

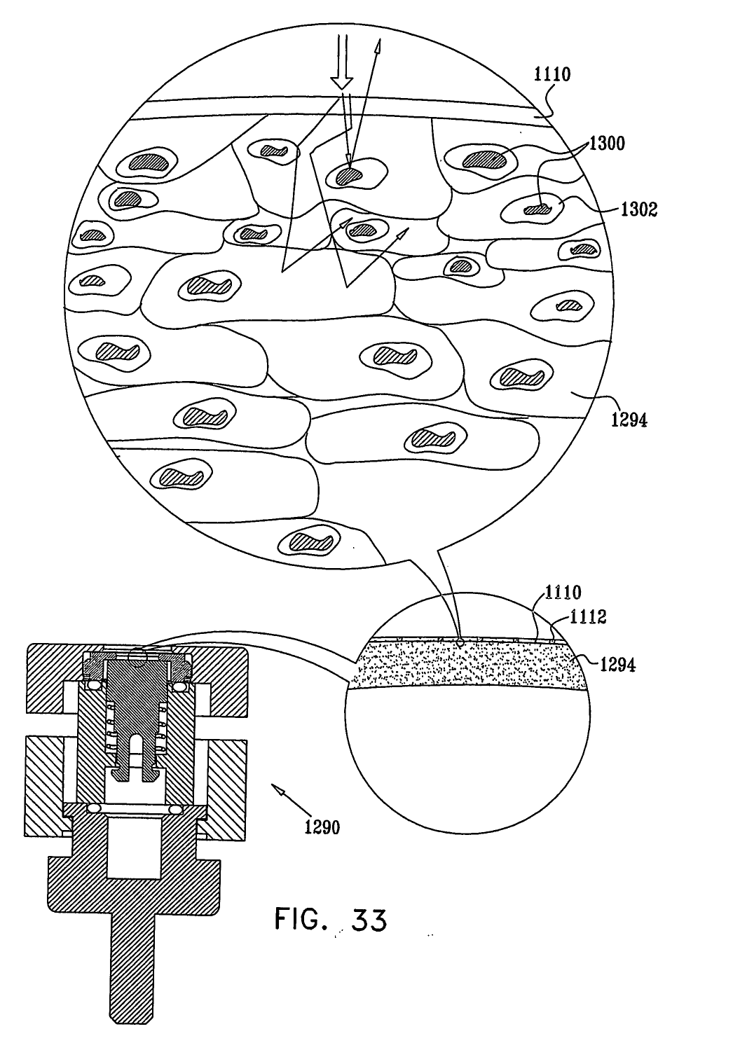

Reference is now made additionally to FIG. 33, which schematically illustrates some details of the electron beam interaction with the sample 1294 in container 1290 in accordance with a preferred embodiment of the present invention. It is noted that the present invention enables high contrast imaging of features which are distinguished from each other by their average atomic number, as illustrated in FIG. 33. In FIG. 33 it is seen that nucleoli 1300, having a relatively high average atomic number, backscatter electrons more than the surrounding nucleoplasm 1302.

It is also noted that in accordance with a preferred embodiment of the present invention, imaging of the interior of the sample to a depth of up to approximately 2 microns is achievable for electrons having an energy level of less than 50 KeV, as seen in FIG. 33, wherein nucleoli 1300 disposed below electron beam permeable, fluid impermeable, membrane 1110 are imaged.

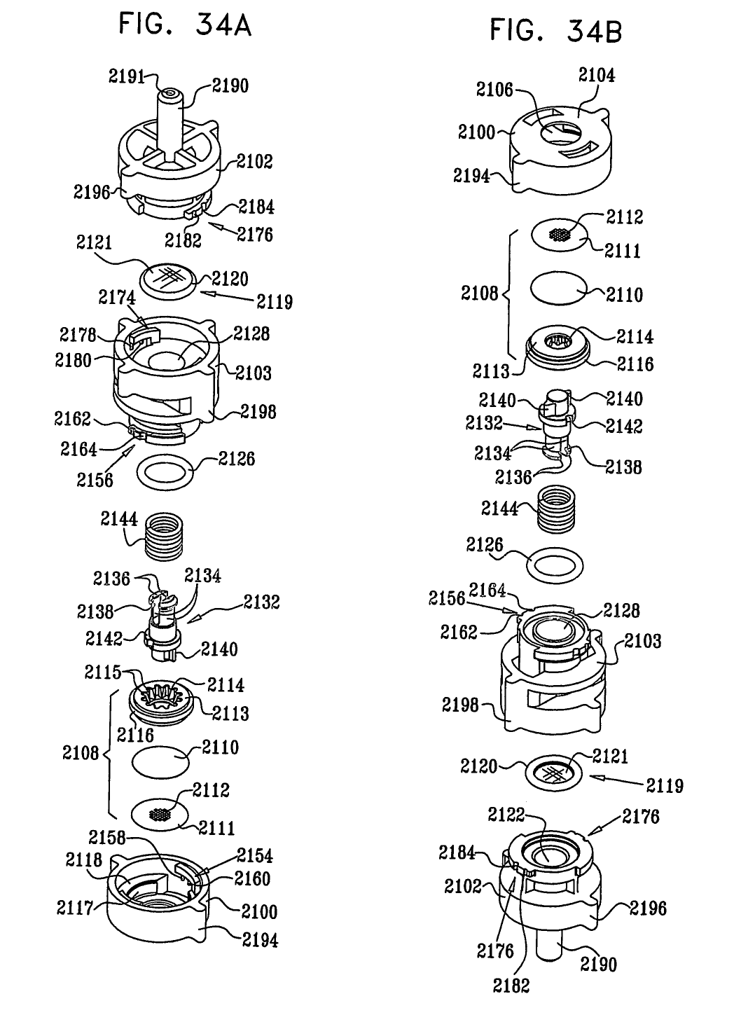

Reference is now made to FIGS. 34A-38B, which are oppositely facing simplified exploded view pictorial illustrations of a disassembled scanning electron microscope (SEM) compatible sample container constructed and operative in accordance with another preferred embodiment of the present invention. As seen in FIGS. 34A & 34B, the SEM compatible sample container comprises first and second enclosure elements, respectively designated by reference numerals 2100 and 2102 and a connecting element 2103 arranged for enhanced ease and speed of closure. Enclosure elements 2100 and 2102 and connecting element 2103 are preferably molded of plastic and coated with a conductive metal coating.

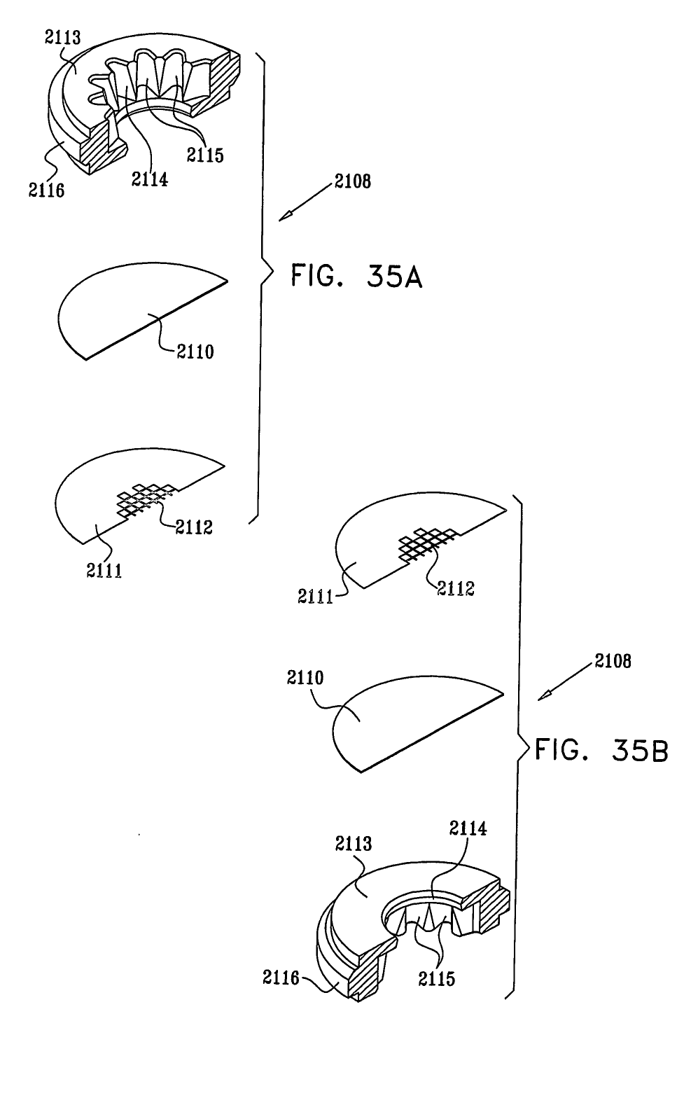

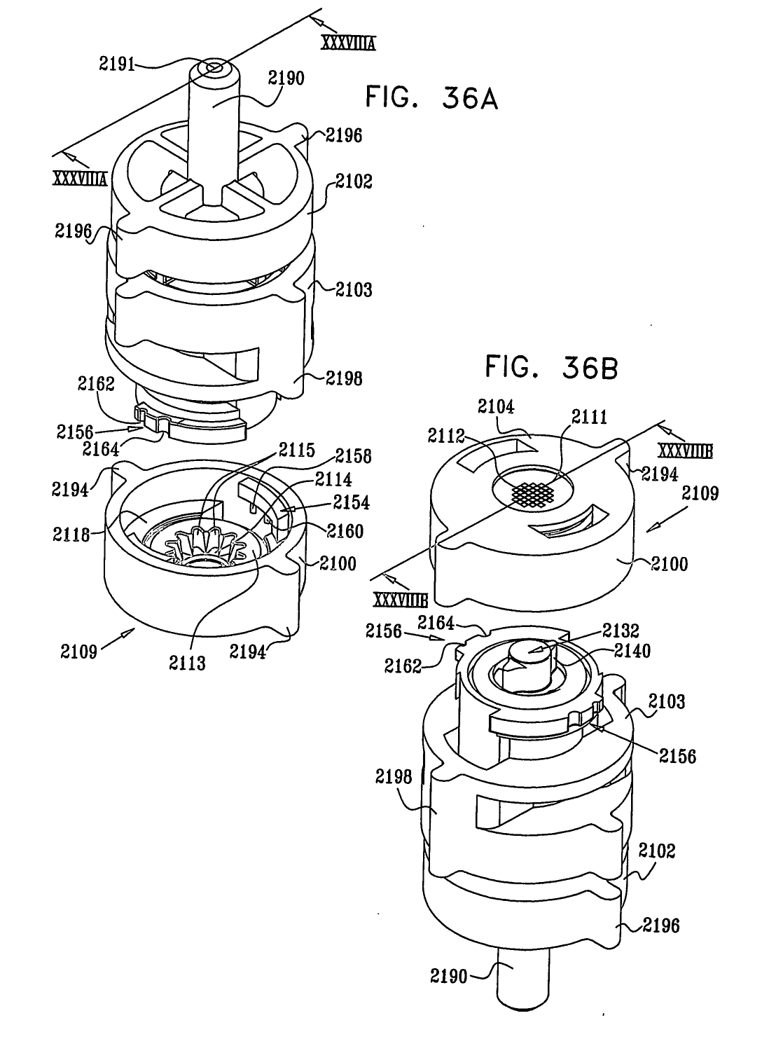

First enclosure element 2100 preferably defines a sample enclosure and has a base surface 2104 having a generally central aperture 2106. An electron beam permeable, fluid impermeable, membrane subassembly 2108, shown in detail in FIGS. 35A and 35B, is seated inside enclosure element 2100 against and over aperture 2106, as shown in FIGS. 36A & 36B and 38A & 38B. A sample dish comprising subassembly 2108 suitably positioned in enclosure element 2100 is designated by reference numeral 2109, as shown in FIGS. 36A-38B.

Turning additionally to FIGS. 35A and 35B, it is seen that an electron beam permeable, fluid impermeable, membrane 2110, preferably a polyimide membrane, such as Catalog No. LWN00033, commercially available from Moxtek Inc. of Orem, Utah, U.S.A., is adhered, as by an adhesive, to a grid support element 2111, which defines at its center a mechanically supporting grid 2112. Grid 2112, which is not shown to scale, is preferably configured to define an asymmetrical array of apertures to provide reference orientation indication finctionality so as to assist users in identifying the location of a sample region in respect to the SEM compatible sample container and is preferably formed by photochemical etching of stainless still sheets, commercially available from Suron Ltd. of Kibutz Maagan Michael, Israel. A sample enclosure defining ring 2113 is adhered to electron beam permeable, fluid impermeable, membrane 2110, preferably by an adhesive, such as Catalog No. 1193MVLV, commercially available from Dyamx corporation of 51 Greenwoods Road, Torrington, Conn. 06790, USA. Ring 2113 is preferably formed of PMMA (polymethyl methacrylate), such as Catalog No. 692106001000, commercially available from Irpen of Barcelona, Spain, and preferably defines a sample enclosure with a volume of approximately 20 microliters and a height of approximately 2 mm. Preferably ring 2113 is configured to define a sample enclosure 2114 having inclined walls configured to define a plurality of radially distributed grooves 2115. Ring 2113 is also preferably formed on an external surface thereof with a circumferential rim 2116 operative to engage recesses 2117 formed in protruded portions 2118 of first enclosure element 2100 so as to securely seat ring 2113 in first enclosure element 2100.

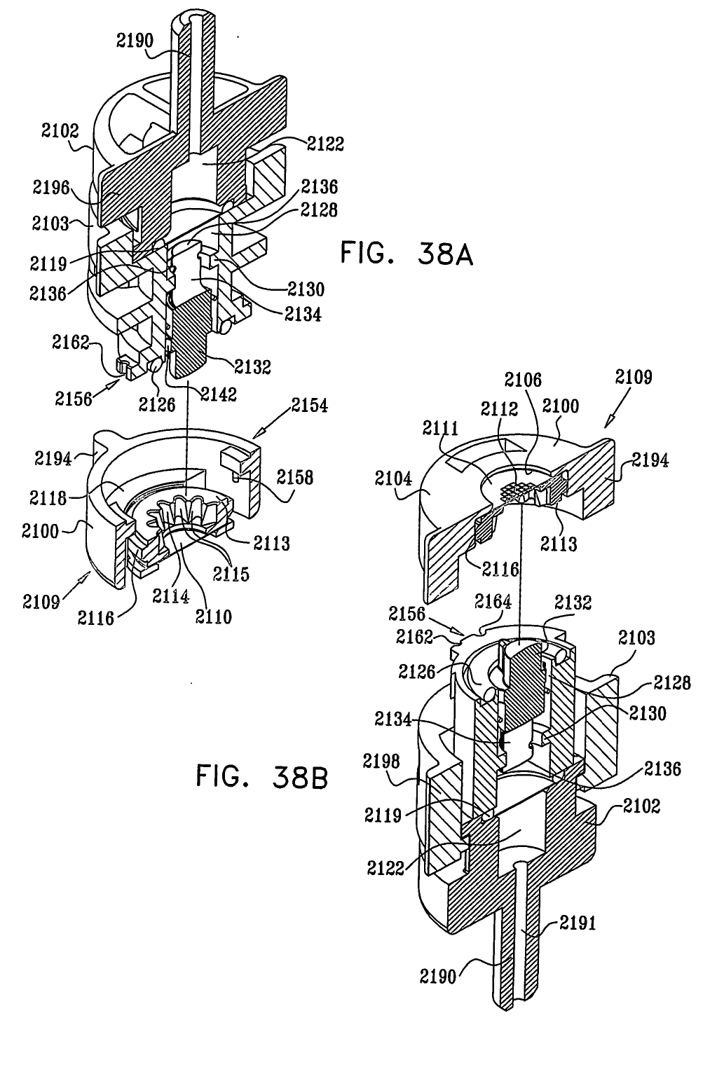

As seen in FIGS. 34A, 34B, 38A and 38B, a diaphragm 2119 is preferably integrally formed of an O-ring portion 2120 to which is sealed an expandable sheet portion 2121. Diaphragm 2119 is preferably disposed between an interior surface 2122 of second enclosure element 2102 and connecting element 2103. An O-ring 2126 is preferably disposed between connecting element 2103 and ring 2113 of subassembly 2108. Diaphragm 2119 and O-ring 2126 are operative, when enclosure elements 2100 and 2102 and connecting element 2103 are in tight engagement, to obviate the need for the engagement of elements 2100 and 2102 and connecting element 2103 to be a sealed engagement.

Connecting element 2103 preferably has a recess 2128. Connecting element 2103 is also formed with a circumferential protrusion 2130, seen in FIGS. 38A & 38B, protruding into recess 2128.

A positioner 2132 is preferably comprised of two upright flexible projections 2134, each with a ridge 2136 formed on an end portion 2138 of the projections 2134. Positioner 2132 is preferably molded of plastic. Projections 2134 press against each other when inserted into recess 2128 of connecting element 2103 and then snap back to an upright position once ridges 2136 are seated on the protrusion 2130 of connecting element 2103, as shown in FIGS. 38A & 38B.

Positioner 2132 is preferably also provided with respective radially extending positioning and retaining protrusions 2140 extending from a circumferential rim 2142. Positioning and retaining protrusions 2140 are seated in grooves 2115 of ring 2113 so as to prevent rotation of positioner 2132 within ring 2113.

A coil spring 2144 is disposed on positioner 2132 between rim 2142 and ridges 2136 of projections 2134. Spring 2144 is preferably formed of hardened stainless steel.

The positioner 2132 and spring 2144 are operative to move a non-liquid sample up and against electron beam permeable, fluid impermeable, membrane 2110 when enclosure elements 2100 and 2102 and connecting element 2103 are in tight engagement.

First enclosure element 2100 engages connecting element 2103 by connecting a protruded portion 2154 formed in first enclosure element 2100 to a bayonet-type socket 2156 formed in connecting element 2103.

Protruded portion 2154 preferably comprises a first protrusion 2158 and a second protrusion 2160, which communicate with a first recess 2162 and a second recess 2164 formed in bayonet-type socket 2156. Initial engagement of protrusion 2158 with recess 2162 provides for a loose engagement of first enclosure element 2100 and connecting element 2103 so as to prevent inadvertent damage of the SEM compatible sample container, such as during shipping and handling. Subsequent engagement of protrusion 2158 with recess 2164 provides for a tight engagement of first enclosure element 2100 and connecting element 2103.

Second enclosure element 2102 engages connecting element 2103 by connecting a protruded portion 2174 formed in connecting element 2103 to a bayonet-type socket 2176 formed in second enclosure element 2102.

Protruded portion 2174 preferably comprises a first protrusion 2178 and a second protrusion 2180, which communicate with a first recess 2182 and a second recess 2184 formed in bayonet-type socket 2176. Initial engagement of protrusion 2178 with recess 2182 provides for a loose engagement of second enclosure element 2102 and connecting element 2103 so as to prevent inadvertent damage of the SEM compatible sample container, such as during shipping and handling. Subsequent engagement of protrusion 2178 with recess 2184 provides for a tight engagement of second enclosure element 2102 and connecting element 2103.

Second enclosure element 2102 is preferably formed with a generally central stub 2190, having a throughgoing bore 2191, which is arranged to be seated in a suitable recess (not shown) in a specimen stage of a scanning electron microscope. It is a particular feature of the present invention that the container, shown in FIGS. 34A-43, is sized and operative with conventional stub recesses in conventional SEMs and does not require any modification thereof whatsoever. It is appreciated that various configurations and sizes of stubs may be provided so as to fit various SEMs.

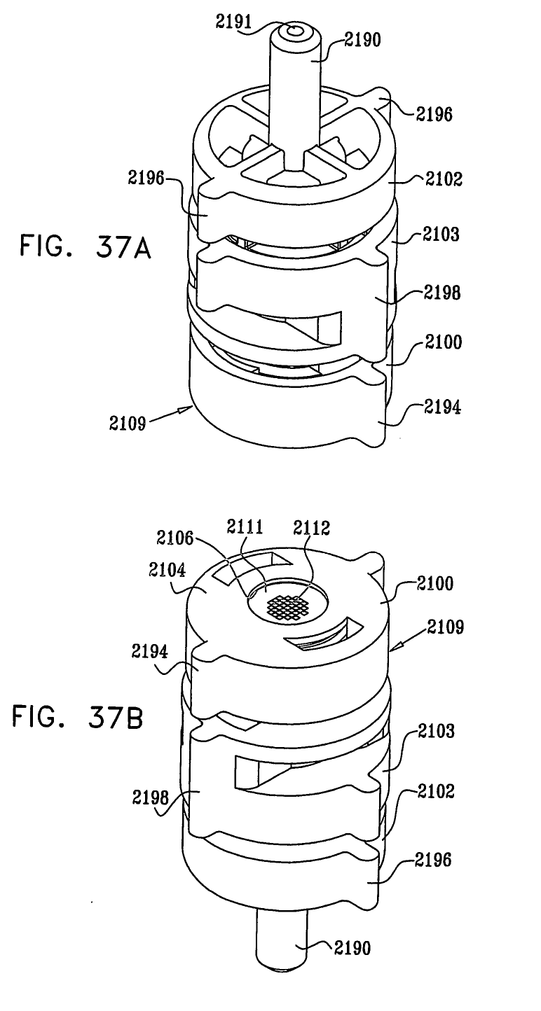

Enclosure elements 2100 and 2102 and connecting element 2103 are preferably also provided with respective radially extending positioning and retaining protrusions 2194, 2196 and 2198, to enable the container to be readily seated in a suitable multi-container holder and also to assist users in opening and closing the enclosure elements 2100 and 2102 and connecting element 2103. Preferably, the mutual azimuthal positioning of the protrusions 2194, 2196 and 2198 on respective enclosure elements 2100 and 2102 and connecting element 2103 is such that mutual azimuthal alignment therebetween indicates a tight engagement therebetween, as shown in FIGS. 37A and 37B.

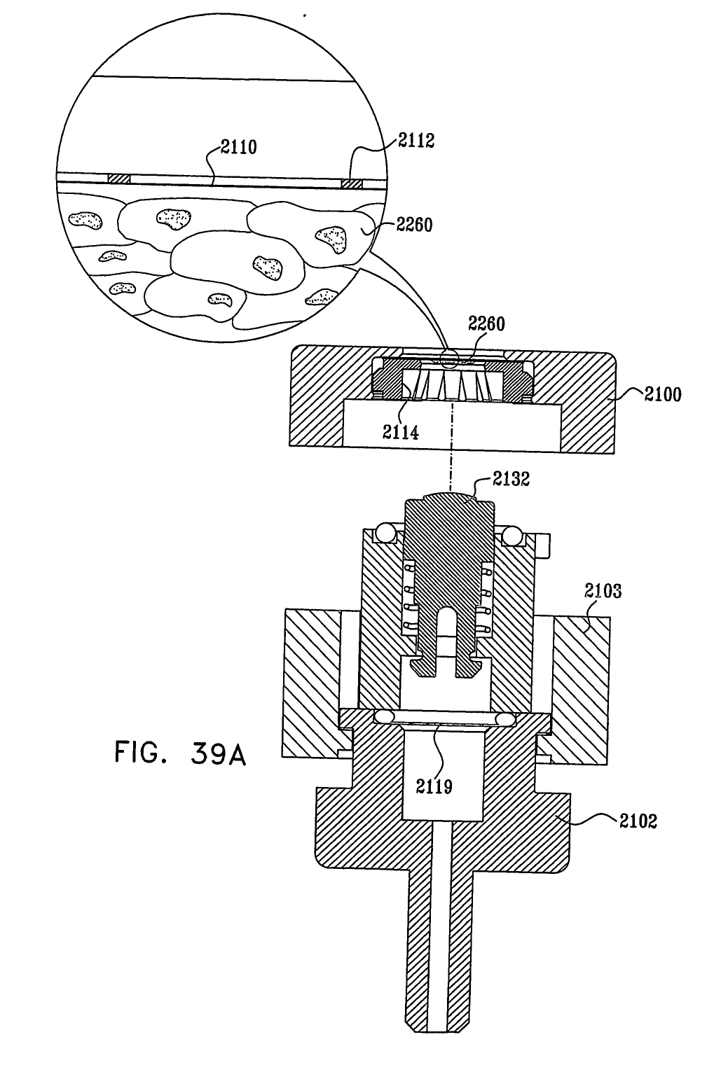

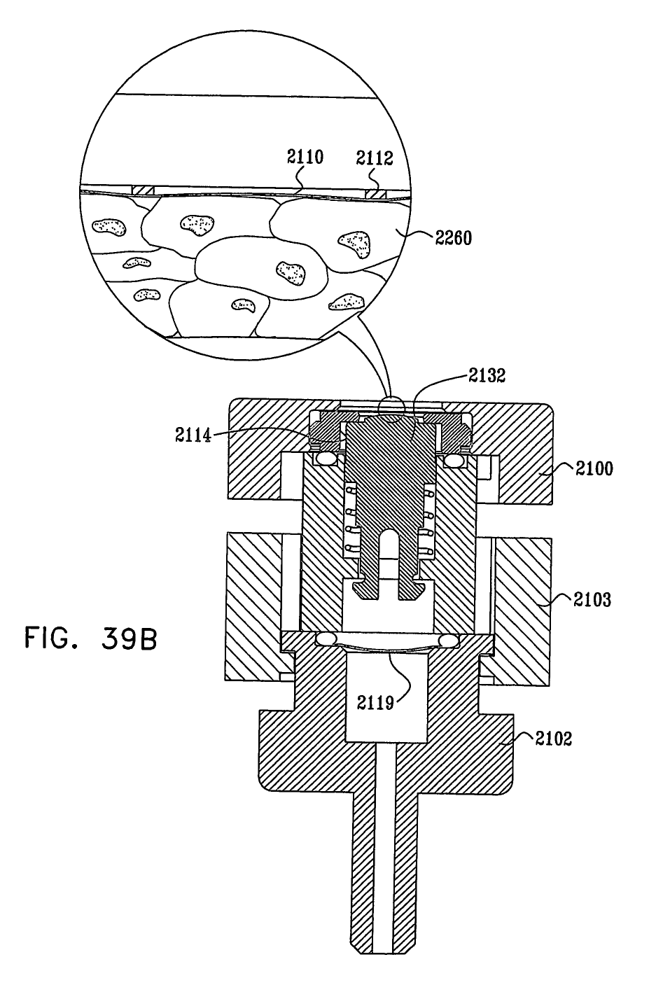

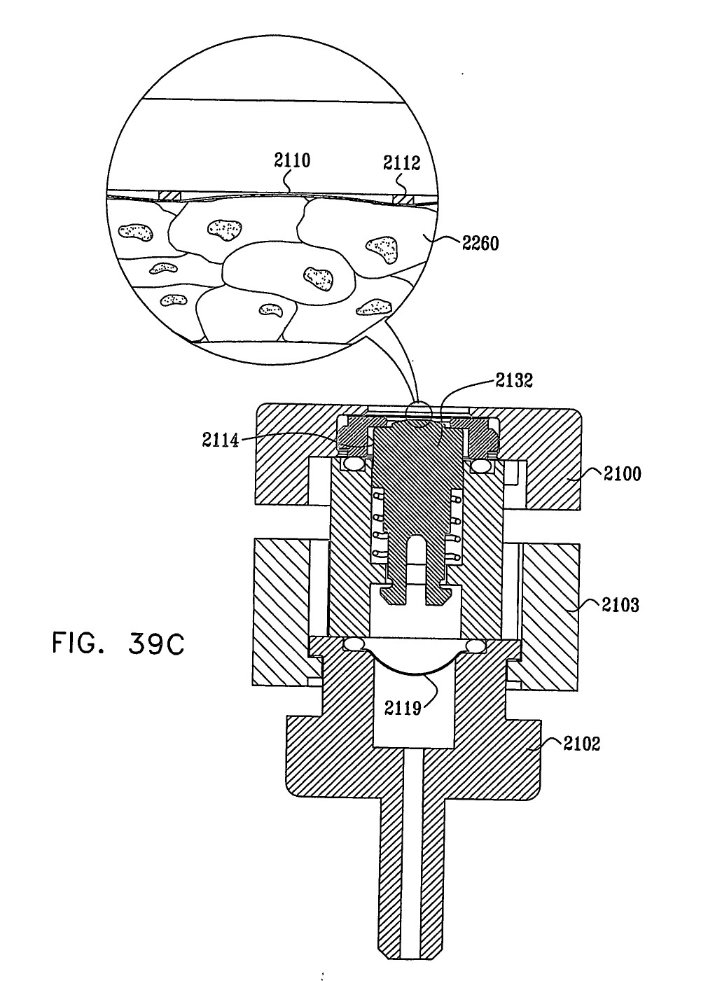

Reference is now made to FIGS. 39A, 39B & 39C, which are three sectional illustrations showing the operative orientation of the SEM compatible sample container of FIGS. 34A-38B at three stages of operation. FIG. 39A shows the container of FIGS. 34A-38B containing a tissue sample 2260 and arranged in the orientation shown in FIG. 34B, prior to closure of enclosure elements 2100 and 2102 and connecting element 2103. The electron beam permeable, fluid impermeable, membrane 2110 is seen in FIG. 39A to be generally planar.

FIG. 39B shows the container of FIG. 39A immediately following full engagement between enclosure elements 2100 and 2102 and connecting element 2103 producing sealing of the tissue sample enclosure 2114 from the ambient. It is noted that the tissue sample 2260 is in close contact with the electron beam permeable, fluid impermeable, membrane 2110 due to the force exerted by the positioner 2132. It is seen that the diaphragm 2119 bows outwardly due to pressure buildup in the liquid sample enclosure 2114 as the result of sealing thereof in this manner. In this embodiment the electron beam permeable, fluid impermeable, membrane 2110 bows outwardly due to pressure buildup in the tissue sample enclosure 2114 as the result of sealing thereof in this manner, however to a significantly lesser extent, due to the action of diaphragm 2119. This can be seen by comparing FIG. 39B with FIG. 29B. Supporting grid 2112 is seen to be generally planar.

FIG. 39C illustrates the container of FIG. 39B, when placed in an evacuated environment of a SEM, typically at a vacuum of 10⁻²-10⁻⁶ millibars. It is seen that in this environment, the diaphragm 2119 bows outwardly to a greater extent than in the ambient environment of FIG. 39B and the electron beam permeable, fluid impermeable, membrane 2110 and support grid 2112 also bow outwardly to a greater extent than in the ambient environment of FIG. 39B, but to a significantly lesser extent than in the embodiment of FIG. 29C, due to the action of diaphragm 2119. This can be seen by comparing FIG. 39C with FIG. 29C.

It is also noted that the electron beam permeable, fluid impermeable, membrane 2110 tends to be forced into and through the interstices of grid 2112 to a greater extent than occurs in the ambient environment of FIG. 39B but to a significantly lesser extent than in the embodiment of FIG. 39C, due to the action of diaphragm 2119. This can also be seen by comparing FIG. 39C with FIG. 29C.

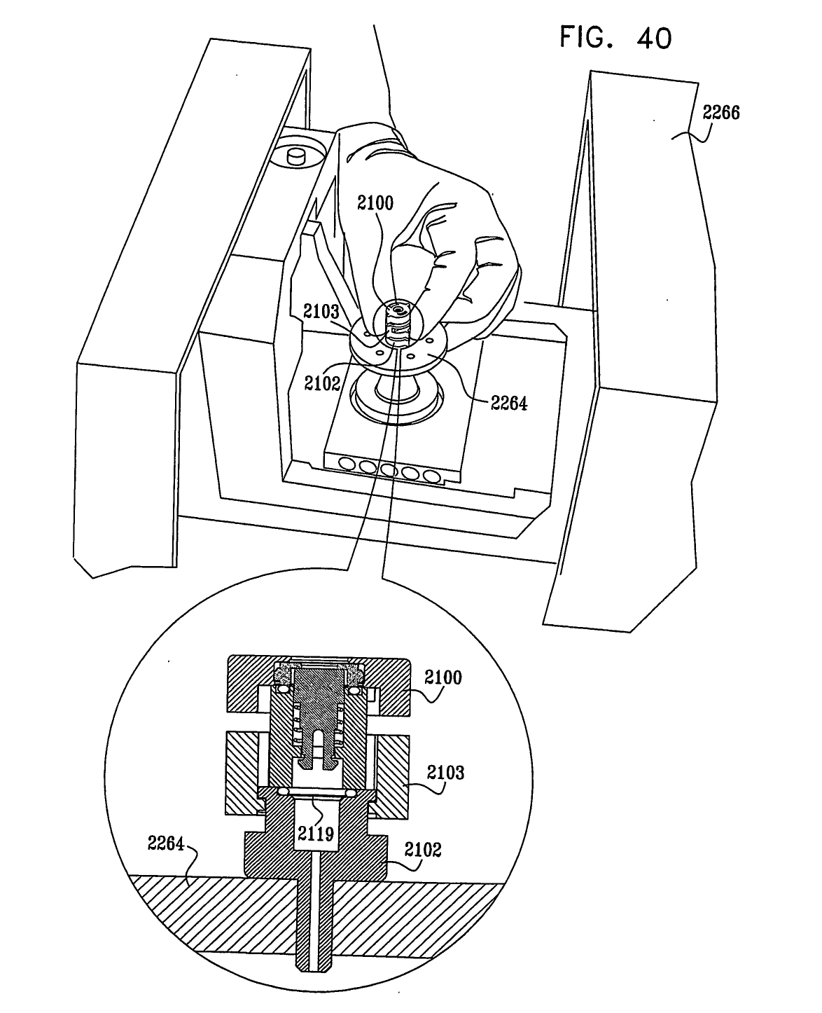

Reference is now made to FIG. 40, which is a simplified sectional and pictorial illustration of tissue containing sample and insertion into a SEM using the SEM compatible sample container of FIGS. 34A-39C. FIG. 40 shows the closed container, in the orientation of FIG. 34B, being inserted onto a stage 2264 of a SEM 2266. It is appreciated that there exist SEMs wherein the orientation of the container is opposite to that shown in FIG. 40.

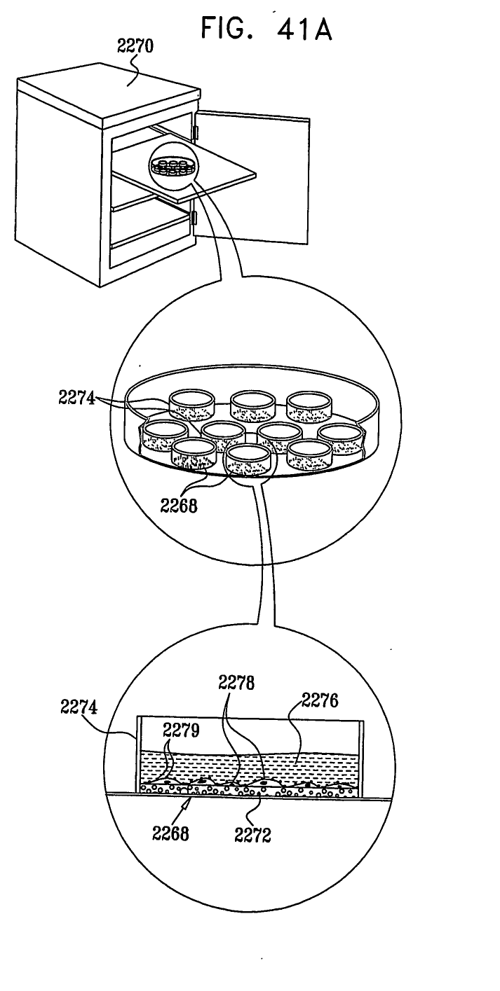

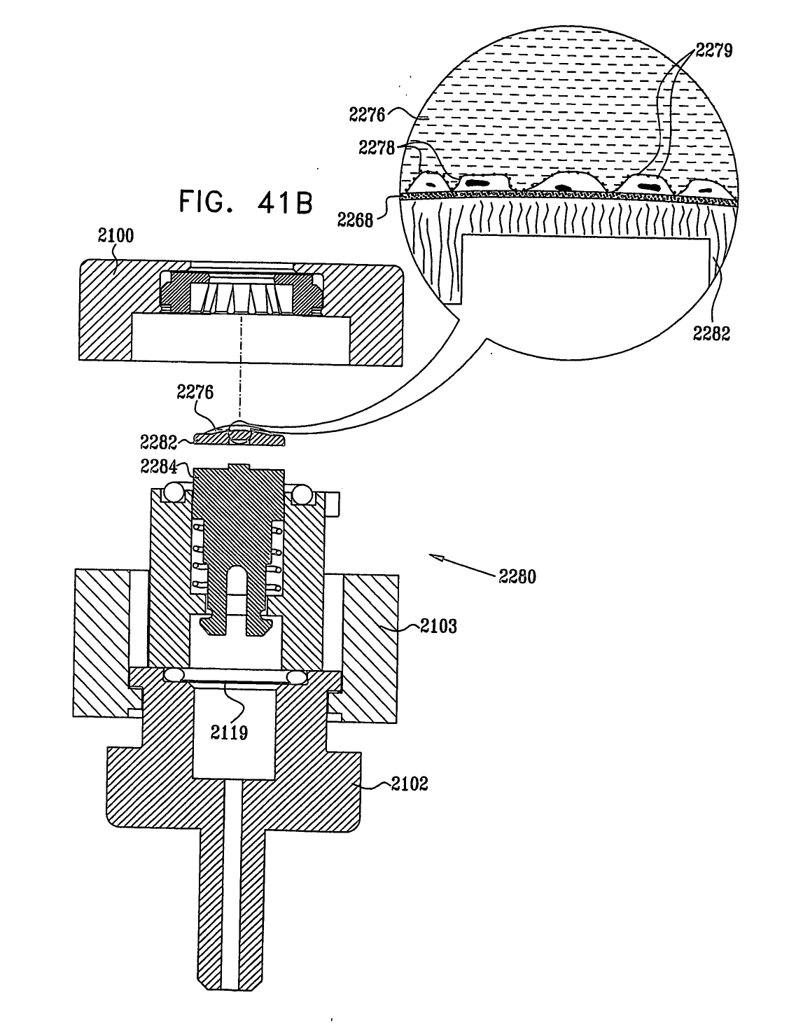

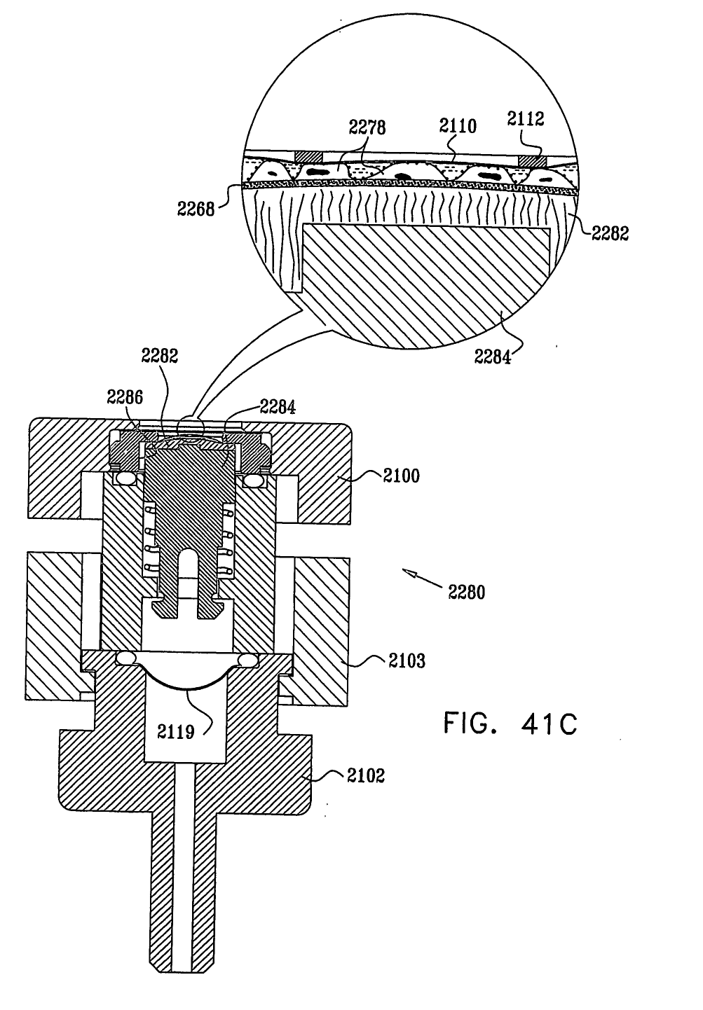

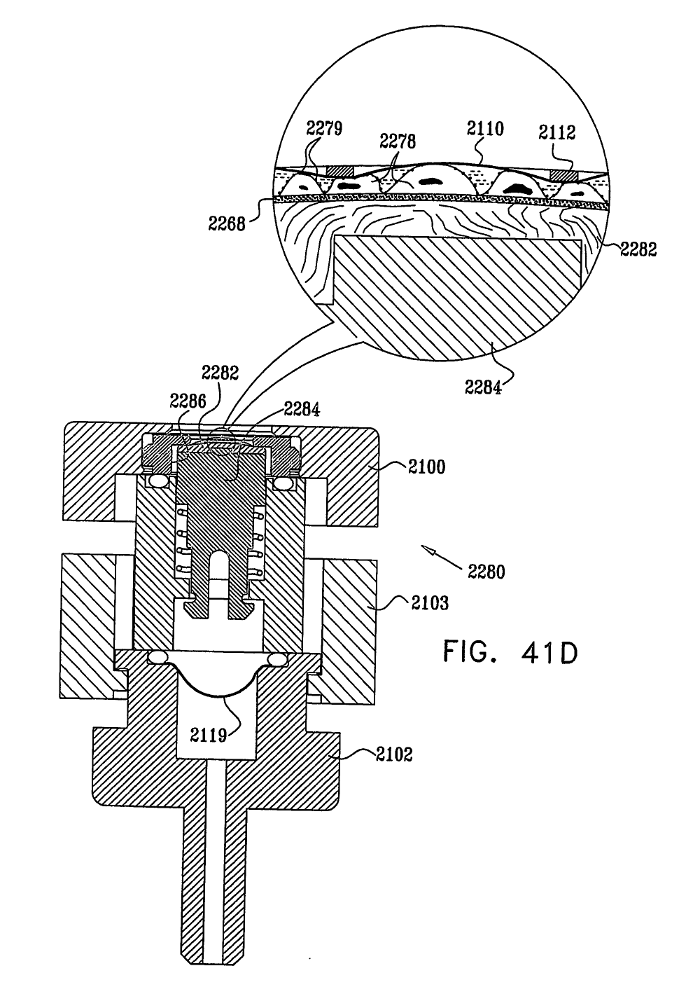

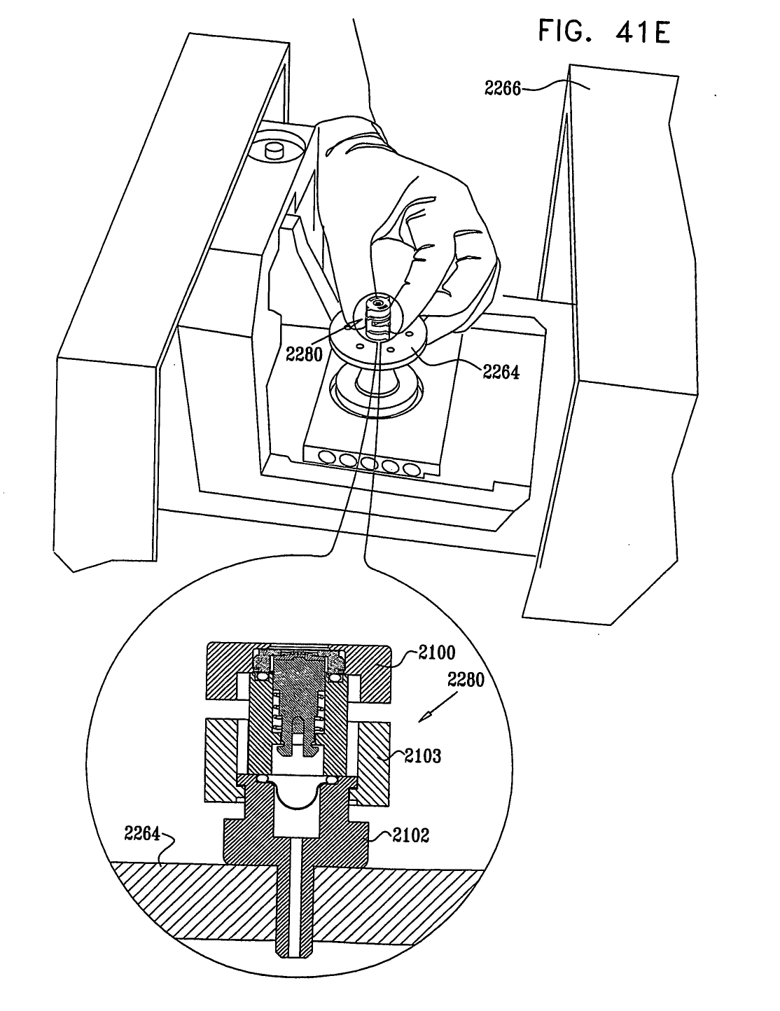

Reference is now made to FIGS. 41A, 41B, 41C, 41D and 41E, which are sectional illustrations showing the operative orientation of a variation of the SEM compatible sample container of FIGS. 34A-39B at various stages of operation and insertion into a SEM using the SEM compatible sample container.

FIG. 41A shows a plurality of flexible support elements, which are operative to support particles or cells, such as cell stages 2268 typically placed in an incubator 2270. Cell stages 2268 are operative to allow growth of cells thereon or, alternatively, allow adherence of grown cells thereon. Each cell stage 2268 is preferably defmed by a porous membrane 2272, which is surrounded by a ring 2274 and supports a sample 2276 including cells 2278. Porous membrane 2272 is preferably formed of polyester, such as a Transwell plate, Catalog number 3470, commercially available from Corning, Acton, Mass., USA. Cells 2278 are preferably supported by the porous membrane 2272 on a basal side of cells 2278 in a liquid medium. The porous membrane 2272 is operative to maintain a desired level of humidity in the sample during the stages of operation, such as during incubation in incubator 2270, as shown in FIG. 41A.

It is appreciated that cells 2278 or particles may be deposited on the flexible support elements by adsorption or by filtering a fluid containing the cells or the particles trough the porous membrane 2272.

As seen in FIG. 41A, molecules 2279, such as molecules of cells 2278 or extraneously added molecules are preferably provided on an apical side of the cells 2278. Preferably, molecules 2279 are linked to electron-dense structures such as gold colloids, which can be visualized in an electron microscope.

FIG. 41B shows a SEM compatible sample container 2280, identical to the container of FIGS. 34A-38B other than as specified hereinbelow, containing the cell stage 2268, which supports the sample 2276 and is mounted on a platform 2282, preferably formed of a non-rigid material. The container 2280 is arranged in the orientation shown in FIG. 34B, prior to closure of enclosure elements 2100 and 2102 and connecting element 2103. Cell platform 2282 is mounted onto a suitably configured positioner 2284, which corresponds to positioner 2132 in the embodiment of FIGS. 34A-40. Typically, the cells 2278 are grown onto cell stage 2268 in incubator 2270 while cell stage 2268 is not mounted onto platform 2282. The mounting of the cell stage 2268 onto platform 2282 and, in turn, the mounting of the platform 2282 with the cell stage 2268 onto positioner 2284 typically occurs just before SEM inspection takes place.

FIG. 41C shows the container 2280 of FIG. 41B immediately following full engagement between enclosure elements 2100 and 2102 and connecting element 2103 producing sealing of the cell sample enclosure, here designated by reference numeral 2286, from the ambient. It is noted that the sample containing cells 2278 is in close contact with the electron beam permeable, fluid impermeable, membrane 2110 due to the force exerted by the positioner 2284. It is seen that the electron beam permeable, fluid impermeable, membrane 2110 and the cell stage 2268 bow outwardly due to pressure buildup in the cell sample enclosure 2286 as the result of sealing thereof in this manner, however to a significantly lesser extent than in the embodiment of FIG. 31C, due to the action of diaphragm 2119. This can be seen by comparing FIG. 41C with FIG. 31C.The supporting grid 2112 is seen to be generally planar.

FIG. 41D illustrates the container of FIG. 41C, when placed in an evacuated environment of a SEM, typically at a vacuum of 10⁻²-10⁻⁶ millibars. It is seen that in this environment, the electron beam permeable, fluid impermeable, membrane 2110 and the cell stage 2268 bow outwardly to a greater extent than in the ambient environment of FIG. 41C and further that the electron beam permeable, fluid impermeable, membrane 2110 tends to be forced into and through the interstices of grid 2112 to a greater extent than occurs in the ambient environment of FIG. 41C, but to a significantly lesser extent than in the embodiment of FIG. 31D, due to the action of diaphragm 2119. This can be seen by comparing FIG. 41D with FIG. 31D. The grid 2112 is also seen to slightly bow outwardly in this environment.

FIG. 41E shows the closed container 2280, in the orientation of FIG. 34B, being inserted onto stage 2264 of SEM 2266. It is appreciated that there exist SEMs wherein the orientation of the container is opposite to that shown in FIG. 41E.

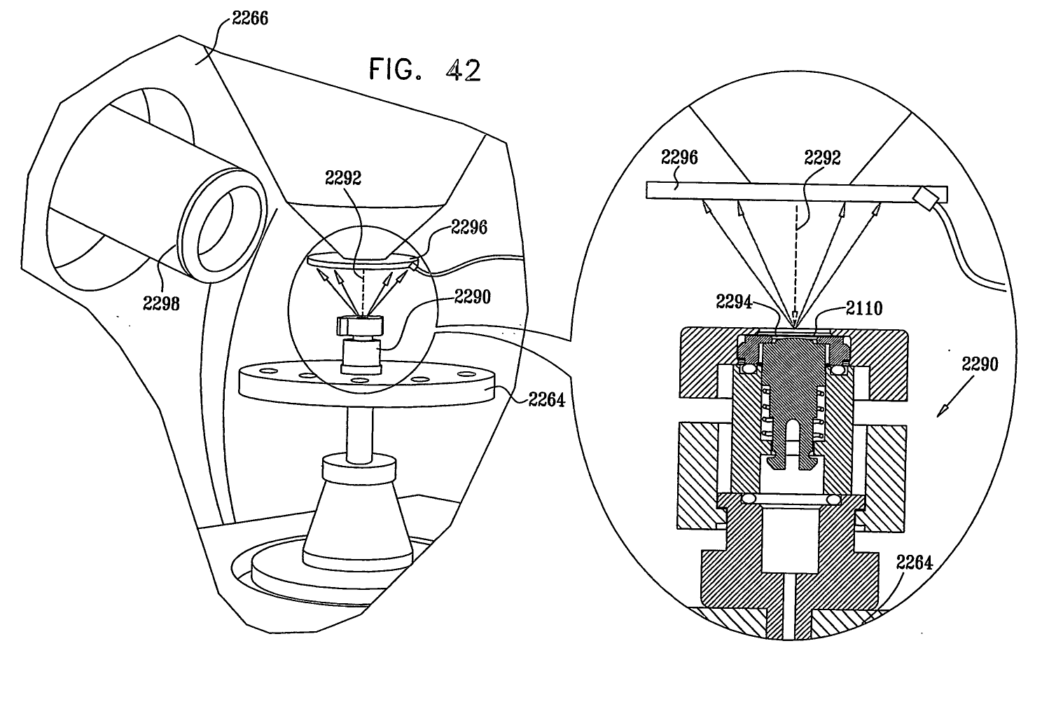

Reference is now made to FIG. 42, which is a simplified pictorial and sectional illustration of SEM inspection of a sample using the SEM compatible sample container of FIGS. 34A-40. As seen in FIG. 42, the container, here designated by reference numeral 2290, is shown positioned on stage 2264 of SEM 2266 such that an electron beam 2292, generated by the SEM, passes through electron beam permeable, fluid impermeable, membrane 2110 (FIGS. 34A-41E) and impinges on a tissue containing sample 2294 within container 2290. Backscattered electrons from sample 2294 pass through electron beam permeable, fluid impermeable, membrane 2110 and are detected by a detector 2296, forming part of the SEM. One or more additional detectors, such as a secondary electron detector 2298, may also be provided. An X-ray detector (not shown) may also be provided for detecting X-ray radiation emitted by the sample 2294 due to electron beam excitation thereof and a cathodoluminescent detector (not shown) may also be provided for detecting radiation emitted by the sample 2294 due to electron beam excitation thereof.

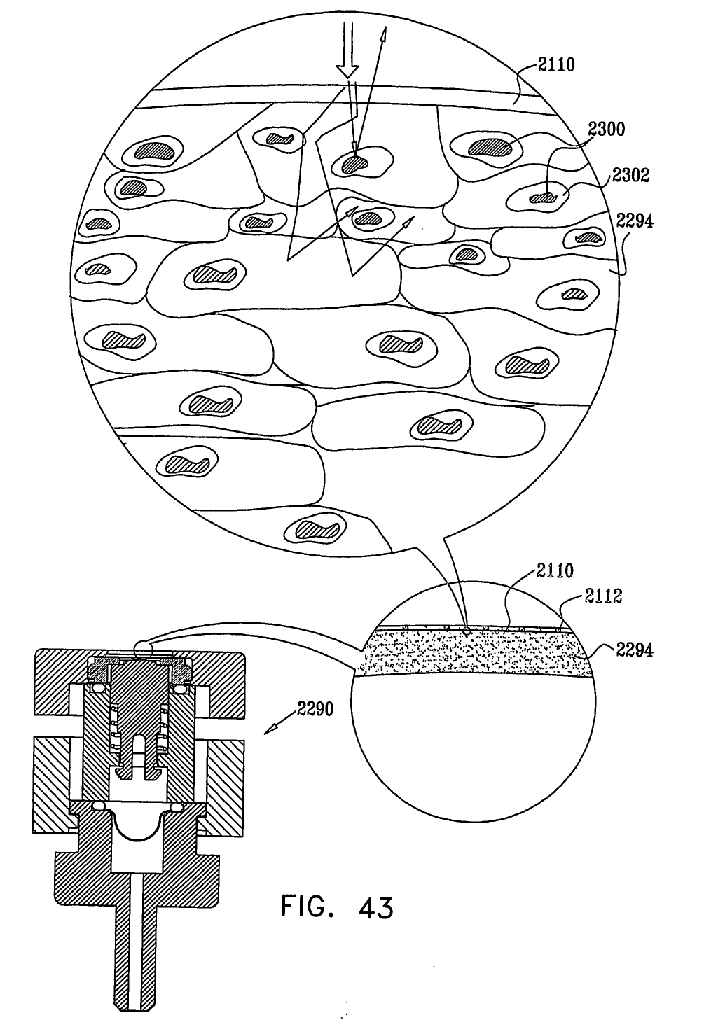

Reference is now made additionally to FIG. 43, which schematically illustrates some details of the electron beam interaction with the sample 2294 in container 2290 in accordance with a preferred embodiment of the present invention. It is noted that the present invention enables high contrast imaging of features which are distinguished from each other by their average atomic number, as illustrated in FIG. 43. In FIG. 43 it is seen that nucleoli 2300, having a relatively high average atomic number, backscatter electrons more than the surrounding nucleoplasm 2302.

It is also noted that in accordance with a preferred embodiment of the present invention, imaging of the interior of the sample to a depth of up to approximately 2 microns is achievable for electrons having an energy level of less than 50 KeV, as seen in FIG. 43, wherein nucleoli 2300 disposed below electron beam permeable, fluid impermeable, membrane 2110 are imaged.

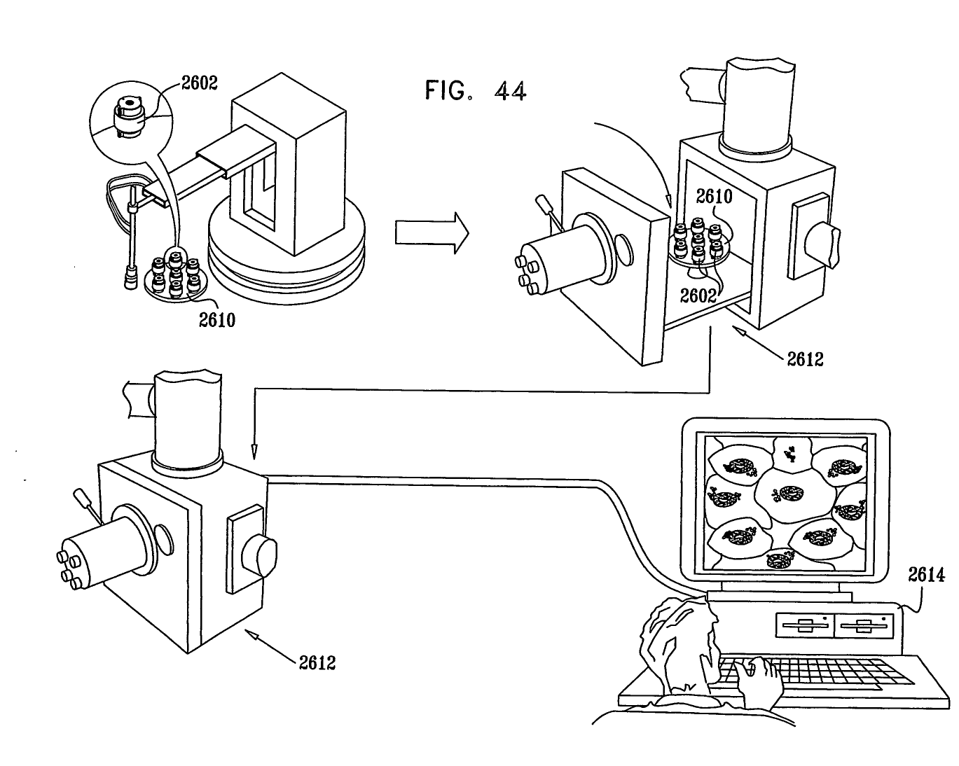

Reference is now made to FIG. 44, which is a simplified illustration of a SEM based sample inspection system constructed and operative in accordance with a preferred embodiment of the present invention. As seen in FIG. 44, preferably, automated positioning systems, such as robotic arms, as shown, are used for conveying a multiplicity of SEM compatible sample containers 2602 throughout the system, it being appreciated that manual intervention may be employed at one or more stages as appropriate.

Thereafter, individual containers 2602 are placed on a removable electron microscope specimen stage 2610, which is subsequently introduced into a scanning electron microscope 2612. The resulting image may be inspected visually by an operator and/or analyzed by conventional image analysis functionality, typically embodied in a computer 2614.

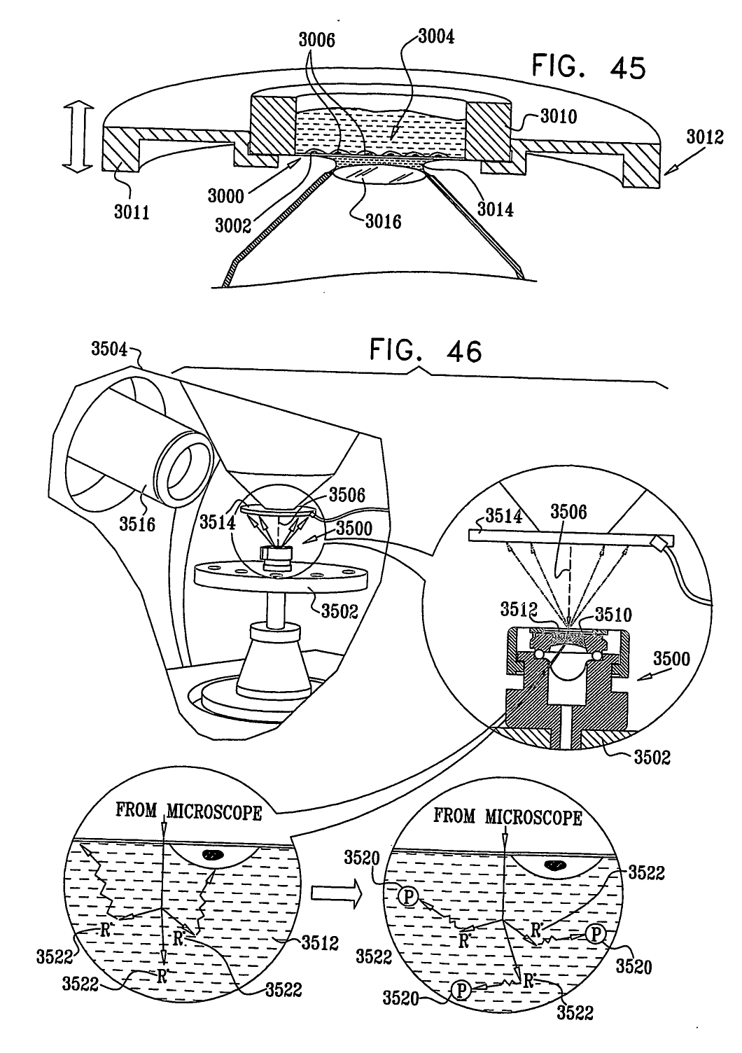

Reference is now made to FIG. 45, which is a simplified pictorial and sectional illustration of inspection of a sample in an Inverted Light Microscope using a sample holder 3000. The sample holder 3000 is preferably defined by a light transmissive membrane 3002 and supports a sample 3004 in a liquid medium. The membrane 3002 is operative to allow light to pass therethrough and impinge on sample 3004. It is appreciated that the sample may include fluid or particulate components, such as cells 3006.

As seen in FIG. 45, the sample holder 3000 is shown supported by a supporting ring 3010, which is placed in a specimen stage 3011 of an Inverted Light Microscope 3012. An immersion fluid 3014, such as oil or a gel, with an index of refraction similar to the index of refraction of an objective lens 3016 of the Inverted Light Microscope 3012 may be placed between membrane 3002 and the objective lens 3016 to provide optimal optical properties.

It is appreciated that the sample holder 3000 with the membrane 3002, which is preferably less than 10 microns thick, can provide improved imaging by a variety of methods, including brightfield and darkfield light microscopy, confocal microscopy, and total internal reflection fluorescence microscopy, because of the shorter distance from the lens to the sample and the weaker optical activity of the membrane 3002, as compared to conventional glass slides.

Reference is now made to FIG. 46, which illustrates methodology for electron microscopy, which reduces or prevents damage to samples or sample containers due to electron beam impingement. It is known that samples, particularly organic or macromolecular samples suffer damage due to electron beam impingement thereon. Applicants have appreciated the electron beam damage to the membranes of the sample holders, described hereinabove with reference to FIGS. 1A-45, may occur due to electron beam impingement thereon and alternatively or additionally to electron beam impingement on a sample, which produces reactive species which may attack the membrane.

It is a particular feature of the present invention that methodology is provided for preventing or reducing electron beam induced damage including providing a sample of an organic or macromolecular material which is susceptible to electron beam impingement induced damage, adding to the sample a protective material which at least partially prevents the electron beam impingement induced damage and irradiating the sample and the protective material with an electron beam in an electron microscope.

It is also a particular feature of the present invention that methodology is provided for preventing or reducing electron beam induced damage including placing a sample in a sample enclosure comprising an electron beam permeable, fluid impermeable membrane, which is susceptible to electron beam induced damage and also comprising a peripheral enclosure sealed to the membrane and defining with the membrane the sample enclosure, adding to the sample a protective material which at least partially prevents the electron beam induced damage to the membrane and irradiating the sample and the protective material with an electron beam in an electron microscope.

It is appreciated that the membrane may be susceptible to electron beam induced damage resulting from electron beam impingement thereon or electron beam impingement on the sample.

Turning to FIG. 46, there is seen a simplified pictorial and sectional illustration of SEM inspection of a sample using the SEM compatible sample container of FIGS. 11A-15B. It is appreciated that the protective methodology described herein with reference to FIG. 46 is not limited to SEM microscopy but is equally applicable to other types of electron microscopy such as TEM microscopy.

As seen in FIG. 46, a container, here designated by reference numeral 3500, is shown positioned on a stage 3502 of a SEM 3504 such that an electron beam 3506, generated by the SEM, passes through an electron beam permeable, fluid impermeable, membrane 3510, which may be identical to the electron beam permeable, fluid impermeable, membrane shown in FIGS. 1A-44, and impinges on a liquid containing sample 3512 within container 3500. Sample 3512 typically contains an organic material or a macromolecular material. Backscattered electrons from sample 3512 pass through electron beam permeable, fluid impermeable, membrane 3510 and are detected by a detector 3514, forming part of the SEM 3504. One or more additional detectors, such as a secondary electron detector 3516 may also be provided. An X-ray detector (not shown) may also be provided for detecting X-ray radiation emitted by the sample 3512 due to electron beam excitation thereof and a cathodoluminescent detector (not shown) may also be provided for detecting radiation emitted by the sample 3512 due to electron beam excitation thereof.

As shown symbolically in FIG. 46, impingement of the electron beam on the sample 3512 and/or on the membrane 3510 may produce reactive species, such as ions or free radicals. These reactive species may cause damage to the sample 3512 and/or to the membrane 3510.

In accordance with a preferred embodiment of the present invention, a protective material is added to the sample 3512 in order to at least partially inactivate the reactive species so as to prevent damage to the sample 3512 and/or the membrane 3510. Examples of suitable protective materials include:

4-(2-hydroxyethyl)-1-piperazineethanesulfonic acid (HEPES-KOH), 25 mM, pH 7.5); Tris hydroxymethyl aminomethane (Tris-HCl), 10 mM, pH 7.5; D-glucose, 25 mM; D-sorbitol, 25 mM; L-ascorbic acid, 50 mM; L-camosine, 50 mM; nicotinamide adenine dinucleotide (NADH), 25 mM; and fetal bovine serum, 10% (v/v).

As shown symbolically in FIG. 46, molecules of the protective material, here designated by reference numeral 3520, tend to react with the reactive species, here designated by reference numeral 3522, thus inactivating them and reducing or preventing damage to the sample 3512 and/or the membrane 3510 which would otherwise result from impingement of the electron beam 3506 on the sample 3512 or the membrane 3510.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1-130. (canceled)

131. A sample container comprising:
a sample enclosure comprising:
an election beam permeable, fluid impermeable, membrane; and
a peripheral enclosure sealed to said membrane and defining with said membrane said sample enclosure; and
a sample enclosure closure comprising a quick-connect attachment for sealing engagement with said sample enclosure.

132. The sample container according to claim 131, wherein said quick-connect attachment comprises a bayonet connection.

133. The sample container according to claim 131, wherein said sample container is at least partially electrically conductive.

134. The sample container according to claim 131, comprising a reference orientation indicator.

135. The sample container according to claim 131, comprising a membrane support grid for supporting said membrane and for providing a reference orientation indication.

136. The sample container according to claim 131, comprising a flexible support element.

137. A sample inspection system comprising:
the sample container according to claim 131; and
a microscope

138. The sample inspection system according to claim 137, comprising at least one of:
an X-ray detector arranged to receive X-rays from a sample;
a light detector arranged to receive light in the ultraviolet to infrared range from a sample;
a backscattered election detector arranged to receive backscattered electrons from a sample; and
a secondary electron detector arranged to receive secondary electrons fiom a sample.

139. A multi-sample holder comprising:
a sample container comprising:
an electron beam permeable, fluid impermeable, membrane; and
an enclosure sealed to said membrane and defining with said membrane said sample container; and
a support for supporting a plurality of said sample containers.

140. The multi-sample holder according to claim 139, wherein said support comprises a light transparent portion underlying said membrane.

141. The multi-sample holder according to claim 139, wherein said support comprises a liquid reservoir

142. The multi-sample holder according to claim 139, comprising a suction device and pipettes, said suction device is configured such that upon operative engagement thereof with said support, physical engagement thereof with said membrane is prevented

143. The multi-sample holder according to claim 142, wherein at least one of said pipettes is provided with a collar element to prevent inadvertent engagement of said pipettes with said membrane.

144. A method of microscopy comprising:
placing a sample in a sample enclosure comprising:
an electron beam permeable, fluid impermeable, membrane;
a peripheral enclosure sealed to said membrane and defining with said membrane said sample enclosure; and
an outer enclosure arranged about said sample enclosure and defining an aperture for electron communication through said membrane with an interior of said sample enclosure;
sealing said sample enclosure with said outer enclosure;
placing said sample enclosure in a beam of electrons; and
analyzing results of interactions of said beam of electrons with said sample.

145. The method of microscopy according to claim 144, wherein said sealing said sample enclosure with said outer enclosure is performed with a bayonet connection.

146. The method of microscopy according to claim 144, wherein said placing said sample in said sample enclosure comprises positioning said sample in reference to a reference orientation indicator of said sample enclosure.

147. The method of microscopy according to claim 144, comprising:
disposing said sample intermediate a flexible support element and said membrane, thereby impinging said sample on a first surface of said sample,
wherein said first surface of said sample being opposite a second surface of said sample, which said second surface of said sample is adjacent to said flexible support element.

148. A method of microscopy comprising:
providing a sample which is susceptible to election beam impingement induced damage;
adding to said sample a protective material which at least partially prevents said electron beam impingement induced damage; and
irradiating said sample and said protective material with an electron beam in an electron microscope.

149. The method of microscopy according to claim 148, wherein said providing comprises:
placing said sample in a sample enclosure comprising:
an electron beam permeable, fluid impermeable membrane; and
a peripheral enclosure sealed to said membrane and defining with said membrane said sample enclosure.

150. The method of microscopy according to claim 149, wherein said membrane is susceptible to said electron beam induced damage resulting from electron beam impingement thereon.

151. The method of microscopy according to claim 149, wherein said membrane is susceptible to said electron beam induced damage resulting from electron beam impingement on said sample.

152. An open top microscopy sample container comprising:
a light transmissive, fluid impermeable sample support of thickness less than ten microns; and
an open top peripheral enclosure seated to said sample support and defining with said sample support said open top microscopy sample container.

153. A sample container comprising:
a sample enclosure comprising:
an electron beam permeable, fluid impermeable, membrane; and
a peripheral enclosure sealed to said membrane and defining with said membrane said sample enclosure; and
a sample enclosure closure comprising quick-connect attachment means for connecting said sample enclosure with said sample enclosure closure.

154. The sample container according to claim 153, wherein said quick-connect attachment means comprises a bayonet connection.

155. The sample container according to claim 153, wherein said sample container is at least partially electrically conductive.

156. The sample container according to claim 153, comprising a reference orientation indicator.

157. The sample container according to claim 153, comprising a membrane support grid for supporting said membrane and for providing a reference orientation indication.

158. The sample container according to claim 153, comprising a flexible support element.
